(19) United States
(12) Patent Application Publication
(10) Pub. No.: US 2026/0352279 A1
(43) Pub. Date: Nov. 5, 2026

(54) MACHINE LEARNING IN WIRELESS COMMUNICATIONS

(71) Applicant: QUALCOMM Incorporated, San Diego, CA (US)

(72) Inventors: Chenxi HAO, Beijing (CN); Yu ZHANG, San Diego, CA (US); Taesang YOO, San Diego, CA (US); Ruiming ZHENG, Beijing (CN); Jay Kumar SUNDARARAJAN, San Diego, CA (US); June NAMGOONG, San Diego, CA (US); Pavan Kumar VITTHALADEVUNI, San Diego, CA (US); Runxin WANG, San Diego, CA (US); Naga BHUSHAN, San Diego, CA (US); Krishna Kiran MUKKAVILLI, San Diego, CA (US); Tingfang JI, San Diego, CA (US); Abdelrahman Mohamed Ahmed Mohamed IBRAHIM, San Diego, CA (US)

(21) Appl. No.: 19/100,073

(22) PCT Filed: Aug. 11, 2022
(86) PCT No.: PCT/CN2022/111665

§ 371 Date: Jan. 30, 2025

(51) Int. Cl. H04B 7/06; H04L 41/16

(52) U.S. Cl. CPC H04B 7/0626; H04L 41/16

(57) ABSTRACT

Certain aspects of the present disclosure provide techniques for machine learning in wireless communications. An example method performed by a user equipment includes receiving an indication to report channel state information (CSI) associated with a first machine learning model; receiving a reference signal associated with the CSI; and transmitting a CSI report associated with the reference signal based at least in part on a machine learning capability associated with the user equipment.

### INTRODUCTION

Aspects of the present disclosure relate to wireless communications, and more particularly, to techniques for machine learning in wireless communications.

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method of wireless communication by a user equipment. The method includes receiving an indication to report channel state information (CSI) associated with a first machine learning model; receiving a reference signal associated with the CSI; and transmitting a CSI report associated with the reference signal based at least in part on a machine learning capability associated with the user equipment.

Another aspect provides an apparatus of wireless communication. The apparatus includes a memory and a processor coupled to the memory. The processor is configured to: receive an indication to report channel state information (CSI) associated with a first machine learning model; receive a reference signal associated with the CSI; and transmit a CSI report associated with the reference signal based at least in part on a machine learning capability associated with the user equipment.

Another aspect provides an apparatus of wireless communication. The apparatus includes means for receiving an indication to report channel state information (CSI) associated with a first machine learning model; means for receiving a reference signal associated with the CSI; and means for transmitting a CSI report associated with the reference signal based at least in part on a machine learning capability associated with the user equipment.

Another aspect provides a non-transitory computer-readable medium having instructions stored thereon for receiving an indication to report channel state information (CSI) associated with a first machine learning model; receiving a reference signal associated with the CSI; and transmitting a CSI report associated with the reference signal based at least in part on a machine learning capability associated with the user equipment.

Another aspect provides a method of wireless communication by a user equipment. The method includes receiving an indication to report CSI associated with a first machine learning model; determining a set of one or more active machine learning models in response to receiving the indication; receiving a reference signal associated with the CSI; and transmitting a CSI report based on the reference signal at least in response to a timing constraint being satisfied, wherein the timing constraint is based at least in part on the set of one or more active machine learning models.

Another aspect provides an apparatus for wireless communication. The apparatus includes a memory and a processor coupled to the memory. The processor is configured to: receive an indication to report CSI associated with a first machine learning model; determine a set of one or more active machine learning models in response to receiving the indication; receive a reference signal associated with the CSI; and transmit a CSI report based on the reference signal at least in response to a timing constraint being satisfied, wherein the timing constraint is based at least in part on the set of one or more active machine learning models.

Another aspect provides an apparatus for wireless communication. The apparatus includes means for receiving an indication to report CSI associated with a first machine learning model; means for determining a set of one or more active machine learning models in response to receiving the indication; means for receiving a reference signal associated with the CSI; and means for transmitting a CSI report based on the reference signal at least in response to a timing constraint being satisfied, wherein the timing constraint is based at least in part on the set of one or more active machine learning models.

Another aspect provides a non-transitory computer-readable medium having instructions stored thereon for receiving an indication to report CSI associated with a first machine learning model; determining a set of one or more active machine learning models in response to receiving the indication; receiving a reference signal associated with the CSI; and transmitting a CSI report based on the reference signal at least in response to a timing constraint being satisfied, wherein the timing constraint is based at least in part on the set of one or more active machine learning models.

Another aspect provides a method of wireless communication by a user equipment. The method includes receiving an indication to report information associated with a first machine learning model; determining the information using the first machine learning model while concurrently determining other information using a second machine learning model in response to a machine learning processing constraint being satisfied; and transmitting a report indicating the information.

Another aspect provides an apparatus of wireless communication. The apparatus includes a memory and a processor coupled to the memory. The processor is configured to: receive an indication to report information associated with a first machine learning model; determine the information using the first machine learning model while concurrently determining other information using a second machine learning model in response to a machine learning processing constraint being satisfied; and transmit a report indicating the information.

Another aspect provides an apparatus of wireless communication. The apparatus includes means for receiving an indication to report information associated with a first machine learning model; means for determining the information using the first machine learning model while concurrently determining other information using a second machine learning model in response to a machine learning processing constraint being satisfied; and means for transmitting a report indicating the information.

Another aspect provides a non-transitory computer-readable medium having instructions stored thereon for receiving an indication to report information associated with a first machine learning model; determining the information using the first machine learning model while concurrently determining other information using a second machine learning model in response to a machine learning processing constraint being satisfied; and transmitting a report indicating the information.

Another aspect provides a method of wireless communication by a network entity. The method includes outputting an indication to report CSI associated with a first machine learning model; and obtaining a CSI report associated with a reference signal based at least in part on a machine learning capability associated with a user equipment.

Another aspect provides an apparatus for wireless communication. The apparatus includes a memory and a processor coupled to the memory. The processor is configured to: output an indication to report CSI associated with a first machine learning model; and obtain a CSI report associated with a reference signal based at least in part on a machine learning capability associated with a user equipment.

Another aspect provides an apparatus for wireless communication. The apparatus includes means for outputting an indication to report CSI associated with a first machine learning model; and means for obtaining a CSI report associated with a reference signal based at least in part on a machine learning capability associated with a user equipment.

Another aspect provides a non-transitory computer-readable medium having instructions stored thereon for outputting an indication to report CSI associated with a first machine learning model; and obtaining a CSI report associated with a reference signal based at least in part on a machine learning capability associated with a user equipment.

Another aspect provides a method of wireless communication by a network entity. The method includes outputting an indication to report CSI associated with a first machine learning model; determining a set of one or more active machine learning models in response to outputting the indication; outputting a reference signal associated with the CSI; and obtaining a CSI report based on the reference signal at least in response to a timing constraint being satisfied, wherein the timing constraint is based at least in part on the set of one or more active machine learning models.

Another aspect provides an apparatus for wireless communication. The apparatus includes a memory and a processor coupled to the memory. The processor is configured to: output an indication to report CSI associated with a first machine learning model; determine a set of one or more active machine learning models in response to outputting the indication; output a reference signal associated with the CSI; and obtain a CSI report based on the reference signal at least in response to a timing constraint being satisfied, wherein the timing constraint is based at least in part on the set of one or more active machine learning models.

Another aspect provides an apparatus for wireless communication. The apparatus includes means for outputting an indication to report CSI associated with a first machine learning model; means for determining a set of one or more active machine learning models in response to outputting the indication; means for outputting a reference signal associated with the CSI; and means for obtaining a CSI report based on the reference signal at least in response to a timing constraint being satisfied, wherein the timing constraint is based at least in part on the set of one or more active machine learning models.

Another aspect provides a non-transitory computer-readable medium having instructions stored thereon for outputting an indication to report CSI associated with a first machine learning model; determining a set of one or more active machine learning models in response to outputting the indication; outputting a reference signal associated with the CSI; and obtaining a CSI report based on the reference signal at least in response to a timing constraint being satisfied, wherein the timing constraint is based at least in part on the set of one or more active machine learning models.

Another aspect provides a method of wireless communication by a network entity. The method includes outputting an indication to report information associated with a first machine learning model; and obtaining a report indicating the information based on a machine learning processing constraint being satisfied.

Another aspect provides an apparatus of wireless communication. The apparatus includes a memory and a processor coupled to the memory. The processor is configured to: output an indication to report information associated with a first machine learning model; and obtain a report indicating the information based on a machine learning processing constraint being satisfied.

Another aspect provides an apparatus of wireless communication. The apparatus includes means for outputting an indication to report information associated with a first machine learning model; and means for obtaining a report indicating the information based on a machine learning processing constraint being satisfied.

Another aspect provides a non-transitory computer-readable medium having instructions stored thereon for outputting an indication to report information associated with a first machine learning model; and obtaining a report indicating the information based on a machine learning processing constraint being satisfied.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5A is a timing diagram illustrating example timing constraints for aperiodic channel state information (CSI).

FIG. 5B is a timing diagram illustrating an example timing constraint for periodic/semi-persistent CSI.

FIG. 6 illustrates an example networked environment in which a predictive model is used for determining CSI or a channel estimation.

FIG. 7 is a diagram illustrating an example wireless communication network using machine learning models.

FIG. 8 is a signaling flow illustrating an example of a user equipment loading machine learning model(s).

FIG. 9 is a table illustrating example machine learning capability levels that may be supported by user equipment.

FIGS. 10A-10C are diagrams of example machine learning capability levels 1.0, 1.1, and 1.2 with respect to FIG. 9.

FIGS. 11A-11C are diagrams of example machine learning capability levels 2.0, 2.1, and 2.2 with respect to FIG. 9.

FIGS. 12A-12C are diagrams illustrating various timelines associated with machine learning capability levels 1.0, 1.1, and 1.2.

FIGS. 13A-13C are diagrams illustrating various timelines associated with machine learning capability levels 2.0, 2.1, and 2.2.

FIG. 14 is a timing diagram illustrating an example of updating a model-status over time in response to aperiodic CSI triggers and the corresponding timelines for processing CSI using a machine learning model.

FIG. 15 is a timing diagram illustrating an example of timing constraints for processing periodic and semi-persistent CSI using machine learning models.

FIG. 16 is a timing diagram illustrating example protections for back-to-back model switching.

FIG. 17 depicts a process flow for communications in a network between a base station and a user equipment.

FIG. 18 depicts a method for wireless communications.

FIG. 19 depicts a method for wireless communications.

FIG. 20 depicts a method for wireless communications.

FIG. 21 depicts a method for wireless communications.

FIG. 22 depicts a method for wireless communications.

FIG. 23 depicts a method for wireless communications.

FIG. 24 depicts aspects of an example communications device.

FIG. 25 depicts aspects of an example communications device.

### DETAILED DESCRIPTION

Aspects of the present disclosure provide apparatuses, methods, processing systems, and computer-readable mediums for machine learning in wireless communications.

Wireless communication networks (e.g., 5G NR systems or other systems) may use channel state information (CSI) feedback from a user equipment (UE) for adaptive communications. The network may adjust certain communication parameters in response to CSI feedback from the UE. For example, link adaptation (such as adaptive modulation and coding) with various modulation schemes and channel coding rates may be applied to certain communication channels. For channel state estimation purposes, the UE may be configured to measure a reference signal (e.g., a CSI reference signal (CSI-RS)) and estimate the downlink channel state based on the CSI-RS measurements. The UE may report an estimated channel state to the network in the form of CSI, which may be used in link adaptation. The CSI may indicate channel properties of a communication link between a base station (BS) and a UE. The CSI may represent the effect of, for example, scattering, fading, and pathloss of a signal across the communication link.

In certain cases, machine learning models may be used to determine various information associated with a wireless communication network. Machine learning models may be used to determine CSI at the UE, beam management, UE positioning, and/or channel estimation, for example. For beam management, a machine learning model may determine beams to use in future transmission occasions, for example, to preemptively avoid beam failure. The machine learning model may determine the channel quality associated with narrow beams based on measurements associated with wide beams. In some cases, the machine learning model may determine fine resolution measurements associated with a beam based on course resolution measurements associated with the beam. In certain cases, machine learning models may be used by the UE to perform positioning, for example, for drone localization and/or vehicular to everything (V2X) communications. Machine learning models may be used for channel estimation.

In any of these applications, machine learning models may be designed for certain scenarios, such as an urban micro cell, an urban macro cell, an indoor hotspot, payload resolution, antenna architectures, etc. For example, the UE may use a particular machine learning model for a micro cell and a different machine learning model for a macro cell. As another example, the UE may use a particular machine learning for high resolution CSI (e.g., a precoder represented by several hundred bits) and a different machine learning model for low resolution CSI (e.g., a precoder represented by two to twelve bits). In some cases, the UE may use a particular machine learning model for UE positioning and a different machine learning model for beam management. Due to different UE architectures, UEs may support various capabilities related to using machine learning models. For example, UEs may store a different number of models in their modems and/or memory, and the UEs may use different amounts of time to switch to using a model stored in the modem or to switch to using a model stored in memory. There is uncertainty on how to handle the different UE architectures in a radio access network.

Aspects of the present disclosure provide apparatus and techniques for using machine learning models in wireless communications. Different categories of machine learning capabilities may be supported by UEs. As an example, a machine learning capability may represent the maximum number of machine learning models that a UE has the capability to process or store in its modem, the maximum number of machine learning models that the UE has the capability to store in memory (e.g., non-volatile memory and/or random access memory), or the minimum amount of time used to switch to using a machine learning model stored in memory or the modem. Different timelines may be supported for processing CSI using machine learning models. For example, a faster timeline may be used if the UE is switching between machine learning models stored in the UE's modem, and a slower timeline may be used if the UE is activating a new machine learning model (e.g., downloading the machine learning model or loading the machine learning model from memory). Certain criteria for concurrent processing of machine learning models may be supported. For example, a machine learning model may occupy a number of processing units for a certain duration when the machine learning model is being used by the UE. A UE may support a maximum number of processing units associated with machine learning models, such that the UE has the capability to process multiple machine learning models concurrently up to the maximum number of processing units.

The machine learning model procedures described herein may enable improved wireless communication performance (e.g., higher throughputs, lower latencies, and/or spectral efficiencies). For example, different UE architectures may support different timelines for processing CSI (and/or other information) using machine learning models. The different categories for machine learning capabilities may allow the radio access network to dynamically configure a UE with machine learning models in response to the UE's particular machine learning capabilities. Such dynamic configurations may allow a UE to process CSI using machine learning models under various conditions, such as high latency, low latency, ultra-low latency, high resolution CSI, or low resolution CSI, for example.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards, such as future wireless communications technologies, not explicitly mentioned herein.

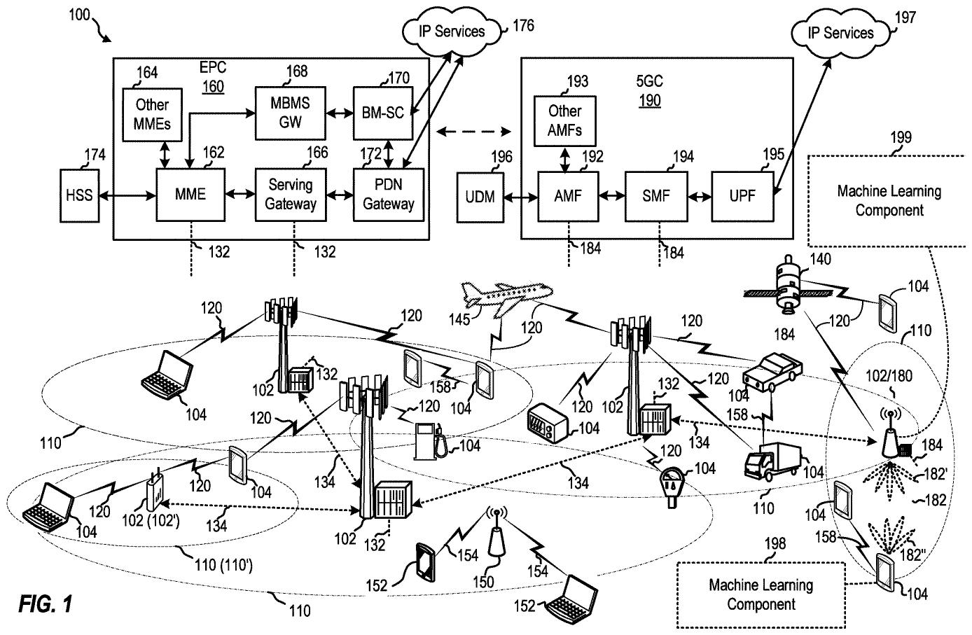

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipment.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

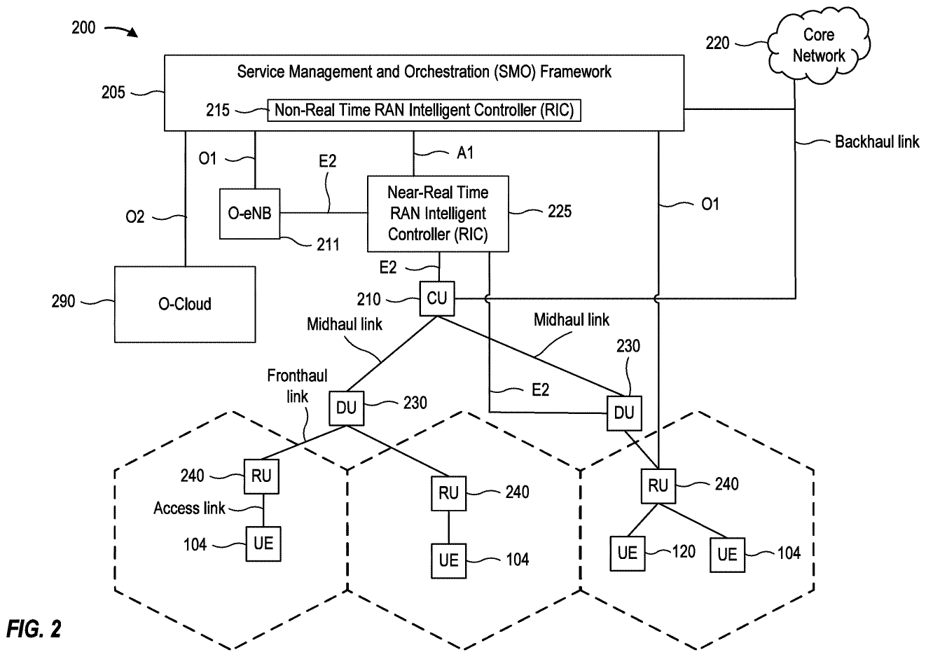

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

Wireless communication network 100 includes a machine learning component 199, which may perform the operations described herein related to machine learning timelines and/or machine learning concurrent processing. Wireless network 100 further includes a machine learning component 198, which may perform the operations described herein related to machine learning timelines and/or machine learning concurrent processing.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

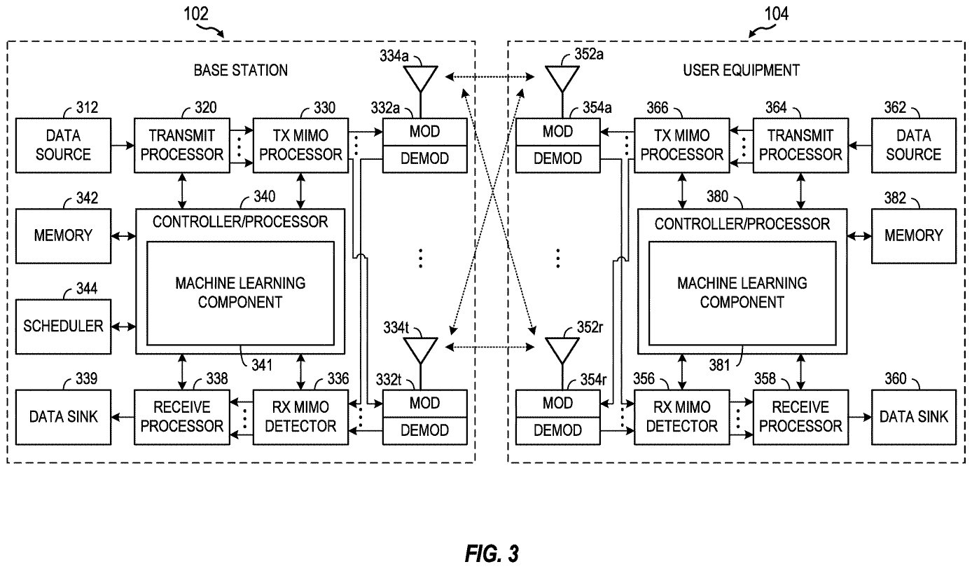

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Base station 102 includes controller/processor 340, which may be configured to implement various functions related to wireless communications. In the depicted example, controller/processor 340 includes machine learning component 241, which may be representative of the machine learning component 199 of FIG. 1. Notably, while depicted as an aspect of controller/processor 340, the machine learning component 341 may be implemented additionally or alternatively in various other aspects of base station 102 in other implementations.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

User equipment 104 includes controller/processor 380, which may be configured to implement various functions related to wireless communications. In the depicted example, controller/processor 380 includes machine learning component 381, which may be representative of the machine learning component 198 of FIG. 1. Notably, while depicted as an aspect of controller/processor 380, the machine learning component 381 may be implemented additionally or alternatively in various other aspects of user equipment 104 in other implementations.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

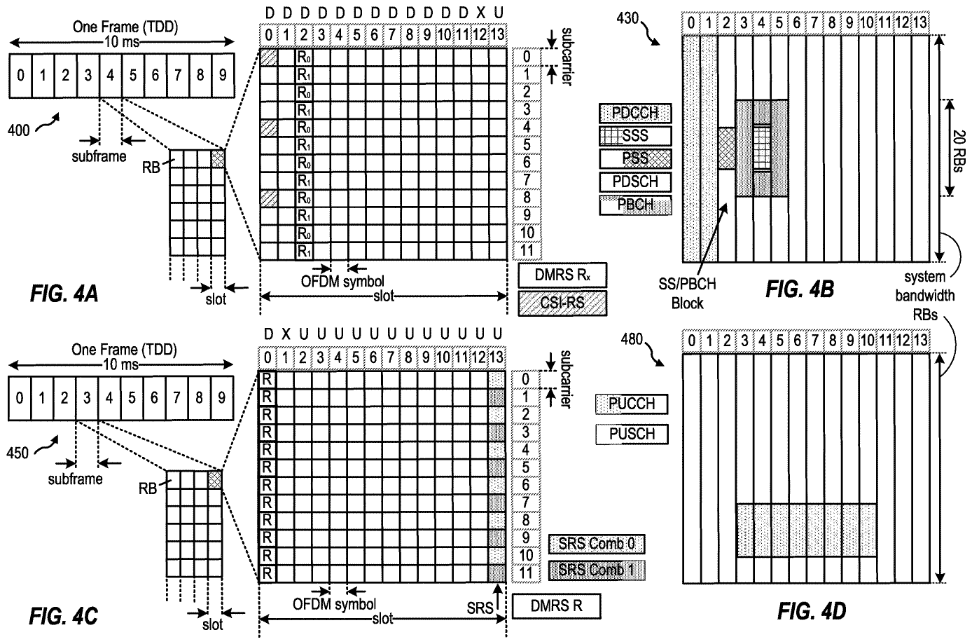

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology u, there are 14 symbols/slot and 2μ slots/subframe. The subcarrier spacing and symbol length/duration are a function of the numerology. The subcarrier spacing may be equal to 2^{μ}×15 kHz, where u is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Introduction to mmWave Wireless Communications

In wireless communications, an electromagnetic spectrum is often subdivided into various classes, bands, channels, or other features. The subdivision is often provided based on wavelength and frequency, where frequency may also be referred to as a carrier, a subcarrier, a frequency channel, a tone, or a subband.

In 5G NR two initial operating bands have been identified as frequency range designations FR1 (410 MHz-7.125 GHZ) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHZ-114.25 GHZ), and FR5 (114.25 GHZ-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

Communications using mmWave/near mmWave radio frequency band (e.g., 3 GHz-300 GHz) may have higher path loss and a shorter range compared to lower frequency communications. As described above with respect to FIG. 1, a base station (e.g., 180) configured to communicate using mmWave/near mmWave radio frequency bands may utilize beamforming (e.g., 182) with a UE (e.g., 104) to improve path loss and range.

Further, as described herein, a UE may estimate a channel or generate channel state information in mmWave bands and/or other frequency bands using machine learning model(s).

### Channel State Information

A UE may report channel state information to a radio access network. In certain cases, a CSI report configuration may indicate a codebook to use for CSI feedback. As an example, a codebook may include a precoding matrix that maps each layer (e.g., data stream) to a particular antenna port. In some cases, a codebook may include a precoding matrix that provides a linear combination of multiple input layers or beams. In certain cases, the codebook may include a set of precoding matrices, where the UE may select one of the precoding matrices for channel estimation.

For artificial intelligence (AI)-based CSI feedback, the UE may use a CSI encoder to generate the CSI using a machine learning model, for example. The encoder input may include a downlink channel matrix (H), a downlink precoder (V), and/or an interference covariance matrix (Rₙₙ). A network entity (e.g., a base station) may use a decoder to convert the AI-encoded CSI into information indicative of the channel quality, such as a precoding matrix indicator (PMI) codeword. The encoder is analogous to the PMI searching algorithm, and the decoder is analogous to the PMI codebook, which is used to translate the CSI reporting bits to a PMI codeword. The decoder output may include the downlink channel matrix (H), a transmit covariance matrix, the downlink precoder(s) (V), the interference covariance matrix (Rₙₙ), the raw versus whitened downlink channel, or any combination thereof.

In certain cases, the UE may report CSI aperiodically, for example, in response to signaling from the radio access network. When aperiodic CSI reports are triggered by the PDCCH, the UE may use certain computational resources to determine the CSI, and the UE may use a certain amount of time to perform the computation. In certain aspects, timing constraints may be used for aperiodic CSI reporting.

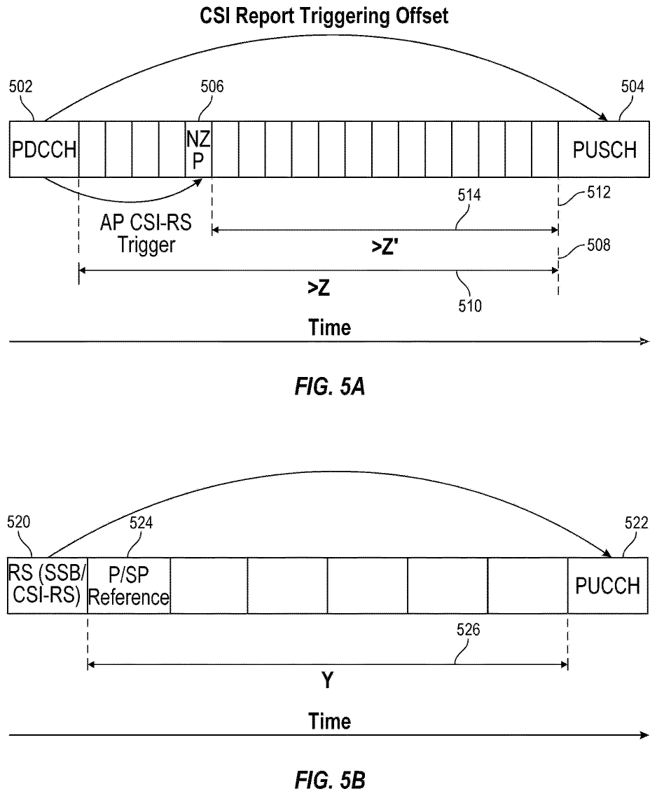

FIG. 5A is a timing diagram illustrating example timing constraints for aperiodic CSI. In this example, the UE may receive a PDCCH 502 indicating to report aperiodic CSI in a reporting occasion 504 (e.g., a PUSCH). In some cases, the UE may receive a reference signal (e.g., a CSI-RS or SSB) or measure interference (e.g., an interference measurement resource (IMR)) in a reception occasion 506, and the UE may compute the CSI based on the received reference signal and/or IMR. The UE may provide the aperiodic CSI report if the timing constraints are satisfied. A first timing constraint may be satisfied if the reporting occasion 504 starts no earlier than a first timing reference 508, where the first timing reference 508 may be positioned in time a first number of OFDM symbols 510 (Z) after the last symbol of the PDCCH 502 triggering the aperiodic CSI report. That is, there may be at least Z symbols between the last symbol of the PDCCH 502 triggering the aperiodic CSI report and the first symbol of the PUSCH (reporting occasion 504), which carries the CSI report. During this time, the UE can decode the PDCCH, perform possible CSI-RS/IM measurements (if the UE does not already have an up-to-date previous channel/interference measurement stored in its memory), perform possible channel estimation, calculate the CSI report, and perform UCI multiplexing with the uplink shared channel.

If the UE measures a reference signal (e.g., an aperiodic CSI-RS) and/or IMR before reporting the CSI, the first timing constraint alone may not guarantee that that the UE has enough time to compute the CSI, since the aperiodic CSI-RS could potentially be triggered close to the PUSCH transmission. A second timing constraint may be satisfied if the reporting occasion 504 starts no earlier than a second timing reference 512, where the second timing reference 512 may be positioned in time a second number of OFDM symbols 514 (Z′) after the end of the last symbol in time of the reception occasion 506 (e.g., the latest of: aperiodic CSI-RS resource for channel measurements, aperiodic CSI-IM used for interference measurements, and aperiodic non-zero power (NZP) CSI-RS for interference measurement). That is, there may be at least Z′ symbols between the last symbol of the aperiodic CSI-RS/IMR used to calculate the report and the first symbol of the PUSCH (reporting occasion 504), which carries the CSI report. In practice, with respect to Z′, Z may additionally encompass DCI decoding time, such that Z is typically a few symbols larger than the corresponding Z′ value.

If the Z-criterion (or Z′-criterion) is not fulfilled (e.g., the gNB triggers the PUSCH too close to the PDCCH (or the aperiodic CSI-RS/IM)), the UE can simply ignore the scheduling DCI if the UE is not also scheduled with an UL-SCH or HARQ-ACK, and the UE can refrain from transmitting anything. If UL-SCH or HARQ-ACK is scheduled to be multiplexed on the PUSCH, the UE may transmit the PUSCH with the CSI report, where the CSI report may be padded with dummy bits or stale (old) information.

NR systems may support various values for Z and Z′. For example, there may be separate values of Z and Z′ per subcarrier spacing (SCS) for high latency CSI, low latency CSI, and ultra-low latency CSI. The ultra-low latency criteria can only be applied if a single low latency CSI report is triggered, without multiplexing with either UL-SCH or HARQ-ACK, and when the UE has all of its CSI processing units unoccupied. The UE can then allocate all of its computational resources to compute the ultra-low latency CSI in a very short time.

In certain aspects, a timing constraint may be used for periodic and/or semi-persistent CSI to provide the UE with enough time to measure a periodic reference signal and report the CSI. FIG. 5B is a timing diagram illustrating an example timing constraint for periodic/semi-persistent CSI. In this example, a UE may receive a periodic reference signal (e.g., CSI-RS and/or SSB) in a reception occasion 520. In some cases, the UE may measure an interference measurement resource in the reception occasion 520. The UE may report CSI associated with the reference signal or the interference measurement resource in a reporting occasion 522 (e.g., PUCCH). The timing constraint may be satisfied if the reception occasion 520 occurs no later than (e.g., occurs before) a third timing reference 524 (e.g., a CSI reference resource), where the third timing reference 524 is positioned in time a third number of symbols (or slots) 526 (Y) before the reception occasion 522. That is, there may be at least Y symbols (or slots) between the reception occasion 520 and the reporting occasion 522. The UE is not expected to measure a reference signal or an interference measurement resource after the third timing reference 524. After a CSI reconfiguration, a bandwidth part switch, serving cell activation, or semi-persistent CSI activation, if there is no CSI-RS prior to the third timing reference, the UE may drop the CSI (e.g., refrain from transmitting).

### Adaptive Learning

A non-adaptive algorithm is deterministic as a function of its inputs. If the algorithm is faced with exactly the same inputs at different times, then its outputs will be exactly the same. An adaptive algorithm (e.g., machine learning or artificial intelligence) is one that changes its behavior based on its past experience. This means that different devices using the adaptive algorithm may end up with different algorithms as time passes.

According to certain aspects, channel estimation and CSI feedback procedures may be performed using an adaptive learning-based algorithm (e.g., machine learning module 712). Thus, over the time, the channel estimation and CSI feedback algorithm changes (e.g., adapts or updates) based on new learning. The channel estimation and CSI feedback procedures may be used for adapting various characteristics of the communication link between a UE and a network entity, such as transmit power control, modulation and coding scheme(s), code rate, subcarrier spacing, etc. For example, the adaptive learning can be used to determine a channel estimation and/or CSI feedback.

In some examples, the adaptive learning-based CSI/channel estimation involves training a model, such as a predictive model. The model may be used to determine the CSI/channel estimation associated with reference signals. The model may be trained based on training data (e.g., training information), which may include feedback, such as feedback associated with the CSI/channel estimation (e.g., measurements of reference signals).

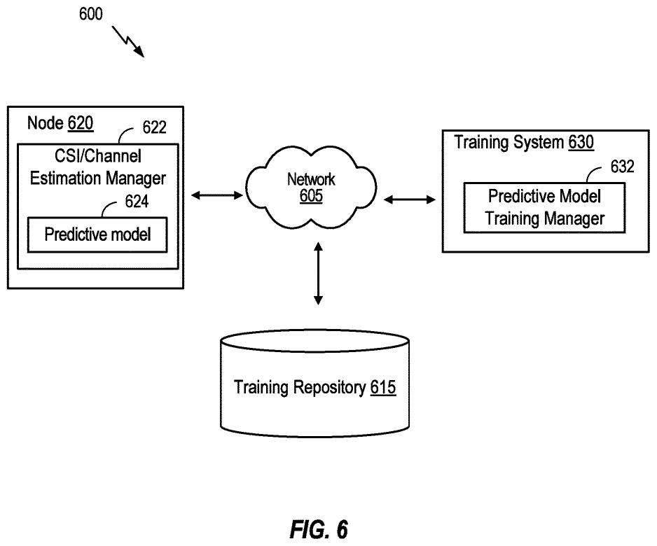

FIG. 6 illustrates an example networked environment 600 in which a predictive model 624 is used for determining CSI/channel estimation. As shown in FIG. 6, networked environment 600 includes a node 620, a training system 630, and a training repository 615, communicatively connected via network 605. The node 620 may be a UE (e.g., such as the UE 104 in the wireless communication network 100) or a BS (e.g., such as the BS 102 in the wireless communication network 100). The network 605 may be a wireless network such as the wireless communication network 100, which may be a 5G NR wireless network, for example. While the training system 630, node 620, and training repository 615 are illustrated as separate components in FIG. 6, it should be recognized by one of ordinary skill in the art that the training system 630, node 620, and training repository 615 may be implemented on any number of computing systems, either as one or more standalone systems or in a distributed environment.

The training system 630 generally includes a predictive model training manager 632 that uses training data to generate a predictive model 624 for determining CSI and/or a channel estimation based on signal measurements. The predictive model 624 may be determined based on the information in the training repository 615.

The training repository 615 may include training data obtained before and/or after deployment of the node 620. The node 620 may be trained in a simulated communication environment (e.g., in field testing, drive testing, etc.) prior to deployment of the node 620. For example, various CSI and/or channel estimations (e.g., channel quality indicator (CQI), precoding matrix indicator (PMI), reference signal received power (RSRP), a signal-to-interference plus noise ratio SINR, etc.) can be tested in various scenarios, to obtain training information related to the CSI/channel estimation procedure. This information can be stored in the training repository 615. After deployment, the training repository 615 can be updated to include feedback associated with CSI/channel estimation procedures performed by the node 620. The training repository can also be updated with information from other BSs and/or other UEs, for example, based on learned experience by those BSs and UEs, which may be associated with CSI/channel estimation procedures performed by those BSs and/or UEs.

The predictive model training manager 632 may use the information in the training repository 615 to determine the predictive model 624 (e.g., algorithm) used for CSI/channel estimation, such as to determine CQI, PMI, RSRP, SINR, etc. As discussed in more detail herein, the predictive model training manager 632 may use various different types of adaptive learning to form the predictive model 624, such as machine learning, deep learning, reinforcement learning, etc. The training system 630 may adapt (e.g., update/refine) the predictive model 624 over time. For example, as the training repository is updated with new training information (e.g., feedback), the model 624 is updated based on the new learning/experience.

The training system 630 may be located on the node 620, on a BS in the network 605, or on a different entity that determines the predictive model 624. If located on a different entity, then the predictive model 624 is provided to the node 620.

The training repository 615 may be a storage device, such as a memory. The training repository 615 may be located on the node 620, the training system 630, or another entity in the network 605. The training repository 615 may be in cloud storage, for example. The training repository 615 may receive training information from the node 620, entities in the network 605 (e.g., BSs or UEs in the network 605), the cloud, or other sources.

As described above, the node 620 is provided with (or generates, e.g., if the training system 630 is implemented in the node 620) the predictive model 624. As illustrated, the node 620 may include a CSI/channel estimation manager 622 configured to use the predictive model 624 for CSI/channel estimation described herein. In some examples, the node 620 uses the predictive model 624 to generate CSI and/or determine channel estimation based on received signal measurements. The predictive model 624 is updated as the training system 630 adapts the predictive model 624 with new learning.

Thus, the CSI/channel estimation algorithm, using the predictive model 624, of the node 620 is adaptive learning-based, as the algorithm used by the node 620 changes over time, even after deployment, based on experience/feedback the node 620 obtains in deployment scenarios (and/or with training information provided by other entities as well).

According to certain aspects, the adaptive learning may use any appropriate learning algorithm. As mentioned above, the learning algorithm may be used by a training system (e.g., such as the training system 630) to train a predictive model (e.g., such as the predictive model 624) for an adaptive-learning based CSI/channel estimation algorithm used by a device (e.g., such as the node 620) for determining CSI/channel estimation based on received signal measurements as further described herein. In some examples, the adaptive learning algorithm is an adaptive machine learning algorithm, an adaptive reinforcement learning algorithm, an adaptive deep learning algorithm, an adaptive continuous infinite learning algorithm, or an adaptive policy optimization reinforcement learning algorithm (e.g., a proximal policy optimization (PPO) algorithm, a policy gradient, a trust region policy optimization (TRPO) algorithm, or the like). In some examples, the adaptive learning algorithm is modeled as a partially observable Markov Decision Process (POMDP). In some examples, the adaptive learning algorithm is implemented by an artificial neural network (e.g., a deep Q network (DQN) including one or more deep neural networks (DNNs)).

In some examples, the adaptive learning (e.g., used by the training system 630) is performed using a neural network. Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

In some examples, the adaptive learning (e.g., used by the training system 630) is performed using a deep belief network (DBN). DBNs are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input could be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

In some examples, the adaptive learning (e.g., used by the training system 630) is performed using a deep convolutional network (DCN). DCNs are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods. DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

An artificial neural network, which may be composed of an interconnected group of artificial neurons (e.g., neuron models), is a computational device or represents a method performed by a computational device. These neural networks may be used for various applications and/or devices, such as Internet Protocol (IP) cameras, Internet of Things (IoT) devices, autonomous vehicles, and/or service robots. Individual nodes in the artificial neural network may emulate biological neurons by taking input data and performing simple operations on the data. The results of the simple operations performed on the input data are selectively passed on to other neurons. Weight values are associated with each vector and node in the network, and these values constrain how input data is related to output data. For example, the input data of each node may be multiplied by a corresponding weight value, and the products may be summed. The sum of the products may be adjusted by an optional bias, and an activation function may be applied to the result, yielding the node's output signal or “output activation.” The weight values may initially be determined by an iterative flow of training data through the network (e.g., weight values are established during a training phase in which the network learns how to identify particular classes by their typical input data characteristics).

Different types of artificial neural networks can be used to implement adaptive learning (e.g., used by the training system 630), such as recurrent neural networks (RNNs), multilayer perceptron (MLP) neural networks, convolutional neural networks (CNNs), and the like. RNNs work on the principle of saving the output of a layer and feeding this output back to the input to help in predicting an outcome of the layer. In MLP neural networks, data may be fed into an input layer, and one or more hidden layers provide levels of abstraction to the data. Predictions may then be made on an output layer based on the abstracted data. MLPs may be particularly suitable for classification prediction problems where inputs are assigned a class or label. Convolutional neural networks (CNNs) are a type of feed-forward artificial neural network. Convolutional neural networks may include collections of artificial neurons that each has a receptive field (e.g., a spatially localized region of an input space) and that collectively tile an input space. Convolutional neural networks have numerous applications. In particular, CNNs have broadly been used in the area of pattern recognition and classification. In layered neural network architectures, the output of a first layer of artificial neurons becomes an input to a second layer of artificial neurons, the output of a second layer of artificial neurons becomes an input to a third layer of artificial neurons, and so on. Convolutional neural networks may be trained to recognize a hierarchy of features. Computation in convolutional neural network architectures may be distributed over a population of processing nodes, which may be configured in one or more computational chains. These multi-layered architectures may be trained one layer at a time and may be fine-tuned using back propagation.

In some examples, when using an adaptive machine learning algorithm, the training system 630 generates vectors from the information in the training repository 615. In some examples, the training repository 615 stores vectors. In some examples, the vectors map one or more features to a label. For example, the features may correspond to various deployment scenario patterns discussed herein, such as frequency, subcarrier spacing, bandwidth, code rate, modulation and coding scheme, etc. The label may correspond to the CSI/channel estimation (e.g., CQI, PMI, RSRP, SINR, etc.) associated with the features for performing CSI/channel estimation. The predictive model training manager 632 may use the vectors to train the predictive model 624 for the node 620. As discussed above, the vectors may be associated with weights in the adaptive learning algorithm. As the learning algorithm adapts (e.g., updates), the weights applied to the vectors can also be changed. Thus, when the CSI/channel estimation procedure is performed again, under the same features (e.g., under the same set of conditions including frequency, subcarrier spacing, code rate, modulation and coding scheme, etc.), the model may give the node 620 a different result (e.g., different CQI, PMI, RSRP, SINR, etc.).

According to certain aspects, the adaptive learning based-CSI/channel estimation allows for continuous infinite learning. In some examples, the learning may be augmented with federated learning. For example, while some machine learning approaches use a centralized training data on a single machine or in a data center; with federated learning, the learning may be collaborative involving multiple devices to form the predictive model. With federated learning, training of the model can be done on the device, with collaborative learning from multiple devices. For example, referring back to FIG. 6, the node 620 can receive training information and/or updated trained models, from various different devices.

In certain aspects, the UE and/or the radio access network may train a set of machine learning models, where each model may be designed and/or developed for a certain scenario, such as an urban micro cell, an urban macro cell, or an indoor hotspot. The models may be associated with various bandwidth configurations. The models may be associated with various CSI payloads to fit different UE locations or wireless conditions. For example, if the UE is located near the cell center, the UE can report a CSI payload with greater resolution, and the UE may use a machine learning model associated with the particular CSI payload. If the UE is located on a cell edge, the UE may report a CSI payload with low resolution due to the cell coverage, and the UE may use a different machine learning associated with the low resolution CSI payload. In some cases, the models may be associated with various antenna architectures at the UE and/or base station. In certain aspects, the UE may use models to support beam management. For example, the UE may use a model to determine beams to use in future transmission occasions or determine finer beams based on coarse beam, and the UE may report the determined beam(s) with the RSRP associated with the beam(s) to the radio access network. In certain aspects, the UE may use models to perform positioning, where the UE may use the model to determine the distance and/or angle of the UE position relative to a base station, for example.

After training the models, the models may be registered with the radio access network. A model server (e.g., the training system 630 and/or training repository 615) may test the models, compile the models to run-time images, and store the run-time images. The model server may indicate to the radio access network to register the models. When the radio access network deploys a model, the radio access network may configure the UE to use the model (e.g., indicating a model identifier associated with the model), and the UE may download the run-time image of the model from the model server (e.g., the training repository 615). Due to different UE architectures, UEs may support storing a different number of models in their modems and/or memory (e.g., non-volatile memory and/or random access memory), and the UEs may use different amounts of time to switch to using a model stored in the modem or to switch to using a model stored in memory.

While the examples depicted in FIG. 6 are described herein with respect to AI-based CSI or channel estimation to facilitate understanding, aspects of the present disclosure may also be applied to other AI generated information, including beam management information and/or UE positioning information, for example.

### Aspects Related to Machine Learning in Wireless Communications

Aspects of the present disclosure provide apparatus and techniques for using machine learning in wireless communications. As UEs may have different architectures, machine learning capabilities may be divided into different categories or different aspects. As an example, a machine learning capability may represent the maximum number of active machine learning models that a UE is capable of processing or storing (e.g., via the UE's modem), the maximum number of inactive machine learning models that the UE is capable of storing (e.g., in memory), the minimum amount of time used to switch to using an inactive machine learning model, or combinations of machine learning models the UE is capable of processing or storing concurrently. The UE may indicate, to a radio access network, the specific machine learning capabilities that the UE is capable of performing (e.g., the maximum number of machine learning models that the UE is capable of processing or storing in its modem), and the radio access network may configure the UE with machine learning model(s) according to the machine learning capabilities. For example, if the UE can only support storing and processing a single machine learning model in its modem, the radio access network may configure or schedule the UE with processing using only a single machine learning model at any time.

Different timelines may be supported for processing CSI using machine learning models. For example, a faster timeline may be used if the UE is switching between active machine learning models (e.g., stored in the UE's modem), and a slower timeline may be used if the UE is activating a new machine learning model. To activate a new machine learning model, the UE may download the machine learning model from the radio access network or load the machine learning model from memory (e.g., non-volatile memory or random access memory).

Certain criteria for concurrent processing of machine learning models may be supported. For example, a machine learning model may occupy a number of processing units. A UE may support a maximum number of processing units associated with machine learning models, such that the UE is capable of processing multiple machine learning models concurrently up to the maximum number of processing units. In another aspect, the criteria of concurrent processing may be supported by reporting machine learning model combinations and the number of concurrent processing tasks or inference tasks associated with a combination configured/scheduled concurrently. In this case, the UE may report one or more model combinations, e.g., a first combination including {model 1, 2, 3} and second combination including {model 1 and 2}. The UE may report a total number inference tasks the combinations can process or report a number of inference tasks associated with each model in a combination. For example, the UE may report a total three tasks for the combination of {model 1 and 2} and a total of four tasks for the combination of {model 1, 2, 3}.

The machine learning model procedures described herein may enable improved wireless communication performance (e.g., higher throughputs, lower latencies, and/or spectral efficiencies). For example, different UE architectures may support different timelines for processing CSI (and/or other information) using machine learning models. The different categories for machine learning capabilities may allow the radio access network to dynamically configure a UE with machine learning models in response to the UE's particular machine learning capabilities. Such dynamic configurations may allow a UE to process CSI (and/or beam management information, UE positioning information, channel estimation, etc.) using machine learning models under various conditions, such as high latency, low latency, ultra-low latency, high resolution CSI, low resolution CSI, wide beam, narrow beam, etc.

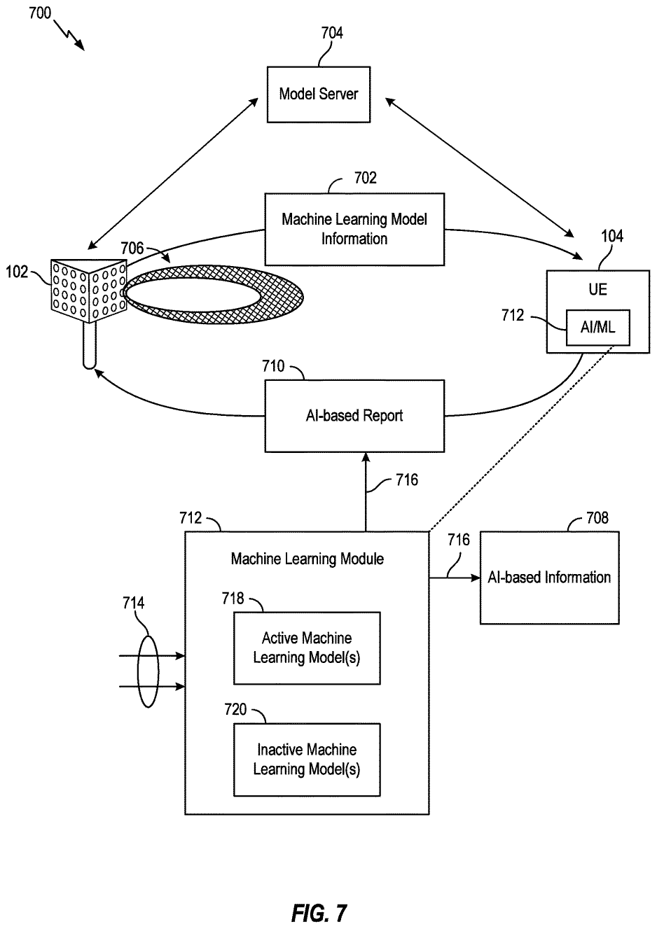

FIG. 7 is a diagram illustrating an example wireless communication network 700 using machine learning models, in accordance with certain aspects of the present disclosure. In this example, a model server 704 may perform model training, model testing, and/or compiling of runtime images for machine learning models, for example, as described herein with respect to FIG. 6. The model server 704 may include the training system 630 and/or training repository 615. In some cases, the model server 704 may be integrated or co-located with the BS 102. In certain cases, the model server 704 may be in communication with the BS 102 and accessed via network communications, such as the internet. For example, the model server 704 may be representative of a cloud computing system operated by the UE vendor, chipset vendor, and/or a third party. The model server 704 may include an over-the-top (OTT) server. In certain aspects, the model server 704 may be accessible to the UE 104 via multiple radio access technologies, such as WiFi and 5G NR.

The BS 102 may configure the UE 104 with reference signals used for data collection for machine learning training at a model server 704. For example, the BS 102 may configure the UE 104 to measure a reference signals (or an interference measurement resource) for data-collection and configure meta-information associated with the reference signals. In this example, the reference signals (e.g., a CSI-RS and/or SSB) may be associated with analog/digital beams 706, or a particular antenna layout equipped at the BS. The meta-information for data-collection may include a precoder, beamforming, antenna setup information associated with the reference signal, for example. In some cases, the meta-information may be an ID which is a regarded as particular representative of those configurations. The UE may measure the reference signal and transmit the measurements to the model server 704 along with the meta-information, Doppler information, delay spread information, channel quality information, and/or a time-stamp.

The model server 704 may perform model training based on the measurements associated with the reference signals taken by the UE 104. After model training, the model server 704 may test the trained model and compile the trained model to run-time image(s). After the model is trained or developed, the model server 704 may register a model identifier associated with the model with the radio access network. In the model deployment phase, the BS 102 may configure the UE with model identifiers associated with the models to use for AI-based processing. The UE may download the run-time image from the model server 704 per the model identifiers. In the inference phase, the BS 102 may transmit reference signals associated with the beams 706 for AI-based reporting, such as CSI, beam management, UE positioning.

In this example, the BS 102 may transmit (e.g., send, output, or provide) machine learning model information 702 to the UE 104. The machine learning model information 702 may include various information associated with AI-based reporting. In some cases, the machine learning model information 702 may include the configuration for AI-based reporting. For example, the machine learning model information 702 may include the training data for one or more machine learning models, run-time images associated with the machine learning model(s), and/or setup parameter(s) associated with the machine learning model(s). The machine learning model information 702 may include machine learning model configurations (e.g., CSI reporting configurations associated with machine learning models), configuration/reconfiguration of periodic/aperiodic CSI associated with a machine learning model, activation/deactivation of semi-persistent CSI associated with a machine learning model, and/or a trigger for reporting aperiodic CSI associated with a machine learning model.

As an example, the UE 104 may monitor for downlink reference signals (or interference measurement resources) from the BS 102, such as a CSI-RS and/or SSB associated with beam(s) 706. The UE 104 may determine AI-based information 708 (e.g., channel estimation) and/or AI-base report 710 (e.g., CSI) associated with the beams 706 based at least in part on the received reference signals corresponding to the beams 706. The UE 104 may report the AI-based report 710 to the BS 102. The AI-based report 710 may include various information, such as CSI, beam management information (e.g., preferred beams), UE positioning information, and/or channel estimation. In some cases, the UE 104 may use the channel estimation for transmit and/or receive beamforming, for example.

In certain cases, the BS 102 may transmit the reference signals (e.g., CSI-RS and/or SSB) using beams, which may be obtained by artificial intelligence and/or machine learning (AI/ML) at the BS 102 and/or UE 104. The UE 104 may use a CSI encoder to compress the channel estimate to a small dimension and report the CSI to the BS 102. The BS 102 may employ a CSI decoder to recover the full channel. In certain cases, the CSI encoder and decoder are matched AI/ML modules, e.g., jointly trained AI/ML modules.

In certain cases, the UE 104 may perform artificial intelligence (e.g., a neural network and/or machine learning) and/or regression analysis (e.g., a linear minimum mean square error (LMMSE) operation) to determine the AI-based information 708 and/or the AI-based report 710. For example, the UE 104 may use a machine learning module 712 to determine the AI-based information 708 and/or the AI-based report 710. The machine learning module 712 may include one or more active machine learning models 718, and in some cases, the machine learning module may include one or more inactive machine learning models 720. The UE 104 may select a machine learning model among the active machine learning models 718 and/or the inactive machine learning models 720 to use for determining the AI-based information 708 and/or the AI-based report 710. The UE 104 may select the machine learning model in response to a configuration from the BS 102, such as a periodic or semi-persistent CSI configuration or a trigger for aperiodic CSI. The CSI encoder/decoder or the AI-based channel estimator is analogous to a CSI codebooks, e.g., Type-1 codebook, Type-2 codebook, or eType-2 codebook. The model identifier may be associated/configured in a CSI report configuration like a codebook. In response to the BS 102 triggering or activating a particular CSI report, the UE may use the corresponding model indicated in the CSI report configuration.

An active machine learning model may be a machine learning model loaded in memory (e.g., random-access memory) and available for processing, whereas an inactive machine learning model may be a machine learning model stored in a data storage device (e.g., non-volatile memory), for example, due to the size of the modem memory. The inactive models are available for processing, where a certain amount of time may or may not be used to load the inactive machine learning model into the memory. The time to load (e.g., switch to using) an inactive machine learning model may depend on the UE architecture, such that some UEs may support a short loading time, and other UEs may support a long loading time.

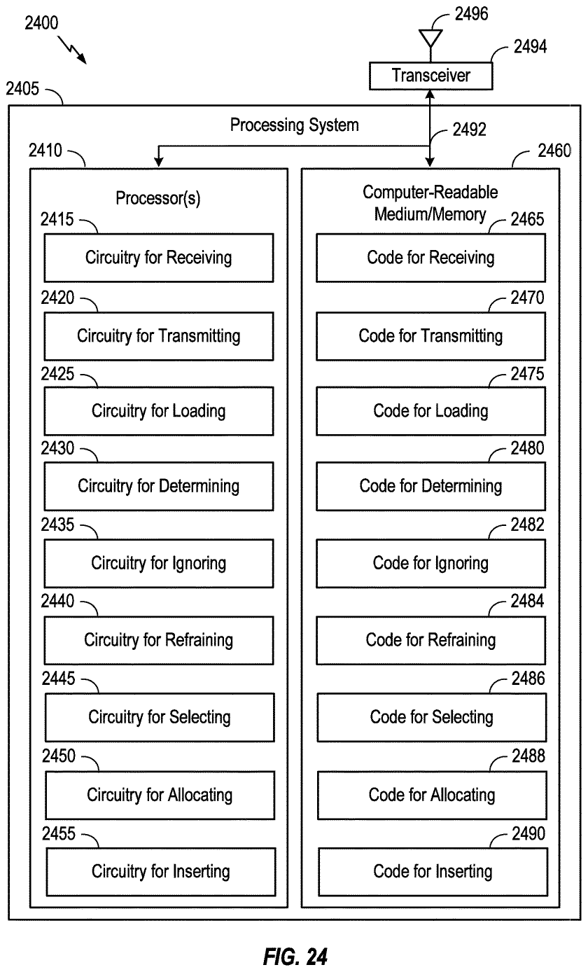

A processing system may execute the machine learning module 712, such as the processing system described herein with respect to FIG. 24. The input 714 of the machine learning module 712 may include measurements of the received reference signal(s) (e.g., a CSI-RS and/or SSB) from the BS 102 or interference measurements. For example, the input 714 may include the received reference signal and/or interference measurements represented in the frequency domain. The output 716 of the machine learning module 712 may include the AI-based information 708 and/or the AI-based report 710.

In certain aspects, timing criteria may be applied to loading or configuring new machine learning models at the UE. Assuming a UE is capable of having a first number of active machine learning models (M) and having a second number of inactive machine learning models (N), the radio access network may configure (or deploy) the UE with machine learning models totaling up to the sum of the first number and the second number (M+N) from the set of registered machine learning models. The M+N models are ready-to-use for periodic, semi-persistent, or dynamic triggering, but with a certain processing timeline criteria and/or concurrent processing criteria, as further described herein. In some cases, after the UE receives the machine learning model configuration (e.g., a radio resource control (RRC) configuration), the UE may download the model(s)/run-time image(s) associated with the configuration from the model server (e.g., the model server 704) and load M of the models to the modem, for example. In certain cases, assuming the UE has already downloaded all of the model(s)/run-time image(s) to a storage device, the UE may load the active model(s)/run-time image(s) associated with the configuration to the modem, for example. The UE may transmit, to the radio access network, an acknowledgement that the model(s) have been successfully loaded.

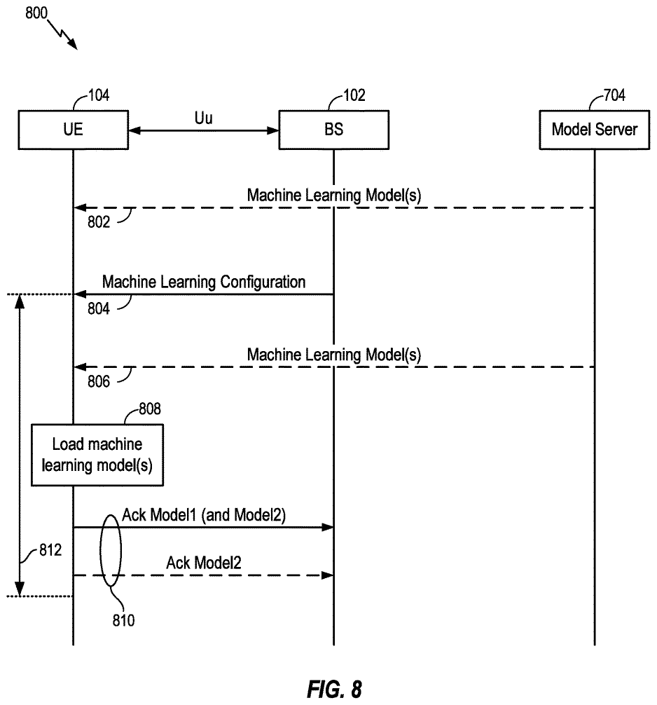

FIG. 8 is a signaling flow 800 illustrating an example of a UE loading machine learning model(s). In this example, the UE 104 may be in communication with a network entity (e.g., the BS 102).

Optionally, at activity 802, the UE 104 may obtain one or more machine learning models from the model server 704. In some cases, the UE 104 may communicate with the model server 704 via the BS 102. In certain cases, the UE 104 may communicate with the model server 704 via another radio access technology, such as WiFi. For example, the UE 104 may download run-time images associated with the machine learning models from the model server 704 (e.g., the training system 630 and/or training repository 615). That is, the UE 104 may pre-download the machine learning models available from the model server 704.

At activity 804, the UE 104 may receive a machine learning configuration indicating machine learning model identifiers to use for processing at the UE, such as CSI processing and/or channel estimation. The machine learning configuration may indicate the active machine learning model(s) and/or the inactive machine learning model(s). The machine learning configuration may indicate the scenarios to use certain machine learning models, such as radio conditions (e.g., frequency, subcarrier spacing, bandwidth, code rate, modulation and coding scheme, etc.), cell type (e.g., micro, macro, etc.), CSI resolution, antenna architecture, etc.

Optionally, at activity 806, the UE 104 may obtain the machine learning models from the model server 704 in response to receiving the configuration. For example, the UE 104 may download, from the model server 704, the run-time images associated with the machine learning models indicated in the configuration.

At activity 808, the UE 104 may load the active machine learning models associated with the configuration into the modem (e.g., the modulators and demodulators of the transceivers 354).

At activity 810, the UE 104 may transmit, to the BS 102, an acknowledgement that the models have been successfully loaded at the UE 104. In some cases, the UE 104 may transmit a separate acknowledgement for each of the models. For example, the UE 104 may transmit a first acknowledgement associated with a first model (Model1) and transmit a second acknowledgement associated with a second model (Model2). In certain cases, the UE 104 may transmit a common acknowledgement for multiple models (e.g., the first model and the second model). The acknowledgement may be a new type of signaling or via RRC signaling.

The UE 104 may be expected to transmit the acknowledgement within a certain time period from receiving the machine learning configuration. For example, the UE 104 may transmit the acknowledgement in a time window 812 starting when the machine learning configuration is received. The duration of the time window 812 may be based on the number of active machine learning models configured at the UE, the number of inactive machine learning models configured at the UE, and/or the size of the corresponding machine learning models. The duration of the time window 812 may be specific to loading machine learning models and acknowledging such activities. The duration of the time window 812 may be greater than some RRC timing criteria for acknowledging an RRC configuration, for example.

If the UE 104 fails to transmit the acknowledgement in the time window 812, the radio access network may assume the UE 104 failed to successfully load the machine learning models. In some cases, the UE 104 may fallback to using a non-AI-based codebook for CSI reporting, which may be signaled as a UE capability to the radio access network.

In certain aspects, machine learning capabilities may be divided into different categories (or levels) or different aspects. A UE may report its machine learning capability to the radio access network. For example, the machine learning capability associated with a UE may include a maximum number of active machine learning models (M), a maximum number of inactive machine learning models (N), and the (additional) time used to switch to (or activate) an inactive machine learning model (T). A UE may be capable of running (processing) up to M models concurrently. In some cases, the UE may be capable of storing up to N inactive machine learning models and activating such machine learning models in a certain time period with or without additional time (T).

In certain aspects, the machine learning capability may be reported to the radio access network as a set of values for M, N, and/or T (e.g., {M, N, T}). In some cases, the number of inactive machine learning models may be implicitly indicated by indicating the maximum number of active machine learning models (M) and the total number of active and inactive machine learning models (X) supported by the UE. The time used to switch to an inactive machine learning model may indicated as an index associated with a set of values for the duration, such as a set of two values (e.g., {zero, T}, where the value for T may be pre-defined) or a set of two or more values (e.g., {0, T1, T2, T3, etc.}, where the values for T1, T2, T3, etc. may be predefined).

For certain aspects, the machine learning capability associated with the UE may include one or more combinations of active models supported by the UE and/or one or more combinations of inactive models supported by the UE. The number of active or inactive models in the combinations may be based on the size of the models or other model characteristics. For example, the UE may report that the UE is capable of processing/storing models {1, 2} or models {1, 3, 4} as active/inactive models. In certain cases, the UE may report the number of inference tasks associated with a model combination and/or associated with each model in a combination, as further described herein.

In some cases, after downloading and/or loading active models, the UE may report to the radio access network the machine learning models that are available for processing at the UE (e.g., the models in the active state). The UE may indicate the models that support a fast timeline as an initial set of active models, as further described herein.

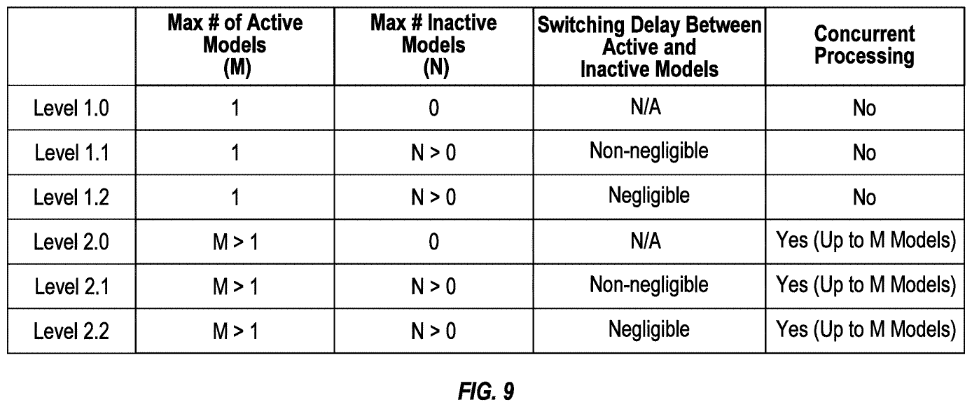

FIG. 9 is a table illustrating example machine learning capability levels that may be supported by UEs. In this example, for levels 1.0, 1.1, and 1.2, the UE may be capable of having a single model (e.g., run-time image of a model) in the modem (e.g., M=1). The UE may not be capable of processing multiple machine learning models concurrently.

For levels 1.0 and 2.0, the UE may be unable to have an inactive machine learning model (e.g., N=0). For example, the UE may not have the capacity to store an inactive machine learning model, such that the UE is unable to load another model image or parameter setup from memory (e.g., non-volatile memory or random access memory) (in a short timeline). In certain aspects, model or parameter setup switching (to models other than the configured M active models and/or N inactive models) may be performed via a reconfiguration (e.g., RRC reconfiguration). For example, the UE may replace the active model with another model in response to the reconfiguration.

For levels 1.1, 1.2, 2.1, and 2.2, the UE may be capable of storing up to N inactive machine learning models (e.g., run-time image and/or parameter setup) in memory (e.g., N>0). The UE may be capable of dynamic model switching (e.g., activating an inactive model) via signaling (e.g., downlink control information (DCI) or medium access control (MAC) signaling). For levels 1.1 and 2.1, the UE may be capable activating an inactive model in a certain timeframe including additional time (T). For example, the processing timeline for inactive models may be longer than the processing timeline for active models. For levels 1.2 and 2.2, the UE may be capable of activating an inactive model without the additional time used for levels 1.1 and 2.1. For example, the processing timeline for inactive models may be the same as the processing timeline for active models.

For levels 2.0, 2.1, 2.2, the UE may be capable of having multiple models (e.g., run-time image of a model) in the modem (e.g., M>1). The UE may be capable of processing multiple active machine learning models concurrently. Switching among the M active models may not use an additional timeline.

In certain aspects, the UE may report its supported machine learning capability level (e.g., levels 1.0-2.2 as described herein with respect to FIG. 9) and/or the values for {M, N, T} as the machine learning capability. The radio access network may configure the UE with at most the sum of M and N (M+N) models, and the radio access network may schedule CSI reporting depending on whether a model is active or inactive to leave enough processing time for the UE to activate an inactive model and process the CSI.

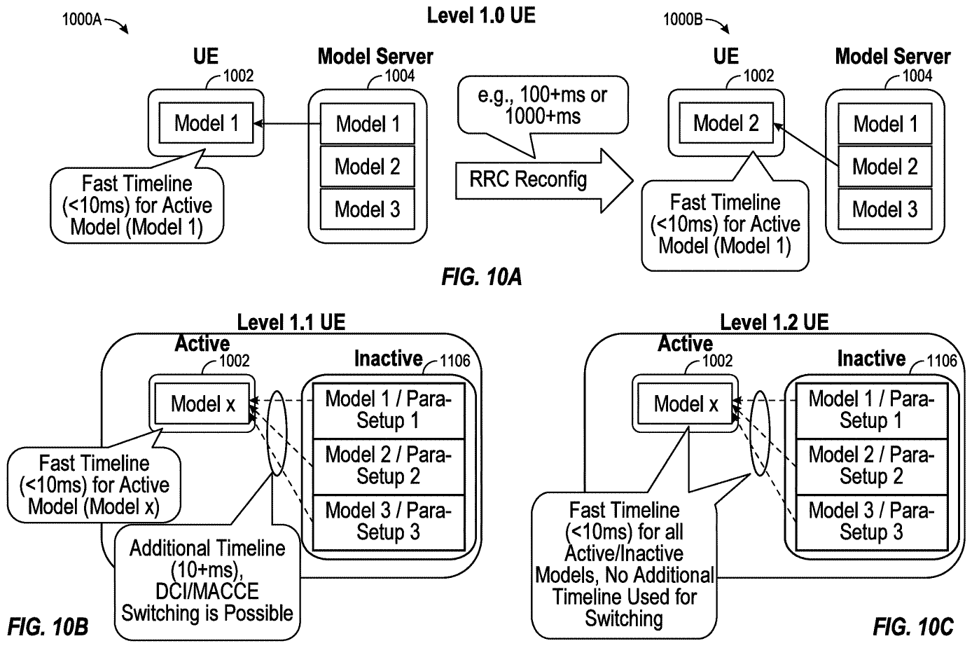

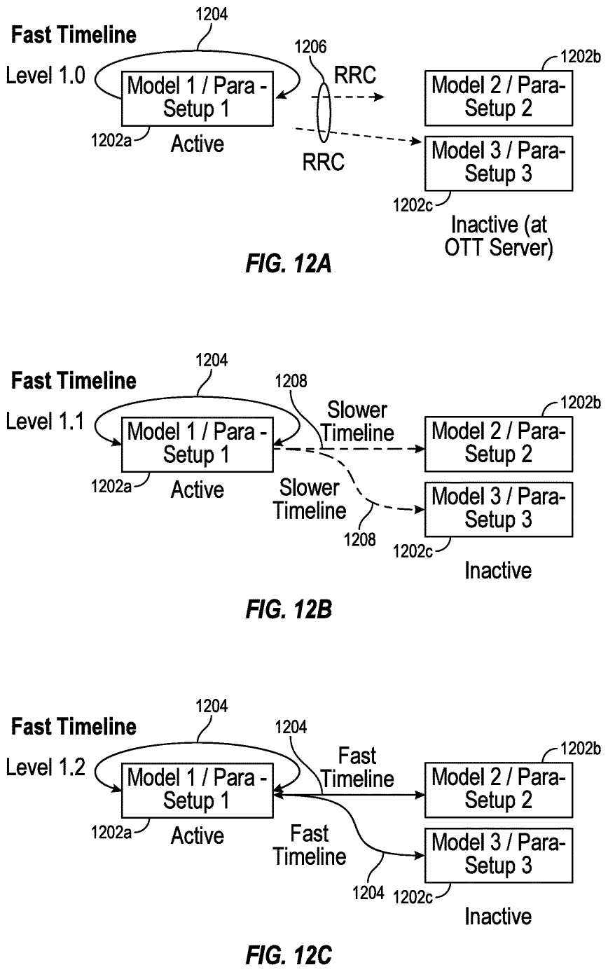

FIGS. 10A-10C are diagrams of example machine learning capability levels 1.0, 1.1, and 1.2. In these examples, the UE may support having up to a single active model loaded in a modem 1002 (e.g., M=1). Referring to FIG. 10A, in a first state 1000A for level 1.0, a UE may have a first model (Model 1) loaded in the modem 1002, where a model server 1004 may have the first model, second model (Model 2), and third model (Model 3) available for the UE. To load the active model in the modem 1002, the UE may download the run-time image associated with the first model from the model server 1004, which may be an over-the-top (OTT) server. For level 1.0, the UE may not be capable of processing multiple models concurrently (e.g., M=1). The UE may be capable of processing measurements for the CSI using the active model (e.g., Model 1) within a fast timeline as further described herein with respect to FIG. 12A.

In a second state 1000B, the UE may be reconfigured to have the second model loaded in the modem 1002. For example, the UE may receive an RRC reconfiguration indicating to use the second model for CSI processing, and the UE may take a certain time period (e.g., more than 100 ms to 1000 ms) to prepare the second model for processing (e.g., downloading the second model and loading the second model into the modem).

As shown in FIGS. 10B and 10C, for levels 1.1 and 1.2, the UE may have an active model (Model X) loaded in the modem 1002 and have three inactive models (the first model, second model, and third model) loaded in a storage device 1006. The UE may not be capable of processing multiple models concurrently. The UE may be capable of processing measurements for CSI using the active model (e.g., Model X) within a fast timeline as further described herein with respect to FIGS. 12B and 12C. For level 1.1, the UE may be capable of processing measurements for CSI using an inactive model in a certain time period with additional time (e.g., more than 10 ms) to activate the inactive model (e.g., a slower timeline or long duration). For level 1.2, the UE may be capable of processing measurements for CSI using an inactive model in the time period without the additional time (e.g., a fast timeline or a short duration). A fast timeline (or short duration) may be referred to as such as it may span less time than a slower timeline (or long duration). As such, the terms fast timeline (or short duration) and slower timeline (or long duration) may be relative to one another.

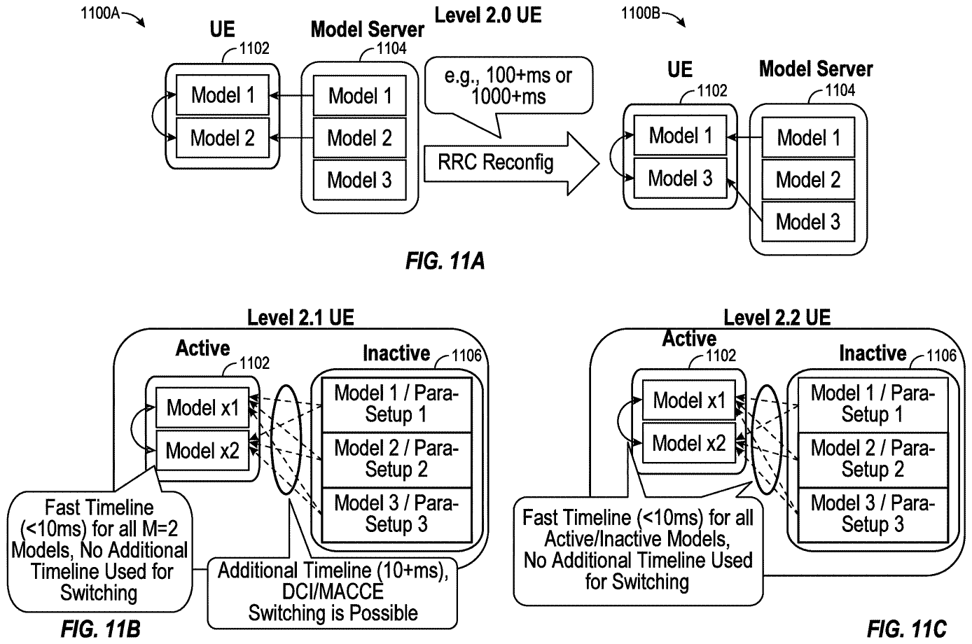

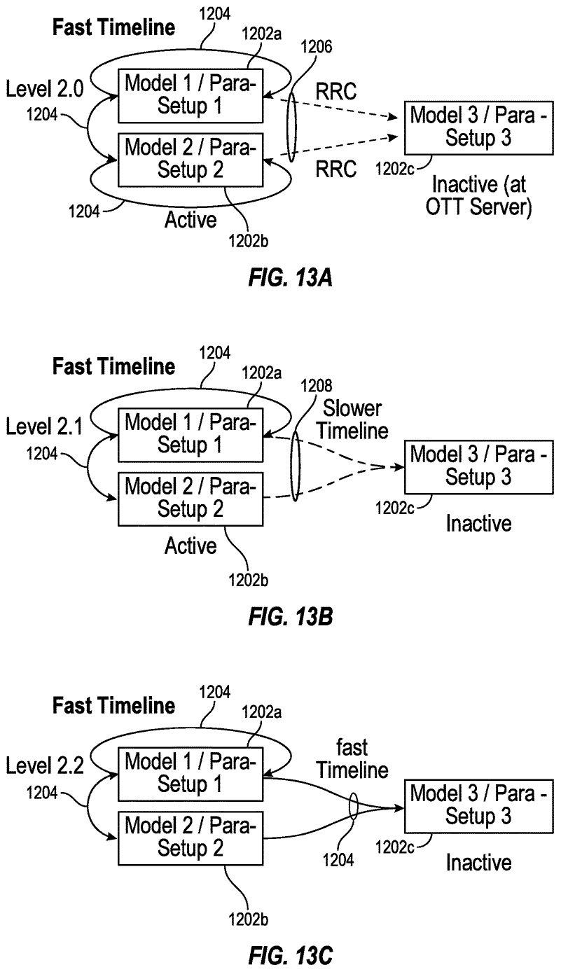

FIGS. 11A-11C are diagrams of example machine learning capability levels 2.0, 2.1, and 2.2. In these examples, the UE may support up to two active models loaded in a modem 1102. Referring to FIG. 11A, in a first state 1100A for level 2.0, a UE may have a first model (Model 1) and a second model (Model 2) loaded in the modem 1102, where a model server 1104 may have the first model, second model, and third model (Model 3) available for the UE. To load the active models in the modem 1102, the UE may download the run-time image associated with the first model and the second model from the model server 1104. For level 2.0, the UE may be capable of processing up to two active models concurrently (e.g., M=2). The UE may be capable of processing measurements for the CSI using the active models (e.g., Model 1 and Model 2) within a fast timeline as further described herein with respect to FIG. 13A.

In a second state 1100B, the UE may be reconfigured to replace the second model with the third model loaded in the modem 1102. For example, the UE may receive an RRC reconfiguration indicating to use the third model for CSI processing, and the UE may take a certain time period (e.g., more than 100 ms to 1000 ms) to prepare the third model for processing (e.g., downloading the third model and loading the third model into the modem).

As shown in FIGS. 11B and 11C, for levels 2.1 and 2.2, the UE may have two active models (Model X1 and Model X2) loaded in the modem 1102 and have three inactive models (the first model, second model, and third model) loaded in a storage device 1106. The UE may be capable of processing up to two active models concurrently. The UE may be capable of processing measurements for CSI using the active models (e.g., Model X1 and Model X2) within a fast timeline as further described herein with respect to FIGS. 13B and 13C. For level 2.1, the UE may be capable of processing measurements for CSI using an inactive model in a certain time period with additional time (e.g., more than 10 ms) to activate the inactive model (e.g., a slower timeline). For level 2.2, the UE may be capable of processing measurements for CSI using an inactive model in the time period without the additional time (e.g., a fast timeline).

In certain aspects, aperiodic CSI processing using machine learning may support multiple timelines (e.g., a fast timeline and a slower timeline) for reporting the CSI. The timeline may span the time period from when the CSI trigger is received at the UE to when the CSI is reported to the radio access network. A particular duration associated with the timeline may depend on the machine learning capability of a UE. For example, for levels 1.1 and 2.1, the UE may be capable of activating an inactive model within the slower timeline (e.g., additional time is used relative to the fast timeline which is used for the active models), whereas for levels 1.2 and 2.2, the UE may be capable of activating the inactive model within the fast timeline (same timeline as the active models).

The duration associated with the timeline may depend on the supported machine learning capability level (1.0-2.2) and/or one or more individual capabilities (e.g., {M, N, T}). The timelines may apply timing constraint(s) for aperiodic CSI processing, such as the timing constraints Z and/or Z′ described herein with respect to FIG. 5A. The value(s) for Z and/or Z′ may be configured for machine learning processing and the corresponding capabilities (e.g., levels 1.0-2.2) of the different UE architectures. For example, the value(s) for Z and/or Z′ may depend on the model complexity, an identifier associated with a machine learning model (where the identifier may be indicative of the model complexity and processing time used), a rank indicator or the maximum rank associated with one or more transmission layers, whether a CSI decoder is available for CSI processing, whether there is any other concurrent AI/ML models being processed, or any combination thereof. In certain cases, the UE may report, to the radio access network, the value(s) for Z and/or Z′ used for machine learning processing. If the UE fails to report the CSI within the timeline for machine learning processing, the UE may report previously reported CSI (e.g., outdated CSI), or the UE may use a non-AI-based codebook for CSI reporting.

FIGS. 12A-12C are diagrams illustrating various timelines associated with machine learning capability levels 1.0, 1.1, and 1.2. In these examples, the UE may support having up to a single active model (e.g., Model 1 or parameter setup associated with Model 1). The UE may have a first model 1202a (Model 1) loaded as the active model.

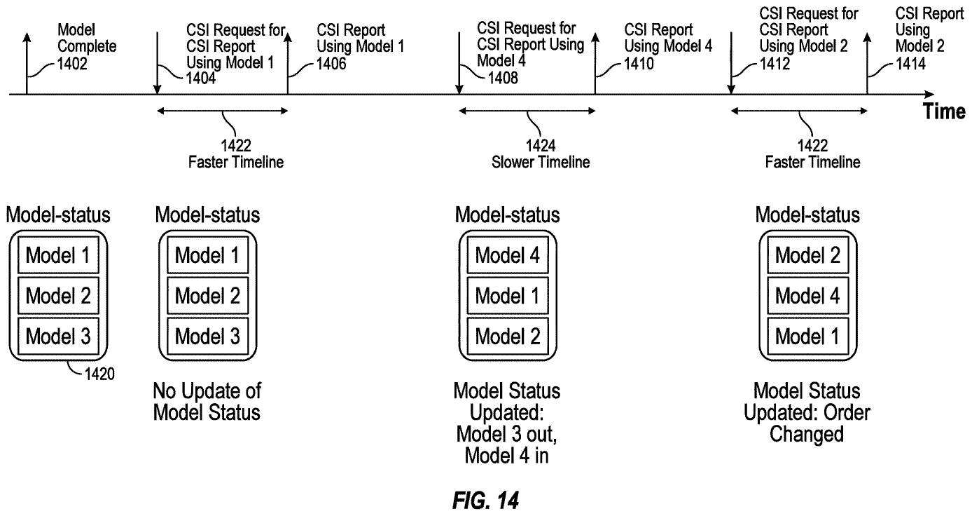

Referring to FIG. 12A, a model server may have a second model 1202b (e.g., Model 2) and a third model 1202c (e.g., Model 3) available for UEs to download. For level 1.0, the UE may be capable of processing measurements for CSI using the active model (e.g., Model 1) within a fast timeline 1204. For example, in response to an aperiodic CSI trigger, the UE may be capable of processing measurements for CSI using the active model (e.g., Model 1) and report the CSI in a duration associated with the fast timeline 1204 as further described herein with respect to FIG. 14. The UE may switch to using the second model 1202b or the third model 1202c in response to a reconfiguration 1206 (e.g., an RRC reconfiguration), which may take a longer duration to perform than the fast timeline 1204.

Referring to FIGS. 12B and 12C, the UE may have the second model 1202b and the third model 1202c loaded in memory as inactive models. For levels 1.1 and 1.2, the UE may be capable of processing measurements for CSI using the active model (e.g., Model 1) within the fast timeline 1204. For level 1.1, the UE may be capable of activating an inactive model (e.g., Model 2 or Model 3) and processing measurements for CSI using the inactive model within a slower timeline 1208. For example, in response to an aperiodic CSI trigger, the UE may be capable of processing measurements for CSI using an inactive model (e.g., Model 2) and report the CSI in a duration associated with the slower timeline 1208, which may span a duration of the fast timeline plus an additional time (e.g., T as described herein with respect to FIG. 9). For level 1.2, the UE may be capable of activating an inactive model (e.g., Model 2 or Model 3) and processing measurements for CSI using the inactive model within the fast timeline 1204.

FIGS. 13A-13C are diagrams illustrating various timelines associated with machine learning capability levels 2.0, 2.1, and 2.2. In these examples, the UE may support having up to two active models (e.g., Model 1 and Model 2). The UE may have the first model 1202a (Model 1) and the second model 1202b loaded as the active model, and the UE may be capable of processing CSI measurements using the first model 1202a and the second model 1202b concurrently.

Referring to FIG. 13A, a model server may have the third model 1202c (e.g., Model 3) available for UEs to download. For level 2.0, the UE may be capable of processing measurements for CSI using the active models (e.g., Model 1 and Model 2) within the fast timeline 1204. For example, in response to an aperiodic CSI trigger, the UE may be capable of processing measurements for CSI using the active model (e.g., Model 1 and/or Model 2) and report the CSI in a duration associated with the fast timeline 1204 as further described herein with respect to FIG. 14. The UE may switch to using the third model 1202c in response to the reconfiguration 1206 (e.g., an RRC reconfiguration), which may take a longer duration to perform than the fast timeline 1204.

Referring to FIGS. 13B and 13C, the UE may have the third model 1202c loaded in memory as an inactive model. For levels 2.1 and 2.2, the UE may be capable of processing measurements for CSI using the active model(s) (e.g., Model 1 and/or Model 2) within the fast timeline 1204. For level 2.1, the UE may be capable of activating an inactive model (e.g., Model 3) and processing measurements for CSI using the inactive model within the slower timeline 1208. For example, in response to an aperiodic CSI trigger, the UE may be capable of processing measurements for CSI using an inactive model (e.g., Model 3) and report the CSI in a duration associated with the slower timeline 1208, which may span a duration of the fast timeline plus an additional time (e.g., T as described herein with respect to FIG. 9). For level 2.2, the UE may be capable of activating an inactive model (e.g., Model 3) and processing measurements for CSI using the inactive model within the fast timeline 1204.

In certain aspects, the UE and/or radio access network (e.g., a network entity) may track which model(s) are currently active models at the UE. The UE and radio access network may keep track of the currently active models. The UE and/or radio access network may update the currently active models in response to an indication to load (or activate) an inactive model (e.g., switch from being inactive to being active) and/or an indication to deactivate an active model (e.g., switch from being active to being inactive). The indication may be an aperiodic CSI trigger, semi-persistent CSI activation/deactivation, or CSI reference resource location for periodic or semi-persistent CSI report. For example, the UE may track the currently active models using a list or set of identifiers associated with the active models. The list or set of identifiers associated with the active models may be referred to as a model-status. The model-status may be updated in response to an aperiodic CSI trigger, activation/deactivation of semi-persistent CSI, and/or configuration/reconfiguration of periodic CSI. The initial model-status may be set to a default value (e.g., none) or reported to the radio access network by the UE.

The UE and/or radio access network may determine the timeline (e.g., the fast timeline or the slower timeline) to use for CSI processing based on the model-status and the UE capability. For an aperiodic CSI trigger, if the triggered model identifier is in the model-status, the fast timeline for CSI processing may be applied for levels 1.1 through 2.2. If the triggered model identifier is not in the model-status, the fast timeline (e.g., the same timeline as the active models) may be used for levels 1.2 and 2.2, and additional time may be used for levels 1.1 and 2.1 (e.g., fast timeline plus additional time T, or the slower timeline). In some cases, the slower timeline may use longer values for Z and Z′ than the fast timeline. In certain cases, the slower timeline may use the same values for Z and Z′ as the fast timeline and add the additional time T to the respective values.

In some cases, the model-status may be an ordered series of model identifiers, where certain criteria may be applied to removing old entries and adding new entries (e.g., last-in-first-out (LIFO) or first-in-first-out (FIFO)). An ordered series may enable the UE and/or radio access network to track the model-status without feedback from the UE on the state of the model-status. In some cases, in response to receiving an indication to activate a new model (e.g., loading an inactive model or downloading a model from a model server), the first or last model identifier in the model-status vector may be removed, and the new model identifier may be inserted in the first position of the model-status. Suppose, for example, the model-status has the values {a, b, c} for the currently active model identifiers, and a CSI report is triggered for model d. The last model identifier in the model-status may be removed, such that model c is removed. The other models may be shifted in position, and model d may be inserted in the first position, such that the model-status becomes {d, a, b}.

If multiple entries are to be added to the model-status concurrently (e.g., when multiple CSI reports are triggered or scheduled in the same UCI by the same CSI request), the identifier (for the new CSI report or model) having the lowest (or highest) value among the new model identifiers may be inserted into the first position of the model-status. Suppose, for example, the model-status has values {a, b, c} for the currently active model identifiers, and a CSI report is triggered for model d and model e. The last two entries may be removed, such that models b and c are removed. Model a may be shifted to the last position, and model d and e may be inserted in the first two positions, such that the model-status becomes {d, e, a}.

In certain cases, the UE may report, to the radio access network, an indication of the current model-status. Feedback on the state of the model-status may allow the model-status to be an unordered list or set. For example, the UE may report which model identifier is removed from the model-status. In certain aspects, the UE may determine which model identifier to remove from the model-status.

FIG. 14 is a timing diagram illustrating an example of updating a model-status over time in response to aperiodic CSI triggers and the corresponding timelines for processing CSI using a machine learning model. In this example, a UE may have a first model (Model 1), a second model (Model 2), and a third model (Model 3) loaded as active models, such that a model-status 1420 includes the identifiers associated with Model 1, Model 2, and Model 3. The UE may also have machine learning capability level of 2.1 such that the UE is capable of having multiple active models, and the UE uses a slower timeline to activate an inactive model. At activity 1402, the UE may report to a network entity that the models are successfully loaded, for example, as described herein with respect to FIG. 8.

At activity 1404, the UE receives a CSI request for a CSI report using Model 1. As Model 1 is in the model-status 1420, there is no update to the model-status 1420, and the UE applies a fast timeline 1422 to report the CSI at activity 1406. For example, in response to the CSI request associated with Model 1, the UE may process measurements using Model 1 and report the CSI in the fast timeline 1422 according to the timing constraints Z and/or Z′ associated with the fast timeline 1422.

At activity 1408, the UE receives a CSI request for a CSI report using a fourth model (Model 4). As Model 4 is not in the model-status 1420, the model-status 1420 is updated to include Model 4, where Model 3 is removed, and Model 4 is added. In response to Model 4 not being in the model-status 1420, the UE applies a slower timeline 1424 to report the CSI at activity 1410. For example, in response to the CSI request associated with Model 4, the UE may load Model 4 from memory, process measurements using Model 4, and report the CSI at activity 1410 in the slower timeline 1424 according to the timing constraints Z and/or Z′ (or an additional time T) associated with the slower timeline 1424.

At activity 1412, the UE receives a CSI request for a CSI report using Model 2. Although Model 2 is in the model-status 1420, the order of the identifiers may be updated such that Model 2 is moved to the first position. As Model 2 is in the model-status 1420, the UE applies a fast timeline 1422 to report the CSI at activity 1414.

For periodic and semi-persistent CSI, multiple timelines (e.g., a fast timeline and a slower timeline) may be used for reporting the CSI, where the timelines may define the position in time of a timing reference (e.g., the third timing reference 524) and the duration of Y as described herein with respect to FIG. 5B. The value for Y (e.g., number of symbols or slots) may be associated with the timelines, such that a slower timeline may have a longer duration for Y than a fast timeline. A fast timeline may correspond to a short duration of Y (e.g., the CSI resource can be located closer in time to the reporting occasion), and a slower timeline may correspond to a long duration of Y (e.g., the CSI resource is located further in time from the reporting occasion) or the short duration of Y plus additional time T.

In certain cases, aspects described herein with respect to the duration of the timeline for aperiodic CSI may apply to the timelines associated with periodic and semi-persistent CSI. For example, a particular duration (e.g., Y) associated with the timeline may depend on the machine learning capability of a UE. For example, for levels 1.1 and 2.1, the UE may be capable of activating an inactive model within the slower timeline (e.g., additional time is used relative to the fast timeline), whereas for levels 1.2 and 2.2, the UE may be capable of activating the inactive model within the fast timeline. The UE (and/or network entity) may determine the timeline to use for periodic/semi-persistent CSI processing based on the model-status, where models for periodic and semi-persistent CSI may occupy positions in the model-status (alongside models for aperiodic CSI).

For certain aspects, the models for periodic/semi-persistent CSI may hold a reserved position in the model-status from configuration/activation to reconfiguration/deactivation. In some cases, the models for periodic or semi-persistent CSI may not participate in a model-status update, such that a fast timeline is applied for periodic or semi-persistent CSI. For example, in response to the periodic CSI configuration, the model for periodic CSI may be loaded as an active model, and thus, the fast timeline is applied for the periodic CSI (and similar behavior may apply to activation of semi-persistent CSI). In certain cases, for semi-persistent CSI, the model-status may be updated in response to receiving the activation/deactivation commands, such that the slower timeline is applied to the initial (first) transmission of the semi-persistent CSI, and the fast timeline is applied to the subsequent transmission of the semi-persistent CSI.

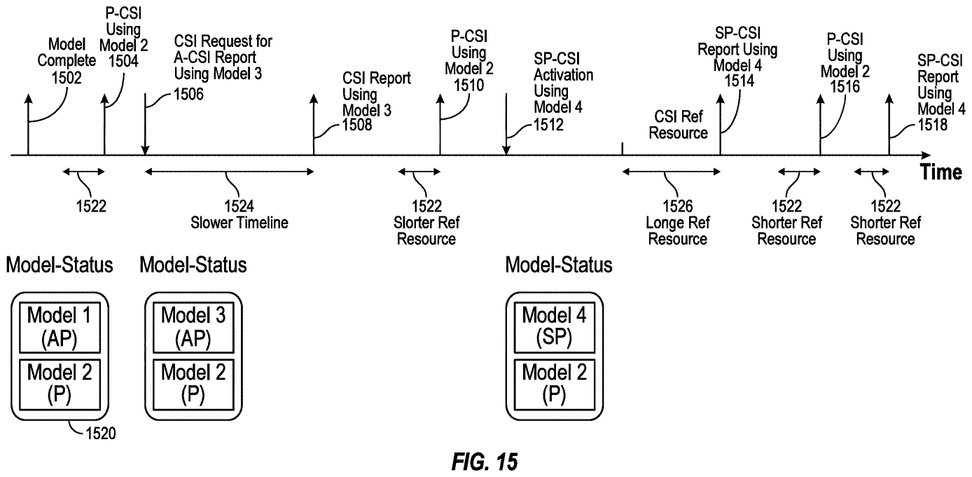

FIG. 15 is a timing diagram illustrating an example of timing constraints for processing periodic and semi-persistent CSI using machine learning models. In this example, a UE may have a first model (Model 1) and a second model (Model 2) loaded as active models, such that a model-status 1520 includes the identifiers associated with Model 1 and Model 2. Model 1 may be used for aperiodic CSI, and Model 2 may be used for periodic CSI. The UE may also have a machine learning capability level of 2.1, such that the UE is capable of having multiple active models, and the UE uses a slower timeline to activate an inactive model. At activity 1502, the UE may report to a network entity that the models are successfully loaded, for example, as described herein with respect to FIG. 8.

At activity 1504, the UE reports periodic-CSI associated with model 2 using a shorter reference resource 1522, which corresponds to a fast timeline (e.g., a short duration for Y). For example, the UE may receive a reference signal no earlier than the timing reference (e.g., the third timing reference 524) associated with the fast timeline, which may have a short (default) duration for Y.

At activity 1506, the UE receives an aperiodic CSI request for a CSI report using a third model (Model 3). As Model 3 is not in the model-status 1520, the model-status 1520 is updated to include Model 3, where Model 1 is removed, and Model 3 is added. In response to Model 3 not being in the model-status 1520, the UE applies a slower timeline 1524 to report the CSI at activity 1508. For example, in response to the CSI request associated with Model 3, the UE may load Model 3 as an inactive model from memory, process measurements using Model 3, and report the CSI at activity 1508 in the slower timeline 1524 according to the timing constraints Z and/or Z′ (or an additional time T) associated with the slower timeline 1524.

At activity 1510, the UE reports periodic CSI associated with model 2 using the shorter reference resource 1522.

At activity 1512, the UE receives an indication to activate semi-persistent CSI using a fourth model (Model 4). As Model 4 is not in the model-status 1520, the model-status 1520 is updated to include Model 4, where Model 3 is removed, and Model 4 is added.

At activity 1514, the UE reports the semi-persistent CSI using Model 4. As this is the initial transmission of the semi-persistent CSI for Model 4, the UE may apply a slower timeline corresponding to a longer reference resource 1526. For example, the UE may receive a reference signal no earlier than the timing reference (e.g., the third timing reference 524) associated with the slower timeline, which may have a longer duration for Y (e.g., the default duration plus additional time T).

At activity 1516, the UE reports periodic CSI associated with model 2 using the shorter reference resource 1522.

At activity 1518, the UE reports semi-persistent CSI associated with model 4 using the shorter reference resource 1522 due to this being a subsequent transmission of the semi-persistent CSI for Model 4.

In certain aspects, protections may be applied to prevent or handle back-to-back switching between active and inactive models. If a CSI report is triggered indicating a model switch (e.g., activating an inactive model), the UE may not be expected to perform certain actions during a time window (e.g., ending when the UE is scheduled to report the CSI). For example, in the time window, the UE may not be expected to receive any CSI requests that trigger any other CSI report (or an AI-based report), which is generated by a model not in the model-status. The UE may not be expected to transmit any other CSI report (or an AI-based report), which is generated by a model not in the model status. In the time window, the UE may ignore CSI requests using inactive models outside the model-status, or the UE may transmit dummy CSI in response to CSI requests using inactive models.

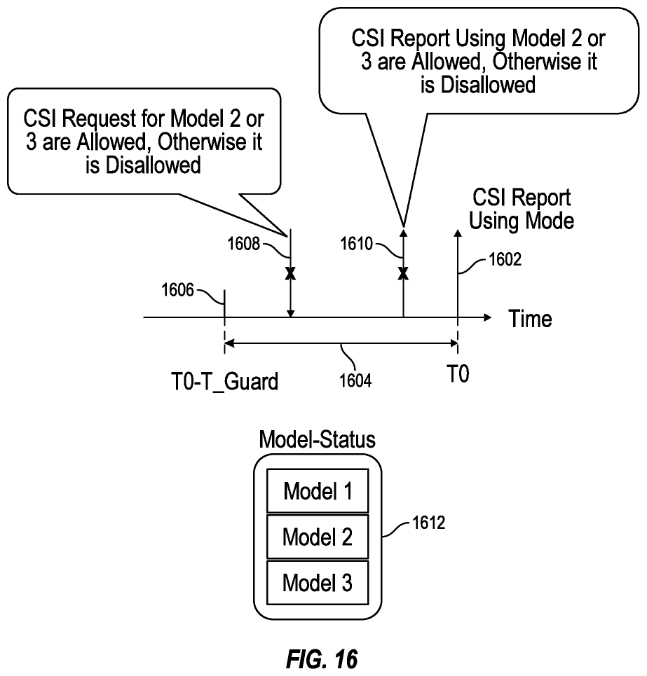

FIG. 16 is a timing diagram illustrating example protections for back-to-back model switching. In this example, a UE may have a first model (Model 1), a second model (Model 2), and a third model (Model 3) loaded as active models, such that a model-status 1612 includes the identifiers associated with Model 1, Model 2, and Model 3. The UE may be scheduled to report CSI using Model 1 at a reporting occasion 1602 (TO). The UE may not be expected to perform certain actions during a time window 1604 spanning from a timing reference 1606 (T0-T_guard) to the reporting occasion 1602. The duration of the time window 1604 may depend on the timeline (e.g., fast timeline or shorter timeline) applied to the CSI processing, for example, as described herein with respect to FIGS. 14 and 15. In some cases, the position of the timing reference 1606 may correspond to the short reference resource plus a number of symbols or slots (T), where T may be reported as a UE capability. In certain aspects, the duration of the time window may depend on the type of CSI being reported. For aperiodic CSI or an initial transmission of semi-persistent CSI, the time window 1604 may start when the CSI request is received or when the semi-persistent CSI is activated. For periodic CSI or subsequent transmissions of semi-persistent CSI, the time window 1604 may start a number of symbols (or slots) before the CSI reference resource (e.g., before the reception occasion 520). The duration of the time window supported by the UE may be reported as a UE capability.

In certain aspects, criteria for processing multiple machine learning models concurrently in an OFDM symbol may be supported. As used herein, concurrent processing may refer to performing processing at the same time. For example, the UE may have a capability to process a certain number of processing units associated with machine learning models in a particular time instance, where the time instance may include one or more OFDM symbols, one or more slots, or a predefined duration. The UE may indicate (to the radio access network) the number of supported simultaneous machine learning model processing units N_{MPU} in one or more component carriers, in one or more bands, or across all component carriers. In certain cases, the UE may report the MPUs that a particular machine learning model occupies in a time instance or duration (e.g., one or more OFDM symbols or slots), per one or more component carriers, per one or more bands, or across all component carriers. In certain cases, the MPU that each model occupies can be predefined. The MPU for each model can be the same or different.

The UE may determine the MPU allocation for each AI-based inference, reports or measurement (e.g., CSI report, beam management, positioning, or channel estimation) according to a particular rule for allocating unoccupied MPUs. If a UE supports N_{MPU} simultaneous machine learning calculations, the UE may have N_{MPU} model processing units (MPUs) for processing AI-based inference, reports, or measurement. If L MPUs are occupied for calculation of AI-based inference, reports or measurement in a given time instance (e.g., an OFDM symbol), the UE may have N_{MPU}-L unoccupied MPUs. For example, if S AI-based inferences, reports or measurements currently occupy MPUs, and there are N_{MPU}-L unoccupied MPUs, the UE may allocate the N_{MPU}-L MPUs to S′ requested AI-based reports according to a priority order, such that the sum of MPUs associated with the requested AI-based reports is less than or equal to the N_{MPU}-L unoccupied MPUs:

$${\sum }_{i = 0}^{{S}^{′} - 1} {O}_{MPU}^{( i )} \leq {N}_{MPU} - L ,$$

where

$${O}_{MPU}^{( i )}$$

is the number of MPUs allocated to the i-th AI-based report. In some aspects, if the model is already in an active state, the number of MPUs allocated to the i-th AI-based report may be equal to zero

$$( e . g . , {O}_{MPU}^{( i )} = 0 ) .$$

In some aspects, the number of MPUs allocated to an AI-based report

$$( {O}_{MPU}^{( i )} )$$

may depend on model complexity, and the UE may report the number of MPUs associated with a particular model to the radio access network as a UE capability. The priority order in which MPUs are allocated may be based on various criteria, such as a model identifier, carrier identifier, serving cell identifier, bandwidth part (subcarrier) identifier, report identifier, or any combination thereof. For example, the UE may allocate the MPUs to an AI-based report with a higher (or lower) model identifier than another AI-based report. The UE may not update the remaining S-S′ AI-based reports. In some case, the UE may report dummy information for the AI-based reports which are not allocated MPUs. In certain cases, the UE may report, to the radio access network, a budget of concurrent processing units (N_{MPU}). The UE may further report an identification number (or weight) for each particular supported model

$$( {O}_{MPU}^{( i )} ) ,$$

the allowed concurrent model combinations (set [symbol] ) and the number of allowed inferences (kᵢ). The sum of inferences per model may satisfy the following expression:

$${\sum }_{i ∈ 𝒮} {k}_{i} \times {O}_{MPU}^{( i )} \leq {N}_{MPU} .$$

For a model combination [symbol] ={model 1, model 2, . . . etc}, the UE may process upto kᵢ inferences for model i. In this case, the priority order for allocating MPUs may be used. The supported model concurrencies and their respective number of inference tasks are bounded by

$${\sum }_{i ∈ 𝒮} {k}_{i} \times {O}_{MPU}^{( i )} \leq {N}_{MPU} .$$

UE is not expected be allocated with any other model inference tasks that exceed this restriction.

In certain aspects, criteria for processing multiple machine learning models concurrently may be based on UE supported model combinations and a number of inference tasks associated with a machine learning model of each combination. The UE may report the concurrent inference capability associated with a combination of models. For example, for each model combination, the UE may report the concurrent inference capability in terms of a total number inference tasks that can be shared among all models in the respective combination and/or a number of inference tasks for each model in the respective combination. As an example, the UE may report a model combination including model 1 and model 2 (e.g., {model 1, model 2}) with up to three inference tasks, such that model 1 occupies two inference task as model 2 occupies one inference task, or model 1 occupies one inference task as model 2 occupies two inference tasks. As another example, the UE may report a model combination model 1 and model 2 where model 1 supports up to three inference tasks and model 2 supports up to two inference task. The UE may have the capability to concurrently process at most three inference tasks for model 1 and at most two inference tasks for model 2. In certain aspects, the UE may report multiple model combinations and the number of inference tasks for each particular combination.

In some cases, a triggered/configured inference report may use M inference tasks (or occupies M processing units) if the inference occasion is based on M measurement resources. For example, for AI-based CSI feedback, a triggered aperiodic CSI report may use M inference tasks if there are M CSI-RS resources for channel measurement. If an AI model is used by O triggered/configured inference, each with Mᵢ inference tasks, then there are total

$${\sum }_{i = 1}^{O} {M}_{i}$$

inference tasks for the AI model. If an inference trigger indicates to report multiple AI-model inference reports, including more inference tasks than the reported UE capability, the UE may only report the high priority inference(s), drop or not update (e.g., report a dummy report including old information or dummy information) the low priority reports that exceed the reported capability. The priority of AI-model inference reports may be based on model use case, model identifiers, carrier identifiers (e.g., serving cell identifier), and/or bandwidth part identifiers.

The MPU(s) associated with a model (or AI-based report) and/or the model inference task processing may occupy a certain amount of time (e.g., in terms of symbols). In some cases, the MPUs may be associated with the inference tasks or a model. For aperiodic CSI or an initial transmission of semi-persistent CSI, the corresponding MPUs(s) may be occupied from the first symbol after the PDCCH triggering a CSI report until the last symbol of the scheduled PUSCH carrying the report. For periodic CSI and subsequent transmissions of semi-persistent CSI, the corresponding MPU(s) may be occupied from the first symbol of the earliest one of each CSI-RS/CSI-IM/SSB resource for channel or interference measurement, respective latest CSI-RS/CSI-IM/SSB occasion no later than the corresponding CSI reference resource (e.g., from a last occasion of the reference signal that is prior to the report by a time duration), until the last symbol of the configured PUSCH/PUCCH carrying the report. In some cases, for aperiodic CSI, the corresponding MPU(s) may be occupied from the first symbol after the PDCCH triggering a CSI report until the last symbol of the scheduled PUSCH carrying the report. For periodic CSI and semi-persistent CSI, the corresponding MPU(s) may be occupied from the activation/configuration of the periodic or semi-persistent reporting until the deactivation/reconfiguration of the periodic or semi-persistent reporting. It will be appreciated that the duration of the MPU(s) described herein may be applied to inference task processing.

In certain aspects, criteria for processing multiple machine learning models concurrently may be based on a process identifier associated with a particular model. For example, the UE may report a model process identifier associated with each model. Models with the same process identifier may not support concurrent processing with each other, and models with different process identifiers may support concurrent processing with each other. Models with different process identifiers can be processed concurrently with each other.

It will be appreciated that the aspects described herein with respect to AI-based CSI reporting are merely an example of AI-based processing for wireless communications. The machine learning timelines and concurrent processing criteria described herein may be applied to other AI-generated information in addition to or instead of the AI-based CSI described herein. As an example, a UE may report beam management information, positioning information, channel estimation information, or any combination thereof using machine learning models in addition to or instead of the AI-based CSI described herein. As such, the UE may apply the various timelines and concurrent processing criteria described herein to generating AI-based CSI, beam management information, positioning information, channel estimation information, or any combination thereof.

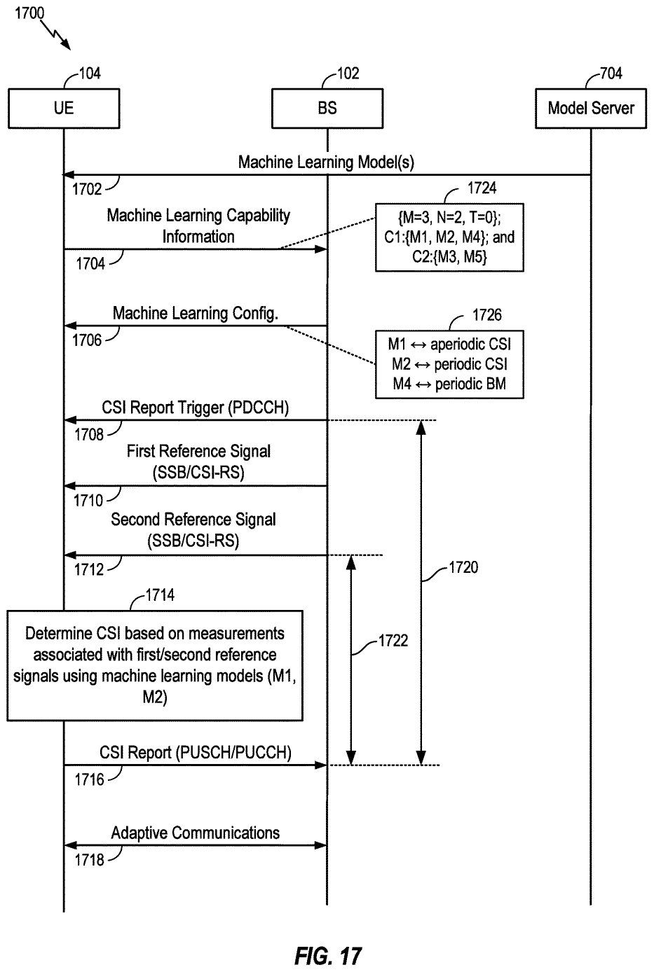

FIG. 17 depicts a process flow 1700 for communications in a network between a BS 102, a UE 104, and a model server 704. In some aspects, the BS 102 may be an example of the base stations depicted and described with respect to FIG. 1 and FIG. 3 or a disaggregated base station depicted and described with respect to FIG. 2. Similarly, the UE 104 may be an example of user equipment depicted and described with respect to FIGS. 1 and 3. However, in other aspects, the UE 104 may be another type of wireless communications device, and BS 102 may be another type of network entity or network node, such as those described herein.

At activity 1702, the UE 104 may receive, from the model server 704, information associated with one or more machine learning models, such as run-time images, setup parameters, and/or training data associated with the machine learning models. In some cases, the UE 104 may initially load at least some of the machine learning models as active models, for example, as described herein with respect to FIGS. 7 and 8.

At activity 1704, the UE 104 may transmit, to the BS 102, machine learning capability information 1724 indicating, for example, the capability of the UE to process and/or store active and/or inactive machine learning model(s). For example, the machine learning capability information 1724 may include values for M, N, and T (e.g., {M=3, N=2, T=0}) as described herein with respect to FIG. 9. The machine learning capability information 1724 may include combinations of machine learning models that the UE is capable of processing or storing concurrently, such as a first combination including a first model, a second model, and a fourth model (e.g., C1: {M1, M2, M4}), and a second combination including a third model and a fifth model (e.g., {M3, M5}). In some cases, the machine learning capability information 1724 may include the machine learning capability level supported by the UE, the maximum number of active machine learning models that a UE is capable of processing or storing (e.g., via the UE's modem), the maximum number of inactive machine learning models that the UE is capable of storing (e.g., in memory), the minimum amount of time used to activate an inactive machine learning model, combination(s) of machine learning models (and their respective number of inference tasks) the UE is capable of processing or storing concurrently, or any combination thereof. In certain aspects, the machine learning capability information 1724 may include any of the UE capability information described herein, such as the inference tasks supported by a combination of models or the process identifiers associated with models.

At activity 1706, the UE 104 may receive an indication of a machine learning configuration 1726 from the BS 102. The UE 104 may receive the machine learning configuration 1726 via RRC signaling (e.g., RRC configuration or reconfiguration), MAC signaling, and/or system information. The machine learning configuration 1726 may satisfy the machine learning capability associated with the UE 104. The machine learning configuration 1726 may indicate to use the first model for aperiodic CSI, the second model for periodic CSI, and the fourth model for periodic beam management. The UE 104 may load the first model, second model, and fourth model as active machine learning models, and the UE 104 may load the third model and fifth model as inactive machine learning models. As an example, the machine learning configuration 1726 may indicate to use the first model for aperiodic CSI via a model identifier associated with the first model in an aperiodic CSI configuration. In some cases, the machine learning configuration 1726 may further include configuration/reconfiguration of periodic/aperiodic CSI associated with a machine learning model and/or activation/deactivation of semi-persistent CSI associated with a machine learning model.

At activity 1708, the UE 104 may receive, from the BS 102, a trigger to report aperiodic CSI, for example, via a PDCCH carrying DCI indicating to report the CSI in a reporting occasion (e.g., the reporting occasion 504). The aperiodic CSI report may be associated with the first model. In some cases, the aperiodic CSI report trigger may indicate to measure a reference signal (e.g., a first reference signal) transmitted after the PDCCH triggering the CSI. It will be appreciated that the aperiodic CSI trigger is merely an example. An aperiodic trigger may indicate to report other information in addition to or instead of the CSI, such as beam management information and/or UE positioning information.

At activity 1710, the UE 104 may receive, from the BS 102, a first reference signal (e.g., an SSB and/or CSI-RS) associated with the aperiodic CSI report. At activity 1712, the UE 104 may receive, from the BS 102, a second reference signal (e.g., an SSB and/or CSI-RS) associated with a periodic CSI report. In some cases, the first reference signal may be associated with a different transmission setup (e.g., a narrower beam, a beam with a different angle of arrival (AoA), or a beam from a different cell or a different antenna layout including antenna architecture, TxRU to antenna element mapping) than the second reference signal. In certain cases, the first reference signal and/or second reference signal may be representative of an interference measurement resource, where the UE 104 may measure interference from other wireless devices (e.g., one or more UEs and/or base stations) in a reception occasion. It will be appreciated that periodic CSI is merely an example. The UE may be configured to periodically report (e.g., via a periodic reporting configuration or a semi-persistent activation) other AI-based information, such as beam management information and/or UE positioning information.

At activity 1714, the UE 104 may determine CSI based on measurements associated with the first reference signal and the second reference signal using the first machine learning model and the second machine learning model. The UE 104 may determine CSI based on measurements associated with the first reference signal using the first machine learning model, and the UE 104 may determine other CSI based on measurements associated with the second reference signal using the second machine learning model.

In some cases, the UE 104 may determine the CSI using the first machine learning model while determining the other CSI using the second machine learning model if a machine learning processing constraint is satisfied, for example, as described herein. Suppose, for example, that MPU(s) (or a number of concurrent inference tasks) associated with the first machine learning model are occupied for a first time period 1720 starting when the PDCCH is received and ending when a CSI report is transmitted, and MPU(s) (or a number of concurrent inference tasks) associated the second machine learning model are occupied for a second time period 1722 starting when the second reference signal is received and ending when the CSI report is transmitted. If the MPU(s) (or a number of concurrent inference tasks) associated with the first machine learning model and the second machine learning model satisfy a threshold, the UE 104 may perform the simultaneous machine learning model calculations for the first machine learning model and the second machine learning model. For example, if the sum of the MPU(s) (or a number of concurrent inference tasks) associated with the first machine learning model and the second machine learning model is less than or equal to the unoccupied MPUs (or a number of concurrent inference tasks) in the time period when the first time period 1720 and the second time period 1722 overlap, the UE 104 may perform the concurrent machine learning model operations using the first machine learning model and the second machine learning model.

At activity 1716, the UE 104 may transmit, to the BS 102, a CSI report including the CSI associated with the first reference signal and the second reference signal, for example, via a PUSCH or PUCCH.

At activity 1718, the UE 104 may communicate with the BS 102 via an adaptive communications link, where the link may be adapted based on the CSI report. For example, the BS 102 may adjust the modulation and coding scheme (MCS), subcarrier spacing, frequency, bandwidth, and/or coding rate in response to the CSI report. As another example, the BS 102 may change the beam(s) used for communications in response to the CSI report.

It will be appreciated that the AI-based CSI reporting is merely an example. The UE may be configured or triggered to report other AI-based information in addition to or instead of the CSI, such as beam management information, UE positioning information, and/or (CSI-RS or DMRS) channel estimation. The UE may be configured to report the AI-based information as an aperiodic report, periodic report, or semi-persistent report, or layer-3 report (e.g., an RRC report). For beam management, the UE may be configured with reference signals associated with beams for beam management, and the UE may report AI-based beam management information in response to an aperiodic trigger, periodic reporting configuration, and/or semi-persistent reporting activation. The UE may report on a preferred beam to use in future transmission occasions, for example. For UE positioning, the UE may be configured with reference signals to use to determine UE positioning, and the UE may report the UE positioning in response to an aperiodic trigger, a periodic reporting configuration, and/or semi-persistent reporting activation. For channel estimation, the UE may be configured with reference signals to perform the channel estimation, and the UE may perform the channel estimation in response to an aperiodic trigger, a periodic configuration, and/or semi-persistent activation.

### Example Operations of a User Equipment

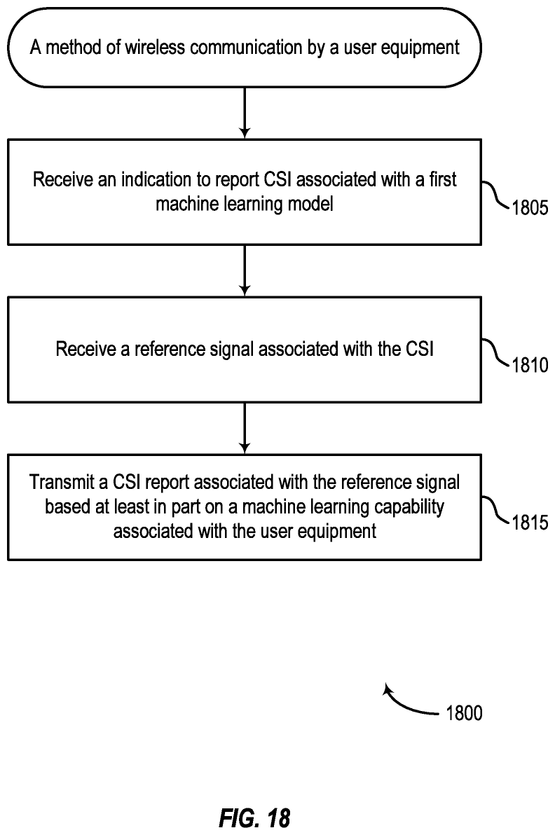

FIG. 18 shows an example of a method 1800 of wireless communication by a user equipment, such as a UE 104 of FIGS. 1 and 3.

Method 1800 may optionally begin at step 1805, where the UE may receive an indication to report CSI (e.g., the AI-based report 710) associated with a first machine learning model (e.g., one of the active machine learning models 718 or inactive machine learning models 720). The indication to report CSI may include a configuration for periodic CSI, an activation for semi-persistent CSI, and/or a trigger for aperiodic CSI. The UE may receive the indication from a network entity, such as the BS 102, via DCI, RRC signaling, MAC signaling, and/or system information. In some cases, the operations of this step refer to, or may be performed by, circuitry for receiving and/or code for receiving as described with reference to FIG. 24.

Method 1800 then proceeds to step 1810, where the UE may receive, from the network entity, a reference signal or an interference measurement resource associated with the CSI, for example, as described herein with respect to FIGS. 7 and 17. The reference signal may include a DMRS, a CSI-RS, an SSB, and/or a phase tracking reference signal (PTRS), for example. The interference measurement resource may include a time-frequency resource to measure interference at the UE from other wireless communication devices, such as other UE(s) or base station(s). The UE may determine the CSI based on measurements associated with the reference signal using the first machine learning model. The UE may receive the reference signal before and/or after receiving the indication to report CSI. In some cases, the operations of this step refer to, or may be performed by, circuitry for receiving and/or code for receiving as described with reference to FIG. 24.

Method 1800 then proceeds to step 1815, where the UE may transmit, to the network entity, a CSI report associated with the reference signal or the interference measurement resource based at least in part on a machine learning capability associated with the user equipment. For example, in certain aspects, certain timing criteria may be associated with the machine learning capability, for example, as described herein with respect to FIGS. 11A-15. In some aspects, transmitting the CSI report at step 1815 comprises transmitting the CSI report in response to a timing constraint being satisfied, where the timing constraint may be based at least in part on the machine learning capability. In some aspects, the timing constraint may be satisfied if an event (e.g., transmitting the CSI report, receiving the reference signal, or measuring the interference) either occurs before (e.g., occurs no later than) or starts no earlier than (e.g., occurs after) a timing reference (e.g., the first timing reference 508, the second timing reference 512, or the third timing reference 524), for example, as described herein with respect to FIGS. 5A and 5B. As an example, for aperiodic CSI, the timing constraint may be satisfied if the event (e.g., transmitting the CSI report) starts no earlier than the timing reference as described in connection with FIG. 5A. For periodic or semi-persistent CSI, the timing constraint may be satisfied if the event (e.g., receiving the reference signal or measuring an interference measurement resource) occurs before the timing reference as described in connection with FIG. 5B. A position in time of the timing reference may be determined based at least in part on the machine learning capability. In some cases, the operations of this step refer to, or may be performed by, circuitry for transmitting and/or code for transmitting as described with reference to FIG. 24.

In certain aspects, the machine learning capability may be in terms of certain capability parameters or model combinations. For example, the machine learning capability may include: a first number (e.g., M) of one or more active machine learning models capable of being processed by (having a capability to be processed at) the user equipment; a second number (e.g., N) of one or more inactive machine learning models capable of being processed by the user equipment; a delay (e.g., additional time, T) for switching between an active machine learning model and an inactive machine learning model; a combination of machine learning models that are capable of being processed in an active state (e.g., the active machine learning models 718) or an inactive state (e.g., the inactive machine learning models 720); or any combination thereof.

In certain aspects, the machine learning capability may be in terms of a level or category, for example, the levels as described herein with respect to FIG. 9. In some aspects, the machine learning capability includes: a first capability (e.g., level 1.0) to have at most a single active machine learning model and zero inactive machine learning models; a second capability (e.g., level 1.1) to have at most a single active machine learning model, one or more inactive machine learning models, and a first duration (e.g., Z+T) to process (for processing) an inactive machine learning model; and a third capability (e.g., level 1.2) to have at most a single active machine learning model, one or more inactive machine learning models, and a second duration (e.g., Z) to process (for processing) the inactive machine learning model, where the first duration may be longer than the second duration. The machine learning capability may further include a fourth capability (e.g., level 2.0) to have one or more active machine learning models and zero inactive machine learning models; a fifth capability (e.g., level 2.1) to have one or more active machine learning models, one or more inactive machine learning models, and a third duration (e.g., Z+T) to process (for processing) the inactive machine learning model; or a sixth capability (e.g., level 2.2) to have one or more active machine learning models, one or more inactive machine learning models, and a fourth duration (e.g., Z) to process (for processing) the inactive machine learning model, where the third duration may be longer than the fourth duration.

In some aspects, the method 1800 further includes transmitting an indication of the machine learning capability (e.g., the machine learning capability information 1724). In some cases, the operations of this step refer to, or may be performed by, circuitry for transmitting and/or code for transmitting as described with reference to FIG. 24.

In some aspects, the method 1800 further includes receiving a configuration (e.g., the machine learning configuration 1726) indicating a first set of one or more active machine learning models (e.g., the active machine learning models 718) and indicating a second set of one or more inactive machine learning models (e.g., the inactive machine learning models 720). A first total of the first set of one or more active machine learning models is less than or equal to the first number of one or more active machine learning models. A second total of the second set of one or more inactive machine learning models is less than or equal to the second number of one or more inactive machine learning models. In some cases, the operations of this step refer to, or may be performed by, circuitry for receiving and/or code for receiving as described with reference to FIG. 24.

In certain aspects, the UE may load the active models at different times in response to a configuration indicating active models, for example, as described herein with respect to FIG. 8. In some cases, the UE may download model information in response to receiving a configuration and load the model information. In some aspects, the method 1800 further includes receiving a configuration (e.g., the machine learning configuration 1726) indicating to use the first machine learning model for CSI reporting. In certain cases, the configuration may indicate a first set of one or more active machine learning models and/or a second set of one or more inactive machine learning models. In some cases, the operations of this step refer to, or may be performed by, circuitry for receiving and/or code for receiving as described with reference to FIG. 24. In some aspects, the method 1800 further includes receiving, in response to receiving the configuration, first information (e.g., training data, run-time image(s), and/or setup parameter(s)) associated with the first set of one or more active machine learning models and second information (e.g., training data, run-time image(s), and/or setup parameter(s)) associated with the second set of one or more inactive machine learning models. In some cases, the operations of this step refer to, or may be performed by, circuitry for receiving and/or code for receiving as described with reference to FIG. 24. In some aspects, the method 1800 further includes loading the first information in a modem (e.g., the modulators and demodulators of the transceivers 354). In some cases, the operations of this step refer to, or may be performed by, circuitry for loading and/or code for loading as described with reference to FIG. 24.

In some cases, the UE may download model information before receiving a configuration and load the model information in response to receiving the configuration. In some aspects, the method 1800 further includes receiving a configuration (e.g., the machine learning configuration 1726) indicating to use the first machine learning model for CSI reporting. In certain cases, the configuration may indicate a first set of one or more active machine learning models and/or a second set of one or more inactive machine learning models. In some cases, the operations of this step refer to, or may be performed by, circuitry for receiving and/or code for receiving as described with reference to FIG. 24. In some aspects, the method 1800 further includes receiving first information associated with the first set of one or more active machine learning models and second information associated with the second set of one or more inactive machine learning models. In some cases, the operations of this step refer to, or may be performed by, circuitry for receiving and/or code for receiving as described with reference to FIG. 24. In some aspects, the method 1800 further includes loading the first information in a modem (e.g., the modulators and demodulators of the transceivers 354) in response to receiving the configuration. In some cases, the operations of this step refer to, or may be performed by, circuitry for loading and/or code for loading as described with reference to FIG. 24.

In certain aspects, the UE may report to the radio access network that the UE has successfully loaded active models, for example, as described herein with respect to FIG. 8. In some aspects, the method 1800 further includes transmitting, in response to receiving the configuration, an acknowledgement (e.g., the acknowledgement at activity 810) that at least one of the first set of one or more active machine learning models is successfully loaded. In some cases, the operations of this step refer to, or may be performed by, circuitry for transmitting and/or code for transmitting as described with reference to FIG. 24. In some aspects, transmitting the acknowledgement comprises transmitting a plurality of acknowledgements (e.g., an acknowledgement per model), where each of the acknowledgements is for (a different) one of the first set of one or more active machine learning models. In some aspects, transmitting the acknowledgement comprises transmitting the acknowledgement in a time window (e.g., the time window 812) starting when the configuration is received. In some aspects, a duration associated with the time window depends on the first number of one or more active machine learning models or the second number of one or more inactive machine learning models.

In some aspects, the method 1800 further includes determining the CSI report based on a non-artificial intelligence codebook if an acknowledgement is not transmitted in a time window (e.g., the time window 812) starting when the configuration is received, where the acknowledgement indicates that at least one of the first set of one or more active machine learning models is successfully loaded. In some cases, the operations of this step refer to, or may be performed by, circuitry for determining and/or code for determining as described with reference to FIG. 24.

In some cases, after downloading and/or loading active models, the UE may report to the network entity the machine learning models that are available for processing at the UE (e.g., the models in the active state). The UE may indicate the models that support a fast timeline as an initial set of active models, as described herein. In some aspects, the method 1800 further includes transmitting (in response to receiving the configuration) an indication of a timing constraint (e.g., Z, Z′, and/or Y) associated with at least one of the first set of one or more active machine learning models. In some cases, the operations of this step refer to, or may be performed by, circuitry for transmitting and/or code for transmitting as described with reference to FIG. 24.

In one aspect, method 1800, or any aspect related to it, may be performed by an apparatus, such as communications device 2400 of FIG. 24, which includes various components operable, configured, or adapted to perform the method 1800. Communications device 2400 is described below in further detail.

Note that FIG. 18 is just one example of a method, and other methods including fewer, additional, or alternative steps are possible consistent with this disclosure.

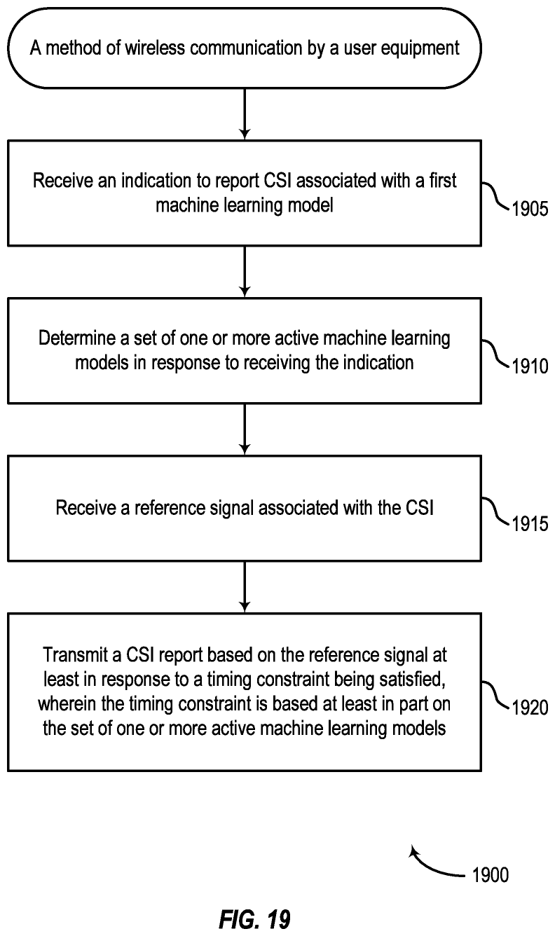

FIG. 19 shows an example of a method 1900 of wireless communication by a user equipment, such as a UE 104 of FIGS. 1 and 3.

Method 1900 may optionally begin at step 1905, where the UE may receive an indication to report CSI associated with a first machine learning model, for example, as described herein with respect to FIG. 18. In some cases, the operations of this step refer to, or may be performed by, circuitry for receiving and/or code for receiving as described with reference to FIG. 24.

Method 1900 then proceeds to step 1910, where the UE may determine a set of one or more active machine learning models (e.g., the model-status 1420, 1520) in response to receiving the indication. In some aspects, the set includes a series of one or more identifiers associated with the one or more active machine learning models (e.g., model identifiers, CSI report identifiers, etc.). In some cases, the operations of this step refer to, or may be performed by, circuitry for determining and/or code for determining as described with reference to FIG. 24.

Method 1900 may then proceed to step 1915, where the UE may receive a reference signal or an interference measurement resource associated with the CSI, for example, as described herein with respect to FIG. 18. In some cases, the operations of this step refer to, or may be performed by, circuitry for receiving and/or code for receiving as described with reference to FIG. 24.

Method 1900 then proceeds to step 1920, where the UE may transmit a CSI report based on the reference signal or the interference measurement resource at least in response to a timing constraint being satisfied, where the timing constraint is based at least in part on the set of one or more active machine learning models. The timing constraint may be representative of the timing constraints described herein with respect to FIGS. 5A, 5B, and 12A-15. In some aspects, the timing constraint may be satisfied if an event (e.g., transmitting the CSI report and/or receiving the reference signal) occurs before or starts no earlier than a timing reference (e.g., the first timing reference 508, the second timing reference 512, or the third timing reference 524), where a position in time of the timing reference is determined based at least in part on a machine learning capability associated with the user equipment. In some cases, the operations of this step refer to, or may be performed by, circuitry for transmitting and/or code for transmitting as described with reference to FIG. 24.

In certain aspects, the timing constraint may be associated with Z for aperiodic CSI as described herein with respect to FIG. 5A. In some aspects, the indication further indicates to report the CSI in a reporting occasion (e.g., the reporting occasion 504). The event includes (transmitting in) the reporting occasion. The timing reference may be positioned in time a first number of one or more symbols (e.g., Z) after a last symbol of the indication triggering the CSI report.

For certain aspects, the timing constraint may be associated with Z′ for aperiodic as described herein with respect to FIG. 5A. In some aspects, the indication further indicates to report the CSI in a reporting occasion (e.g., the reporting occasion 504). The event includes (transmitting in) the reporting occasion. The timing reference is positioned in time a second number of one or more symbols (e.g., Z′) after a last symbol of the reference signal or the interference measurement resource.

In certain aspects, the timing constraint may be associated with Y for periodic CSI and/or semi-persistent CSI as described herein with respect to FIG. 5B. In some aspects, the indication further indicates to report the CSI in a reporting occasion (e.g., the reporting occasion 522). The CSI report includes periodic CSI or semi-persistent CSI. The event includes (receiving in) a reception occasion (e.g., the reception occasion 520) associated with the reference signal or the interference measurement resource. The timing reference is positioned in time a third number of one or more symbols (e.g., Y) before the reporting occasion.

In some aspects, the method 1900 further includes selecting a first value for the third number of one or more symbols if the first machine learning model is in the set of one or more active machine learning models. In some aspects, the method 1900 further includes selecting a second value for the third number of one or more symbols if the first machine learning model is not in the set of one or more active machine learning models, where the second value is different than the first value. For example, the first value may be less than the second value. In some cases, the operations of this step refer to, or may be performed by, circuitry for selecting and/or code for selecting as described with reference to FIG. 24.

In some aspects, the method 1900 further includes selecting a first value for the third number of one or more symbols if the CSI report includes periodic CSI. In some aspects, the method 1900 further includes selecting a second value for the third number of one or more symbols if the CSI report is an initial transmission associated with semi-persistent CSI. In some aspects, the method 1900 further includes selecting a third value for the third number of one or more symbols if the CSI report is a subsequent transmission associated with semi-persistent CSI, where the second value is different than the third value (e.g., the second value may be greater than the third value). In some cases, the operations of this step refer to, or may be performed by, circuitry for selecting and/or code for selecting as described with reference to FIG. 24.

In certain aspects, the UE may report, to the network entity, information associated with the timing constraint. In some aspects, the method 1900 further includes transmitting an indication of the position in time of the timing reference. For example, the UE may indicate the length or duration of certain timing constraints, such as Z, Z′, and/or Y, for a particular machine learning model. In some cases, the operations of this step refer to, or may be performed by, circuitry for transmitting and/or code for transmitting as described with reference to FIG. 24. In some aspects, the position in time of the timing reference may depend in part on: an identifier associated with the first machine learning model (e.g., a CSI report identifier, a model identifier, etc.), a rank indicator associated with one or more transmission layers, if a CSI feedback decoder is available to process the CSI, if another machine learning model is active, or any combination thereof.

In some aspects, the method 1900 further includes determining the position in time of the timing reference based at least in part on the set of one or more active machine learning models. In some cases, the operations of this step refer to, or may be performed by, circuitry for determining and/or code for determining as described with reference to FIG. 24. In some aspects, the timing reference is positioned in time: a first number of one or more symbols after a last symbol of the indication triggering the CSI report (e.g., the timing reference is associated with Z), a second number of one or more symbols after a last symbol of the reference signal (e.g., the timing reference is associated with Z′), or a third number of one or more symbols before a reporting occasion associated with the CSI report (e.g., the timing reference is associated with Y). In some aspects, determining the position in time of the timing reference comprises: selecting a first value for the first number of one or more symbols, a second value for the second number of one or more symbols, or a third value for the third number of one or more symbols if the first machine learning model is in the set of one or more active machine learning models; and selecting a fourth value for the first number of one or more symbols, a fifth value for the second number of one or more symbols, or a sixth value for the third number of one or more symbols if the first machine learning model is not in the set of one or more active machine learning models, where the second value is different than the first value (e.g., the first value is greater than the second value). In some aspects, the first value is less than the fourth value; the second value is less than the fifth value; and the third value is less than the sixth value.

In some aspects, the method 1900 further includes transmitting an indication of a machine learning capability associated with the user equipment, where the machine learning capability includes a first number of one or more active machine learning models capable of being processed by the user equipment, and where a total number of machine learning models in the set is less than or equal to the first number. In some aspects, the method 1900 further includes transmitting an indication of a machine learning capability associated with the user equipment, where the machine learning capability includes a combination of machine learning models that are capable of being processed in an active state, and where the one or more active machine learning models in the set are in the combination of machine learning models. In some cases, the operations of this step refer to, or may be performed by, circuitry for transmitting and/or code for transmitting as described with reference to FIG. 24.

In certain aspects, the set of one or more active machine learning models may include an ordered series, where certain rules may be used to add or remove entries in the series. In some aspects, determining the set comprises updating the set to include the first machine learning model in response to receiving the indication to report the CSI if the first machine learning model is not in the set. In some aspects, updating the set comprises: removing a first identifier or a last identifier associated with a second machine learning model from the set; and adding an identifier associated with the first machine learning model to the set. In some aspects, updating the set comprises: removing a second machine learning model from the set; transmitting an indication that the second machine learning model is removed from the set; and adding the first machine learning model to the set.

In some aspects, the indication further indicates to report CSI associated with the first machine learning model and a second machine learning model in a same UCI; inserting the first machine learning model in a first position of the set if the first machine learning model is associated with an identifier having a smaller value than the second machine learning model; and inserting the second machine learning model in the first position of the set if the second machine learning model is associated with a smaller identifier than the first machine learning model. In some cases, the operations of this step refer to, or may be performed by, circuitry for inserting and/or code for inserting as described with reference to FIG. 24.

In certain aspects, certain rule(s) may be applied to prevent or handle back-to-back indications to use inactive machine learning models, for example, as described herein with respect to FIG. 16. In some aspects, the method 1900 further includes ignoring an indication to report CSI associated with a second machine learning model not in the set of one or more machine learning models in response to a third timing constraint being satisfied. In some cases, the operations of this step refer to, or may be performed by, circuitry for ignoring and/or code for ignoring as described with reference to FIG. 24. In some aspects, the method 1900 further includes refraining from transmitting another CSI report associated with the second machine learning model in response to the third timing constraint being satisfied. In some cases, the operations of this step refer to, or may be performed by, circuitry for refraining and/or code for refraining as described with reference to FIG. 24. In some aspects, the third timing constraint is satisfied: if the indication to report CSI associated with the second machine learning model is received in a time window ending at a reporting occasion in which the CSI report is transmitted, or if the other CSI report is scheduled to be reported in the time window. In some aspects, the time window starts when the indication to report the CSI associated with the first machine learning model is received for aperiodic CSI or an initial transmission of semi-persistent CSI; and the time window starts a third number of one or more symbols before the reference signal (or the interference measurement resource) for periodic CSI or subsequent transmissions of the semi-persistent CSI. In some aspects, the third number of one or more symbols depends on whether the first machine learning model is in a set of one or more active machine learning models. In some aspects, the method 1900 further includes transmitting an indication of the third number of one or more symbols. In some cases, the operations of this step refer to, or may be performed by, circuitry for transmitting and/or code for transmitting as described with reference to FIG. 24.

In one aspect, method 1900, or any aspect related to it, may be performed by an apparatus, such as communications device 2400 of FIG. 24, which includes various components operable, configured, or adapted to perform the method 1900. Communications device 2400 is described below in further detail.

Note that FIG. 19 is just one example of a method, and other methods including fewer, additional, or alternative steps are possible consistent with this disclosure.

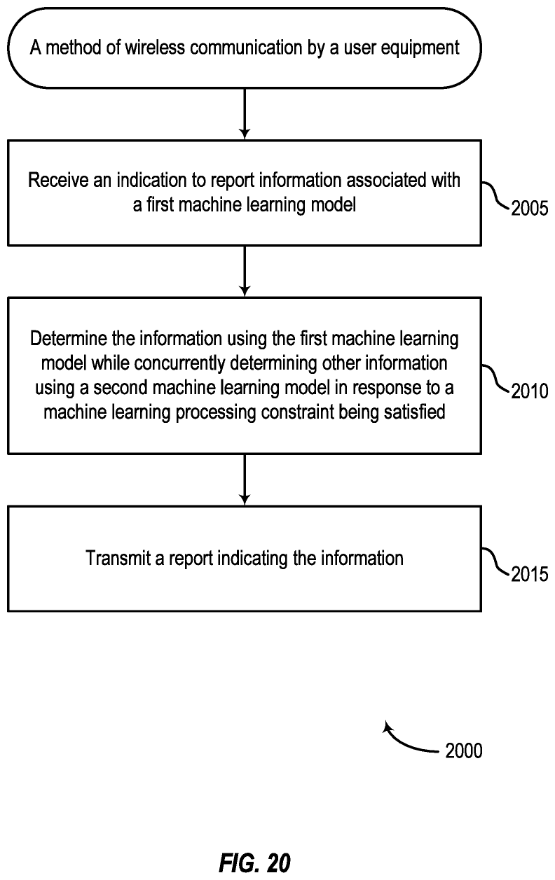

FIG. 20 shows an example of a method 2000 of wireless communication by a user equipment, such as a UE 104 of FIGS. 1 and 3.

Method 2000 may optionally begin at step 2005, where the UE may receive an indication to report information (e.g., the AI-based report 710) associated with a first machine learning model, for example, as described herein with respect to FIG. 18. In some aspects, the information includes channel state information, beam management information, positioning information, channel estimation information, or any combination thereof. In some cases, the operations of this step refer to, or may be performed by, circuitry for receiving and/or code for receiving as described with reference to FIG. 24.

Method 2000 then proceeds to step 2010, where the UE may determine the information using the first machine learning model while concurrently determining other information using a second machine learning model in response to a machine learning processing constraint being satisfied, for example, the concurrent processing criteria described herein. In some cases, the operations of this step refer to, or may be performed by, circuitry for determining and/or code for determining as described with reference to FIG. 24.

Method 2000 then proceeds to step 2015, where the UE may transmit a report indicating the information. In some cases, the operations of this step refer to, or may be performed by, circuitry for transmitting and/or code for transmitting as described with reference to FIG. 24.

In some aspects, the method 2000 further includes transmitting an indication of a machine learning capability including: a combination of machine learning models that are capable of being processed in an active state or an inactive state; a first number of inference tasks that can be shared among models in a set of active machine learning models or the combination, a second number of one or more inference tasks for each model in the set of active machine learning models or the combination, a threshold associated with the machine learning processing constraint per one or more subcarriers, per one or more carriers, or per one or more bands; or a combination thereof. In some cases, the operations of this step refer to, or may be performed by, circuitry for transmitting and/or code for transmitting as described with reference to FIG. 24.

In certain aspects, the machine learning processing constraint may be associated with inference tasks as described herein. In some aspects, the machine learning processing constraint may be satisfied: if a first total number of inference tasks associated with the first machine learning model and the second machine learning model is less than or equal to the first number; if a second total number of inference tasks associated with the first machine learning model is less than or equal to the second number associated with the first machine learning model; and if a third total number of inference tasks associated with the second machine learning model is less than or equal to the second number associated with the second machine learning model.

In certain aspects, the machine learning processing constraint may be associated with a model processing unit as described herein. In some aspects, the machine learning processing constraint may be satisfied if a total number of processing units associated with active machine learning models is less than or equal to a threshold. In some aspects, the method 2000 further includes transmitting an indication of a first number of one or more processing units associated with the first machine learning model and a second number of one or more processing units associated with the second machine learning model. In some cases, the operations of this step refer to, or may be performed by, circuitry for transmitting and/or code for transmitting as described with reference to FIG. 24. In some aspects, a number of one or more processing units associated with the first machine learning model is equal to zero if the first machine learning model is in an active state. In some aspects, the method 2000 further includes allocating unoccupied processing units to the first machine learning model based at least in part on priorities associated with the active machine learning models. In some cases, the operations of this step refer to, or may be performed by, circuitry for allocating and/or code for allocating as described with reference to FIG. 24. In some aspects, the priorities associated with the active machine learning models are based at least in part on: a model identifier, a carrier identifier, a bandwidth part identifier, a CSI report identifier, or any combination thereof.

In some aspects, one or more processing units or one or more inference tasks associated with the first machine learning model are occupied from when the indication is received until the report is transmitted if the report includes aperiodic CSI or an initial transmission associated with semi-persistent CSI; and the one or more processing units or the one or more inference tasks associated with the first machine learning model are occupied from when a last occasion associated with a reference signal (or an interference measurement resource) is received prior to a timing reference (e.g., the CSI reference resource such as the third timing reference 524) until the report is transmitted if the report includes periodic CSI or a subsequent transmission associated with semi-persistent CSI.

In some aspects, one or more processing units or one or more inference tasks associated with the first machine learning model are occupied from when the indication is received until the report is transmitted if the report includes aperiodic CSI; and the one or more processing units or the one or more inference tasks associated with the first machine learning model are occupied from when activation or configuration of the report is received until deactivation or reconfiguration of the report is received if the report includes periodic CSI or semi-persistent CSI, where the reconfiguration may disable the periodic report.

In some aspects, the method 2000 further includes transmitting an indication of a process identifier for each of a plurality of machine learning models, where the process identifier indicates whether the corresponding machine learning model is capable of concurrent processing with another machine learning model. In some cases, the operations of this step refer to, or may be performed by, circuitry for transmitting and/or code for transmitting as described with reference to FIG. 24. In some aspects, concurrent processing is allowed for machine learning models with different process identifiers.

In one aspect, method 2000, or any aspect related to it, may be performed by an apparatus, such as communications device 2400 of FIG. 24, which includes various components operable, configured, or adapted to perform the method 2000. Communications device 2400 is described below in further detail.

Note that FIG. 20 is just one example of a method, and other methods including fewer, additional, or alternative steps are possible consistent with this disclosure.

### Example Operations of a Network Entity

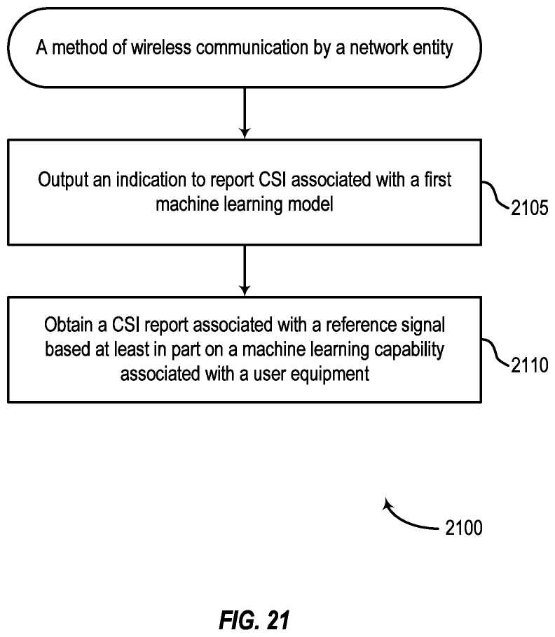

FIG. 21 shows an example of a method 2100 of wireless communication by a network entity, such as a BS 102 of FIGS. 1 and 3, or a disaggregated base station as discussed with respect to FIG. 2. The method 2100 may be complementary to the method 1800 performed by the UE.

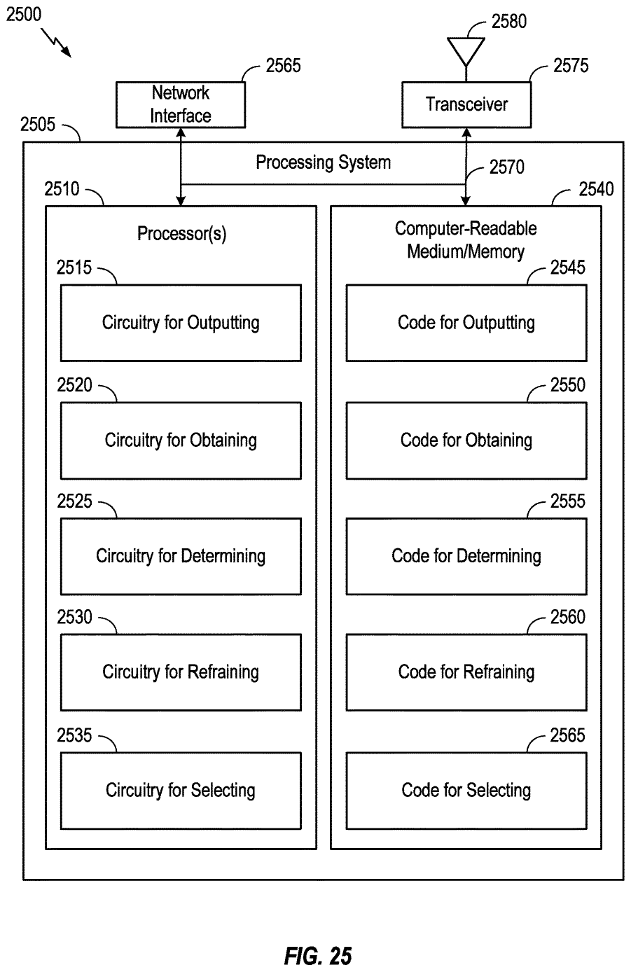

Method 2100 may optionally begin at step 2105, where the network entity may output (e.g., output for transmission, transmit, or provide), to a UE (e.g., the UE 104), an indication to report CSI associated with a first machine learning model. For example, the network may transmit the indication to a UE, such as the UE 104, via DCI, RRC signaling, MAC signaling, and/or system information. In some cases, the operations of this step refer to, or may be performed by, circuitry for outputting and/or code for outputting as described with reference to FIG. 25.

Method 2100 then proceeds to step 2110, where the network entity may obtain, from the UE, a CSI report associated with a reference signal or an interference measurement resource based at least in part on a machine learning capability associated with a user equipment (e.g., the UE 104). For example, the network entity may receive the CSI report via the PUSCH or PUCCH. In some cases, the operations of this step refer to, or may be performed by, circuitry for obtaining and/or code for obtaining as described with reference to FIG. 25.

In some aspects, the method 2100 further includes outputting a reference signal associated with the CSI, for example, as described herein with respect to FIGS. 7 and 17.

In some aspects, obtaining the CSI report comprises obtaining the CSI report in response to a timing constraint being satisfied, where the timing constraint is based at least in part on the machine learning capability. In some aspects, the timing constraint is satisfied if an event occurs before or starts no earlier than a timing reference, where a position in time of the timing reference is determined based at least in part on the machine learning capability. In some cases, the operations of this step refer to, or may be performed by, circuitry for outputting and/or code for outputting as described with reference to FIG. 25.

In some aspects, the machine learning capability includes: a first number of one or more active machine learning models capable of being processed by the user equipment; a second number of one or more inactive machine learning models capable of being processed by the user equipment; a delay for switching between an active machine learning model and an inactive machine learning model; a combination of machine learning models that are capable of being processed in an active state or an inactive state; or any combination thereof.

In some aspects, the method 2100 further includes outputting a configuration indicating a first set of one or more active machine learning models and indicating a second set of one or more inactive machine learning models, where a first total of the first set of one or more active machine learning models is less than or equal to the first number of one or more active machine learning models, and where a second total of the second set of one or more inactive machine learning models is less than or equal to the second number of one or more inactive machine learning models. In some cases, the operations of this step refer to, or may be performed by, circuitry for outputting and/or code for outputting as described with reference to FIG. 25.

In some aspects, the machine learning capability includes: a first capability to have at most a single active machine learning model and zero inactive machine learning models; a second capability to have at most a single active machine learning model, one or more inactive machine learning models, and a first duration to process (for processing) an inactive machine learning model; a third capability to have at most a single active machine learning model, one or more inactive machine learning models, and a second duration to process (for processing) the inactive machine learning model, where the first duration is longer than the second duration; a fourth capability to have one or more active machine learning models and zero inactive machine learning models; a fifth capability to have one or more active machine learning models, one or more inactive machine learning models, and a third duration to process (for processing) the inactive machine learning model; or a sixth capability to have one or more active machine learning models, one or more inactive machine learning models, and a fourth duration to process (for processing) the inactive machine learning model, where the third duration is longer than the fourth duration.

In some aspects, the method 2100 further includes obtaining an indication of the machine learning capability. In some cases, the operations of this step refer to, or may be performed by, circuitry for obtaining and/or code for obtaining as described with reference to FIG. 25.

In some aspects, the method 2100 further includes outputting a configuration indicating to use the first machine learning model for CSI reporting. In some aspects, the configuration may indicate a first set of one or more active machine learning models and/or a second set of one or more inactive machine learning models. In some cases, the operations of this step refer to, or may be performed by, circuitry for outputting and/or code for outputting as described with reference to FIG. 25.

In some aspects, the method 2100 further includes obtaining, in response to receiving the configuration, an acknowledgement that at least one of the first set of one or more active machine learning models is successfully loaded at the user equipment. In some cases, the operations of this step refer to, or may be performed by, circuitry for obtaining and/or code for obtaining as described with reference to FIG. 25. In some aspects, obtaining the acknowledgement comprises obtaining a plurality of acknowledgements, where each of the acknowledgements is for one of the first set of one or more active machine learning models. In some aspects, obtaining the acknowledgement comprises obtaining the acknowledgement in a time window starting when the configuration is output. In some aspects, a duration associated with the time window depends on the first number of one or more active machine learning models or the second number of one or more inactive machine learning models. In some aspects, the method 2100 further includes outputting a configuration indicating to use the first machine learning model for CSI reporting, where the CSI report is based on a non-artificial intelligence codebook if an acknowledgement is not obtained in a time window starting when the configuration is output, where the acknowledgement indicates that at least one of the first set of one or more active machine learning models is successfully loaded at the user equipment. In some cases, the operations of this step refer to, or may be performed by, circuitry for outputting and/or code for outputting as described with reference to FIG. 25.

In some cases, after downloading and/or loading active models, the UE may report to the network entity the machine learning models that are available for processing at the UE (e.g., the models in the active state). The UE may indicate the models that support a fast timeline as an initial set of active models, as described herein. In some aspects, the method 2100 further includes obtaining, in response to outputting the configuration, an indication of a timing constraint associated with at least one of the first set of one or more active machine learning models. In some cases, the operations of this step refer to, or may be performed by, circuitry for obtaining and/or code for obtaining as described with reference to FIG. 25.

In one aspect, method 2100, or any aspect related to it, may be performed by an apparatus, such as communications device 2500 of FIG. 25, which includes various components operable, configured, or adapted to perform the method 2100. Communications device 2500 is described below in further detail.

Note that FIG. 21 is just one example of a method, and other methods including fewer, additional, or alternative steps are possible consistent with this disclosure.

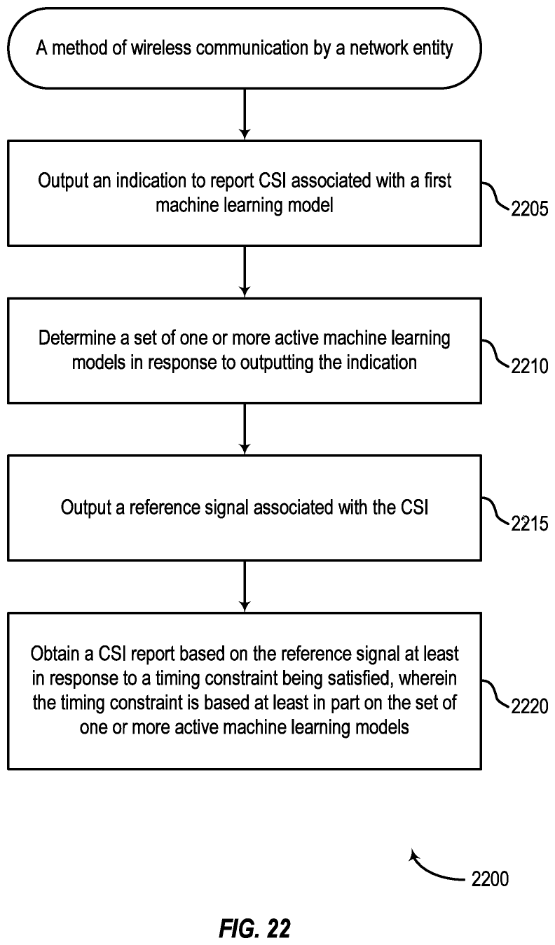

FIG. 22 shows an example of a method 2200 of wireless communication by a network entity, such as a BS 102 of FIGS. 1 and 3, or a disaggregated base station as discussed with respect to FIG. 2. The method 2200 may be complementary to the method 1900 performed by the UE.

Method 2200 may optionally begin at step 2205, where the network entity may output an indication to report CSI associated with a first machine learning model, for example, as described herein with respect to FIG. 21. In some cases, the operations of this step refer to, or may be performed by, circuitry for outputting and/or code for outputting as described with reference to FIG. 25.

Method 2200 then proceeds to step 2210, where the network entity may determine a set of one or more active machine learning models (e.g., the model-status 1420, 1520) in response to outputting the indication. In some cases, the operations of this step refer to, or may be performed by, circuitry for determining and/or code for determining as described with reference to FIG. 25.

Method 2200 may then optionally proceed to step 2215, where the network entity may output a reference signal associated with the CSI. In certain cases, the CSI report may be for interference measurements at the user equipment, and the network entity may not output the reference signal. In some cases, the operations of this step refer to, or may be performed by, circuitry for outputting and/or code for outputting as described with reference to FIG. 25.

Method 2200 then proceeds to step 2220, where the network entity may obtain a CSI report based on the reference signal or an interference measurement resource at least in response to a timing constraint being satisfied, where the timing constraint is based at least in part on the set of one or more active machine learning models. In some cases, the operations of this step refer to, or may be performed by, circuitry for obtaining and/or code for obtaining as described with reference to FIG. 25. In some aspects, the timing constraint is satisfied if an event occurs before or starts no earlier than a timing reference, where a position in time of the timing reference is determined based at least in part on a machine learning capability associated with a user equipment.

In certain aspects, the timing constraint may be associated with Z for aperiodic CSI as described herein with respect to FIG. 5A. In some aspects, the indication further indicates to report the CSI in a reporting occasion; the event includes the reporting occasion; and the timing reference is positioned in time a first number of one or more symbols after a last symbol of the indication triggering the CSI report.

For certain aspects, the timing constraint may be associated with Z′ for aperiodic as described herein with respect to FIG. 5A. In some aspects, the indication further indicates to report the CSI in a reporting occasion; the event includes the reporting occasion; and the timing reference is positioned in time a second number of one or more symbols after a last symbol of the reference signal.

In certain aspects, the timing constraint may be associated with Y for periodic CSI and/or semi-persistent CSI as described herein with respect to FIG. 5B. In some aspects, the indication further indicates to report the CSI in a reporting occasion; the CSI report includes periodic CSI or semi-persistent CSI; the event includes a reception occasion associated with the reference signal; and the timing reference is positioned in time a third number of one or more symbols before the reporting occasion.

In some aspects, the method 2200 further includes selecting a first value for the third number of one or more symbols if the first machine learning model is in the set of one or more active machine learning models. In some aspects, the method 2200 further includes selecting a second value for the third number of one or more symbols if the first machine learning model is not in the set of one or more active machine learning models, where the second value is different than the first value. In some cases, the operations of this step refer to, or may be performed by, circuitry for selecting and/or code for selecting as described with reference to FIG. 25.

In some aspects, the method 2200 further includes selecting a first value for the third number of one or more symbols if the CSI report includes periodic CSI. In some aspects, the method 2200 further includes selecting a second value for the third number of one or more symbols if the CSI report is an initial transmission associated with semi-persistent CSI. In some aspects, the method 2200 further includes selecting a third value for the third number of one or more symbols if the CSI report is a subsequent transmission associated with semi-persistent CSI, where the second value is different than the third value. In some cases, the operations of this step refer to, or may be performed by, circuitry for selecting and/or code for selecting as described with reference to FIG. 25.

In some aspects, the method 2200 further includes obtaining an indication of the position in time of the timing reference. In some cases, the operations of this step refer to, or may be performed by, circuitry for obtaining and/or code for obtaining as described with reference to FIG. 25. In some aspects, the position in time of the timing reference depends in part on: an identifier associated with the first machine learning model, a rank indicator associated with one or more transmission layers, if a CSI feedback decoder is available, if another machine learning model is active, or any combination thereof.

In some aspects, the method 2200 further includes determining the position in time of the timing reference based at least in part on the set of one or more active machine learning models. In some cases, the operations of this step refer to, or may be performed by, circuitry for determining and/or code for determining as described with reference to FIG. 25.

In some aspects, the timing reference is positioned in time: a first number of one or more symbols after a last symbol of the indication triggering the CSI report, a second number of one or more symbols after a last symbol of the reference signal, or a third number of one or more symbols before a reporting occasion associated with the CSI report. In some aspects, determining the position in time of the timing reference comprises: selecting a first value for the first number of one or more symbols, a second value for the second number of one or more symbols, or a third value for the third number of one or more symbols if the first machine learning model is in the set of one or more active machine learning models; and selecting a fourth value for the first number of one or more symbols, a fifth value for the second number of one or more symbols, or a sixth value for the third number of one or more symbols if the first machine learning model is not in the set of one or more active machine learning models, where the second value is different than the first value. In some aspects, the first value is less than the fourth value; the second value is less than the fifth value; and the third value is less than the sixth value. In some aspects, the set includes a series of one or more identifiers associated with the one or more active machine learning models.

In some aspects, the method 2200 further includes obtaining an indication of a machine learning capability associated with a user equipment, where the machine learning capability includes a first number of one or more active machine learning models capable of being processed by the user equipment, and where a total number of machine learning models in the set is less than or equal to the first number. In some cases, the operations of this step refer to, or may be performed by, circuitry for obtaining and/or code for obtaining as described with reference to FIG. 25.

In some aspects, the method 2200 further includes obtaining an indication of a machine learning capability associated with a user equipment, where the machine learning capability includes a combination of machine learning models that are capable of being processed in an active state, and where the one or more active machine learning models in the set are in the combination of machine learning models. In some cases, the operations of this step refer to, or may be performed by, circuitry for obtaining and/or code for obtaining as described with reference to FIG. 25.

In certain aspects, the set of one or more active machine learning models may include an ordered series, where certain rules may be used to add or remove entries in the series. In some aspects, determining the set comprises updating the set to include the first machine learning model in response to receiving the indication to report the CSI if the first machine learning model is not in the set. In some aspects, updating the set comprises: removing a first identifier or a last identifier associated with a second machine learning model from the set; and adding an identifier associated with the first machine learning model to the set. In some aspects, updating the set comprises: removing a second machine learning model from the set; obtaining an indication that the second machine learning model is removed from the set; and adding the first machine learning model to the set.

In some aspects, the indication further indicates to report CSI associated with the first machine learning model and a second machine learning model in a same UCI; inserting the first machine learning model in a first position of the set if the first machine learning model is associated with an identifier having a smaller value than the second machine learning model; and inserting the second machine learning model in the first position of the set if the second machine learning model is associated with a smaller identifier than the first machine learning model. In some cases, the operations of this step refer to, or may be performed by, circuitry for inserting and/or code for inserting as described with reference to FIG. 25.

In certain aspects, certain rule(s) may be applied to prevent or handle back-to-back indications to use inactive machine learning models, for example, as described herein with respect to FIG. 16. In some aspects, the method 2200 further includes refraining from outputting, in a time window ending at a reporting occasion in which the CSI report is obtained, an indication to report CSI associated with a second machine learning model not in the set of one or more machine learning models. In some cases, the operations of this step refer to, or may be performed by, circuitry for refraining and/or code for refraining as described with reference to FIG. 25. In some aspects, the time window starts when the indication to report the CSI associated with the first machine learning model is output for aperiodic CSI or an initial transmission of semi-persistent CSI; and the time window starts a third number of one or more symbols before the reference signal for periodic CSI or subsequent transmissions of the semi-persistent CSI. In some aspects, the third number of one or more symbols depends on whether the first machine learning model is in a set of one or more active machine learning models. In some aspects, the method 2200 further includes obtaining an indication of the third number of one or more symbols. In some cases, the operations of this step refer to, or may be performed by, circuitry for obtaining and/or code for obtaining as described with reference to FIG. 25.

In one aspect, method 2200, or any aspect related to it, may be performed by an apparatus, such as communications device 2500 of FIG. 25, which includes various components operable, configured, or adapted to perform the method 2200. Communications device 2500 is described below in further detail.

Note that FIG. 22 is just one example of a method, and other methods including fewer, additional, or alternative steps are possible consistent with this disclosure.

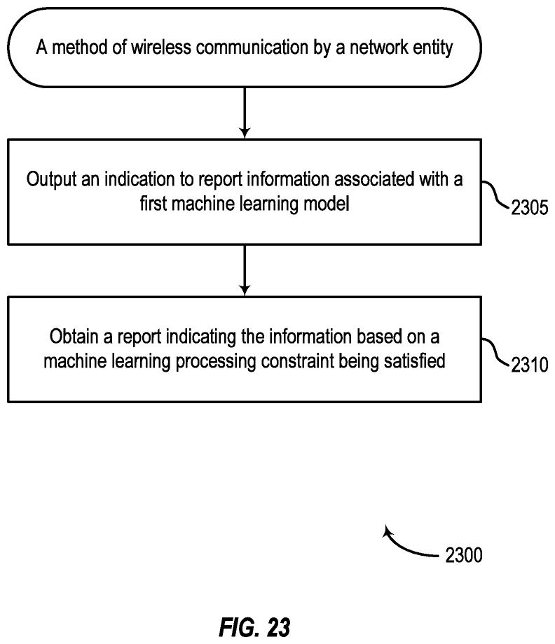

FIG. 23 shows an example of a method 2300 of wireless communication by a network entity, such as a BS 102 of FIGS. 1 and 3, or a disaggregated base station as discussed with respect to FIG. 2. The method 2300 may be complementary to the method 2000 performed by the UE.

Method 2300 may optionally begin at step 2305, where the network entity may output, to a UE (e.g., the UE 104), an indication to report information associated with a first machine learning model. For example, the information may include channel state information, beam management information, positioning information, channel estimation information, or any combination thereof. In some cases, the operations of this step refer to, or may be performed by, circuitry for outputting and/or code for outputting as described with reference to FIG. 25.

Method 2300 then proceeds to step 2310, where the network entity may obtain, from the UE, a report (e.g., a CSI report) indicating the information based on a machine learning processing constraint being satisfied. In some cases, the operations of this step refer to, or may be performed by, circuitry for obtaining and/or code for obtaining as described with reference to FIG. 25. In some aspects, the machine learning processing constraint allows for concurrent processing with the first machine learning model and a second machine learning model.

In some aspects, the method 2300 further includes obtaining an indication of a machine learning capability associated with the UE including: a combination of machine learning models that are capable of being processed in an active state or an inactive state; a first number of inference tasks that can be shared among models in a set of active machine learning models or the combination, a second number of one or more inference tasks for each model in the set of active machine learning models or the combination, a threshold associated with the machine learning processing constraint per one or more subcarriers, per one or more carriers, or per one or more bands; or a combination thereof. In some cases, the operations of this step refer to, or may be performed by, circuitry for obtaining and/or code for obtaining as described with reference to FIG. 25.

In some aspects, the machine learning processing constraint may be satisfied: if a first total number of inference tasks associated with the first machine learning model and the second machine learning model is less than or equal to the first number; if a second total number of inference tasks associated with the first machine learning model is less than or equal to the second number associated with the first machine learning model; and if a third total number of inference tasks associated with the second machine learning model is less than or equal to the second number associated with the second machine learning model.

In some aspects, the machine learning processing constraint may be satisfied if a total number of processing units associated with active machine learning models is less than or equal to a threshold. In some aspects, the method 2300 further includes obtaining an indication of a first number of one or more processing units associated with the first machine learning model and a second number of one or more processing units associated with the second machine learning model. In some cases, the operations of this step refer to, or may be performed by, circuitry for obtaining and/or code for obtaining as described with reference to FIG. 25. In some aspects, a number of one or more processing units associated with the first machine learning model is equal to zero if the first machine learning model is in an active state.

In some aspects, one or more processing units or one or more inference tasks associated with the first machine learning model are occupied from when the indication is output until the report is obtained if the report includes aperiodic CSI or an initial transmission associated with semi-persistent CSI; and the one or more processing units or the one or more inference tasks associated with the first machine learning model are occupied from when a last occasion associated with a reference signal is output prior to a timing reference (e.g., the CSI reference resource such as the third timing reference 524) until the report is obtained if the report includes periodic CSI or a subsequent transmission associated with semi-persistent CSI.

In some aspects, one or more processing units or one or more inference tasks associated with the first machine learning model are occupied from when the indication is output until the report is obtained if the report includes aperiodic CSI; and the one or more processing units or the one or more inference tasks associated with the first machine learning model are occupied from when activation or configuration of the report is output until deactivation or reconfiguration of the report is output if the report includes periodic CSI or semi-persistent CSI.

In some aspects, the method 2300 further includes obtaining an indication of a process identifier for each of a plurality of machine learning models, where the process identifier indicates whether the corresponding machine learning model is capable of concurrent processing with another machine learning model. In some cases, the operations of this step refer to, or may be performed by, circuitry for obtaining and/or code for obtaining as described with reference to FIG. 25. In some aspects, concurrent processing is allowed for machine learning models with different process identifiers.

In one aspect, method 2300, or any aspect related to it, may be performed by an apparatus, such as communications device 2500 of FIG. 25, which includes various components operable, configured, or adapted to perform the method 2300. Communications device 2500 is described below in further detail.

Note that FIG. 23 is just one example of a method, and other methods including fewer, additional, or alternative steps are possible consistent with this disclosure.

### Example Communications Devices

FIG. 24 depicts aspects of an example communications device 2400. In some aspects, communications device 2400 is a user equipment, such as a UE 104 described above with respect to FIGS. 1 and 3.

The communications device 2400 includes a processing system 2405 coupled to the transceiver 2494 (e.g., a transmitter and/or a receiver). The transceiver 2494 is configured to transmit and receive signals for the communications device 2400 via the antenna 2496, such as the various signals as described herein. The processing system 2405 may be configured to perform processing functions for the communications device 2400, including processing signals received and/or to be transmitted by the communications device 2400.

The processing system 2405 includes one or more processors 2410. In various aspects, the one or more processors 2410 may be representative of one or more of receive processor 358, transmit processor 364, TX MIMO processor 366, and/or controller/processor 380, as described with respect to FIG. 3. The one or more processors 2410 are coupled to a computer-readable medium/memory 2460 via a bus 2492. In certain aspects, the computer-readable medium/memory 2460 is configured to store instructions (e.g., computer-executable code) that when executed by the one or more processors 2410, cause the one or more processors 2410 to perform: the method 1800 described with respect to FIG. 18, or any aspect related to it; the method 1900 described with respect to FIG. 19, or any aspect related to it; and/or the method 2000 described with respect to FIG. 20, or any aspect related to it. Note that reference to a processor performing a function of communications device 2400 may include one or more processors 2410 performing that function of communications device 2400.

In the depicted example, computer-readable medium/memory 2460 stores code (e.g., executable instructions), such as code for receiving 2465, code for transmitting 2470, code for loading 2475, code for determining 2480, code for ignoring 2482, code for refraining 2484, code for selecting 2486, code for allocating 2488, and code for inserting 2490. Processing of the code for receiving 2465, code for transmitting 2470, code for loading 2475, code for determining 2480, code for ignoring 2482, code for refraining 2484, code for selecting 2486, code for allocating 2488, and code for inserting 2490 may cause the communications device 2400 to perform: the method 1800 described with respect to FIG. 18, or any aspect related to it; the method 1900 described with respect to FIG. 19, or any aspect related to it; and/or the method 2000 described with respect to FIG. 20, or any aspect related to it.

The one or more processors 2410 include circuitry configured to implement (e.g., execute) the code stored in the computer-readable medium/memory 2460, including circuitry such as circuitry for receiving 2415, circuitry for transmitting 2420, circuitry for loading 2425, circuitry for determining 2430, circuitry for ignoring 2435, circuitry for refraining 2440, circuitry for selecting 2445, circuitry for allocating 2450, and circuitry for inserting 2455. Processing with circuitry for receiving 2415, circuitry for transmitting 2420, circuitry for loading 2425, circuitry for determining 2430, circuitry for ignoring 2435, circuitry for refraining 2440, circuitry for selecting 2445, circuitry for allocating 2450, and circuitry for inserting 2455 may cause the communications device 2400 to perform: the method 1800 described with respect to FIG. 18, or any aspect related to it; the method 1900 described with respect to FIG. 19, or any aspect related to it; and/or the method 2000 described with respect to FIG. 20, or any aspect related to it.

Various components of the communications device 2400 may provide means for performing: the method 1800 described with respect to FIG. 18, or any aspect related to it; the method 1900 described with respect to FIG. 19, or any aspect related to it; and/or the method 2000 described with respect to FIG. 20, or any aspect related to it. For example, means for transmitting, sending or outputting for transmission may include transceivers 354 and/or antenna(s) 352 of the UE 104 illustrated in FIG. 3 and/or the transceiver 2494 and the antenna 2496 of the communications device 2400 in FIG. 24. Means for receiving or obtaining may include transceivers 354 and/or antenna(s) 352 of the UE 104 illustrated in FIG. 3 and/or the transceiver 2494 and the antenna 2496 of the communications device 2400 in FIG. 24.

FIG. 25 depicts aspects of an example communications device 2500. In some aspects, communications device 2500 is a network entity, such as a BS 102 of FIGS. 1 and 3, or a disaggregated base station as discussed with respect to FIG. 2.

The communications device 2500 includes a processing system 2505 coupled to the transceiver 2575 (e.g., a transmitter and/or a receiver) and/or a network interface 2582. The transceiver 2575 is configured to transmit and receive signals for the communications device 2500 via the antenna 2580, such as the various signals as described herein. The network interface 2582 is configured to obtain and send signals for the communications device 2500 via communication link(s), such as a backhaul link, midhaul link, and/or fronthaul link as described herein, such as with respect to FIG. 2. The processing system 2505 may be configured to perform processing functions for the communications device 2500, including processing signals received and/or to be transmitted by the communications device 2500.

The processing system 2505 includes one or more processors 2510. In various aspects, one or more processors 2510 may be representative of one or more of receive processor 338, transmit processor 320, TX MIMO processor 330, and/or controller/processor 340, as described with respect to FIG. 3. The one or more processors 2510 are coupled to a computer-readable medium/memory 2540 via a bus 2570. In certain aspects, the computer-readable medium/memory 2540 is configured to store instructions (e.g., computer-executable code) that when executed by the one or more processors 2510, cause the one or more processors 2510 to perform: the method 2100 described with respect to FIG. 21, or any aspect related to it; the method 2200 described with respect to FIG. 22, or any aspect related to it; and/or the method 2300 described with respect to FIG. 23, or any aspect related to it. Note that reference to a processor of communications device 2500 performing a function may include one or more processors 2510 of communications device 2500 performing that function.

In the depicted example, the computer-readable medium/memory 2540 stores code (e.g., executable instructions), such as code for outputting 2545, code for obtaining 2550, code for determining 2555, code for refraining 2560, and code for selecting 2565. Processing of the code for outputting 2545, code for obtaining 2550, code for determining 2555, code for refraining 2560, and code for selecting 2565 may cause the communications device 2500 to perform: the method 2100 described with respect to FIG. 21, or any aspect related to it; the method 2200 described with respect to FIG. 22, or any aspect related to it; and/or the method 2300 described with respect to FIG. 23, or any aspect related to it.

The one or more processors 2510 include circuitry configured to implement (e.g., execute) the code stored in the computer-readable medium/memory 2540, including circuitry such as circuitry for outputting 2515, circuitry for obtaining 2520, circuitry for determining 2525, circuitry for refraining 2530, and circuitry for selecting 2535. Processing with circuitry for outputting 2515, circuitry for obtaining 2520, circuitry for determining 2525, circuitry for refraining 2530, and circuitry for selecting 2535 may cause the communications device 2500 to perform: the method 2100 described with respect to FIG. 21, or any aspect related to it; the method 2200 described with respect to FIG. 22, or any aspect related to it; and/or the method 2300 described with respect to FIG. 23, or any aspect related to it.

Various components of the communications device 2500 may provide means for performing: the method 2100 described with respect to FIG. 21, or any aspect related to it; the method 2200 described with respect to FIG. 22, or any aspect related to it; and/or the method 2300 described with respect to FIG. 23, or any aspect related to it. Means for transmitting, sending or outputting for transmission may include transceivers 332 and/or antenna(s) 334 of the BS 102 illustrated in FIG. 3 and/or the transceiver 2575 and the antenna 2580 of the communications device 2500 in FIG. 25. Means for receiving or obtaining may include transceivers 332 and/or antenna(s) 334 of the BS 102 illustrated in FIG. 3 and/or the transceiver 2575 and the antenna 2580 of the communications device 2500 in FIG. 25.

### EXAMPLE CLAUSES

Implementation examples are described in the following numbered clauses:

Clause 1: A method of wireless communication by a user equipment, comprising: receiving an indication to report CSI associated with a first machine learning model; receiving a reference signal associated with the CSI; and transmitting a CSI report associated with the reference signal based at least in part on a machine learning capability associated with the user equipment.

Clause 2: The method of Clause 1, wherein transmitting the CSI report comprises transmitting the CSI report in response to a timing constraint being satisfied, wherein the timing constraint is based at least in part on the machine learning capability.

Clause 3: The method of Clause 2, wherein: the timing constraint is satisfied if an event occurs before or starts no earlier than a timing reference; and a position in time of the timing reference is determined based at least in part on the machine learning capability.

Clause 4: The method of any one of Clauses 1-3, wherein the machine learning capability includes: a first number of one or more active machine learning models capable of being processed by the user equipment; a second number of one or more inactive machine learning models capable of being processed by the user equipment; a delay for switching between an active machine learning model and an inactive machine learning model; a combination of machine learning models that are capable of being processed in an active state or an inactive state; or any combination thereof.

Clause 5: The method of Clause 4, further comprising: receiving a configuration indicating a first set of one or more active machine learning models and indicating a second set of one or more inactive machine learning models, wherein a first total of the first set of one or more active machine learning models is less than or equal to the first number of one or more active machine learning models, and wherein a second total of the second set of one or more inactive machine learning models is less than or equal to the second number of one or more inactive machine learning models.

Clause 6: The method of any one of Clauses 1-5, wherein the machine learning capability includes: a first capability to have at most a single active machine learning model and zero inactive machine learning models; a second capability to have at most a single active machine learning model, one or more inactive machine learning models, and a first duration to process an inactive machine learning model; a third capability to have at most a single active machine learning model, one or more inactive machine learning models, and a second duration to process the inactive machine learning model, wherein the first duration is longer than the second duration; a fourth capability to have one or more active machine learning models and zero inactive machine learning models; a fifth capability to have one or more active machine learning models, one or more inactive machine learning models, and a third duration to process the inactive machine learning model; or a sixth capability to have one or more active machine learning models, one or more inactive machine learning models, and a fourth duration to process the inactive machine learning model, wherein the third duration is longer than the fourth duration.

Clause 7: The method of any one of Clauses 1-6, further comprising: transmitting an indication of the machine learning capability.

Clause 8: The method of any one of Clauses 1-7, further comprising: receiving a configuration indicating a first set of one or more active machine learning models and indicating a second set of one or more inactive machine learning models; receiving, in response to receiving the configuration, first information associated with the first set of one or more active machine learning models and second information associated with the second set of one or more inactive machine learning models; and loading the first information in a modem.

Clause 9: The method of any one of Clauses 1-8, further comprising: receiving a configuration indicating a first set of one or more active machine learning models and indicating a second set of one or more inactive machine learning models; receiving first information associated with the first set of one or more active machine learning models and second information associated with the second set of one or more inactive machine learning models; and loading the first information in a modem in response to receiving the configuration.

Clause 10: The method of any one of Clauses 1-9, further comprising: receiving a configuration indicating a first set of one or more active machine learning models and indicating a second set of one or more inactive machine learning models and transmitting, in response to receiving the configuration, an acknowledgement that at least one of the first set of one or more active machine learning models is successfully loaded.

Clause 11: The method of Clause 10, wherein transmitting the acknowledgement comprises transmitting a plurality of acknowledgements, wherein each of the acknowledgements is for one of the first set of one or more active machine learning models.

Clause 12: The method of Clause 10 or 11, wherein transmitting the acknowledgement comprises transmitting the acknowledgement in a time window starting when the configuration is received.

Clause 13: The method of Clause 12, wherein the machine learning capability includes a first number of one or more active machine learning models capable of being processed by the apparatus, and a second number of one or more inactive machine learning models capable of being processed by the apparatus; and a duration associated with the time window depends on the first number of one or more active machine learning models or the second number of one or more inactive machine learning models.

Clause 14: The method of any one of Clauses 10-13, further comprising: transmitting, in response to receiving the configuration, an indication of a timing constraint associated with at least one of the first set of one or more active machine learning models.

Clause 15: The method of any one of Clauses 1-14, further comprising: receiving receive a configuration indicating a first set of one or more active machine learning models and indicating a second set of one or more inactive machine learning models and determining the CSI report based on a non-artificial intelligence codebook if an acknowledgement is not transmitted in a time window starting when the configuration is received, wherein the acknowledgement indicates that at least one of the first set of one or more active machine learning models is successfully loaded.

Clause 16: A method of wireless communication by a user equipment, comprising: receiving an indication to report CSI associated with a first machine learning model; determining a set of one or more active machine learning models in response to receiving the indication; receiving a reference signal associated with the CSI; and transmitting a CSI report based on the reference signal at least in response to a timing constraint being satisfied, wherein the timing constraint is based at least in part on the set of one or more active machine learning models.

Clause 17: The method of Clause 16, wherein: the timing constraint is satisfied if an event occurs before or starts no earlier than a timing reference; and a position in time of the timing reference is determined based at least in part on a machine learning capability associated with the user equipment.

Clause 18: The method of Clause 17, wherein: the indication further indicates to report the CSI in a reporting occasion; the event includes the reporting occasion; and the timing reference is positioned in time a first number of one or more symbols after a last symbol of the indication triggering the CSI report.

Clause 19: The method of Clause 17 or 18, wherein: the indication further indicates to report the CSI in a reporting occasion; the event includes the reporting occasion; and the timing reference is positioned in time a second number of one or more symbols after a last symbol of the reference signal.

Clause 20: The method of any one of Clauses 17-19, wherein: the indication further indicates to report the CSI in a reporting occasion; the CSI report includes periodic CSI or semi-persistent CSI; the event includes a reception occasion associated with the reference signal; and the timing reference is positioned in time a third number of one or more symbols before the reporting occasion.

Clause 21: The method of Clause 20, further comprising: selecting a first value for the third number of one or more symbols if the first machine learning model is in the set of one or more active machine learning models and selecting a second value for the third number of one or more symbols if the first machine learning model is not in the set of one or more active machine learning models, wherein the second value is different than the first value.

Clause 22: The method of Clause 20, further comprising: selecting a first value for the third number of one or more symbols if the CSI report includes periodic CSI; selecting a second value for the third number of one or more symbols if the CSI report is an initial transmission associated with semi-persistent CSI; and selecting a third value for the third number of one or more symbols if the CSI report is a subsequent transmission associated with semi-persistent CSI, wherein the second value is different than the third value.

Clause 23: The method of any of Clauses 17-22, wherein the position in time of the timing reference depends in part on: an identifier associated with the first machine learning model, a rank indicator associated with one or more transmission layers, if a CSI feedback decoder is available, if another machine learning model is active, or any combination thereof.

Clause 24: The method of any of Clauses 17-23, further comprising: transmitting an indication of the position in time of the timing reference.

Clause 25: The method of any of Clauses 17-24, further comprising: determining the position in time of the timing reference based at least in part on the set of one or more active machine learning models.

Clause 26: The method of Clause 25, wherein: the timing reference is positioned in time: a first number of one or more symbols after a last symbol of the indication triggering the CSI report, a second number of one or more symbols after a last symbol of the reference signal, or a third number of one or more symbols before a reporting occasion associated with the CSI report; and determining the position in time of the timing reference comprises: selecting a first value for the first number of one or more symbols, a second value for the second number of one or more symbols, or a third value for the third number of one or more symbols if the first machine learning model is in the set of one or more active machine learning models; and selecting a fourth value for the first number of one or more symbols, a fifth value for the second number of one or more symbols, or a sixth value for the third number of one or more symbols if the first machine learning model is not in the set of one or more active machine learning models, wherein the second value is different than the first value.

Clause 27: The method of Clause 26, wherein: the first value is less than the fourth value; the second value is less than the fifth value; and the third value is less than the sixth value.

Clause 28: The method of any one of Clauses 16-27, wherein the set includes a series of one or more identifiers associated with the one or more active machine learning models.

Clause 29: The method of any one of Clauses 16-28, further comprising: transmitting an indication of a machine learning capability associated with the user equipment, wherein the machine learning capability includes a first number of one or more active machine learning models capable of being processed by the user equipment, and wherein a total number of machine learning models in the set is less than or equal to the first number.

Clause 30: The method of any one of Clauses 16-29, further comprising: transmitting an indication of a machine learning capability associated with the user equipment, wherein the machine learning capability includes a combination of machine learning models that are capable of being processed in an active state, and wherein the one or more active machine learning models in the set are in the combination of machine learning models.

Clause 31: The method of any one of Clauses 16-30, wherein determining the set comprises updating the set to include the first machine learning model in response to receiving the indication to report the CSI if the first machine learning model is not in the set.

Clause 32: The method of Clause 31, wherein updating the set comprises: removing a first identifier or a last identifier associated with a second machine learning model from the set; and adding an identifier associated with the first machine learning model to the set.

Clause 33: The method of Clause 31, wherein updating the set comprises: removing a second machine learning model from the set; transmitting an indication that the second machine learning model is removed from the set; and adding the first machine learning model to the set.

Clause 34: The method of any one of Clauses 31-33, wherein: the indication further indicates to report CSI associated with the first machine learning model and a second machine learning model in a same UCI; inserting the first machine learning model in a first position of the set if the first machine learning model is associated with an identifier having a smaller value than the second machine learning model; and inserting the second machine learning model in the first position of the set if the second machine learning model is associated with a smaller identifier than the first machine learning model.

Clause 35: The method of any one of Clauses 16-34, further comprising: ignoring an indication to report CSI associated with a second machine learning model not in the set of one or more machine learning models in response to a third timing constraint being satisfied and refraining from transmitting another CSI report associated with the second machine learning model in response to the third timing constraint being satisfied.

Clause 36: The method of Clause 35, wherein the third timing constraint is satisfied: if the indication to report CSI associated with the second machine learning model is received in a time window ending at a reporting occasion in which the CSI report is transmitted, or if the other CSI report is scheduled to be reported in the time window.

Clause 37: The method of Clause 36, wherein: the time window starts when the indication to report the CSI associated with the first machine learning model is received for aperiodic CSI or an initial transmission of semi-persistent CSI; and the time window starts a third number of one or more symbols before the reference signal for periodic CSI or subsequent transmissions of the semi-persistent CSI.

Clause 38: The method of Clause 37, wherein the third number of one or more symbols depends on whether the first machine learning model is in a set of one or more active machine learning models.

Clause 39: The method of Clause 37 or 38, further comprising: transmitting an indication of the third number of one or more symbols.

Clause 40: A method of wireless communication by a user equipment, comprising: receiving an indication to report information associated with a first machine learning model; determining the information using the first machine learning model while concurrently determining other information using a second machine learning model in response to a machine learning processing constraint being satisfied; and transmitting a report indicating the information.

Clause 41: The method of Clause 40, wherein the information includes channel state information, beam management information, positioning information, channel estimation information, or any combination thereof.

Clause 42: The method of any one of Clauses 40-41, further comprising: transmitting an indication of a machine learning capability including: a combination of machine learning models that are capable of being processed in an active state or an inactive state; a first number of inference tasks that can be shared among models in a set of active machine learning models or the combination, a second number of one or more inference tasks for each model in the set of active machine learning models or the combination, a threshold associated with the machine learning processing constraint per one or more subcarriers, per one or more carriers, or per one or more bands; or a combination thereof.

Clause 43: The method of Clause 42, wherein the machine learning processing constraint is satisfied: if a first total number of inference tasks associated with the first machine learning model and the second machine learning model is less than or equal to the first number; if a second total number of inference tasks associated with the first machine learning model is less than or equal to the second number associated with the first machine learning model; and if a third total number of inference tasks associated with the second machine learning model is less than or equal to the second number associated with the second machine learning model.

Clause 44: The method of any one of Clauses 40-43, wherein the machine learning processing constraint is satisfied if a total number of processing units associated with active machine learning models is less than or equal to a threshold.

Clause 45: The method of Clause 44, further comprising: transmitting an indication of a first number of one or more processing units associated with the first machine learning model and a second number of one or more processing units associated with the second machine learning model.

Clause 46: The method of Clause 44 or 45, wherein a number of one or more processing units associated with the first machine learning model is equal to zero if the first machine learning model is in an active state.

Clause 47: The method of any of Clauses 44-46, further comprising: allocating unoccupied processing units to the first machine learning model based at least in part on priorities associated with the active machine learning models.

Clause 48: The method of Clause 47, wherein the priorities associated with the active machine learning models are based at least in part on: a model identifier, a carrier identifier, a bandwidth part identifier, a CSI report identifier, or any combination thereof.

Clause 49: The method of any of Clauses 40-48, wherein: one or more processing units or one or more inference tasks associated with the first machine learning model are occupied from when the indication is received until the report is transmitted if the report includes aperiodic CSI or an initial transmission associated with semi-persistent CSI; and the one or more processing units or the one or more inference tasks associated with the first machine learning model are occupied from when a last occasion associated with a reference signal is received prior to a timing reference until the report is transmitted if the report includes periodic CSI or a subsequent transmission associated with semi-persistent CSI.

Clause 50: The method of any of Clauses 40-48, wherein: one or more processing units or one or more inference tasks associated with the first machine learning model are occupied from when the indication is received until the report is transmitted if the report includes aperiodic CSI; and the one or more processing units or the one or more inference tasks associated with the first machine learning model are occupied from when activation or configuration of the report is received until deactivation or reconfiguration of the report is received if the report includes periodic CSI or semi-persistent CSI.

Clause 51: The method of any one of Clauses 40-50, further comprising: transmitting an indication of a process identifier for each of a plurality of machine learning models, wherein the process identifier indicates whether the corresponding machine learning model is capable of concurrent processing with another machine learning model.

Clause 52: The method of Clause 51, wherein concurrent processing is allowed for machine learning models with different process identifiers.

Clause 53: A method of wireless communication by a network entity, comprising: outputting an indication to report CSI associated with a first machine learning model; and obtaining a CSI report associated with a reference signal based at least in part on a machine learning capability associated with a user equipment.

Clause 54: The method of Clause 53, further comprising: outputting a reference signal associated with the CSI, wherein obtaining the CSI report comprises obtaining the CSI report in response to a timing constraint being satisfied, wherein the timing constraint is based at least in part on the machine learning capability.

Clause 55: The method of Clause 54, wherein: the timing constraint is satisfied if an event occurs before or starts no earlier than a timing reference; and a position in time of the timing reference is determined based at least in part on the machine learning capability.

Clause 56: The method of any one of Clauses 53-55, wherein the machine learning capability includes: a first number of one or more active machine learning models capable of being processed by the user equipment; a second number of one or more inactive machine learning models capable of being processed by the user equipment; a delay for switching between an active machine learning model and an inactive machine learning model; a combination of machine learning models that are capable of being processed in an active state or an inactive state; or any combination thereof.

Clause 57: The method of Clause 56, further comprising: outputting a configuration indicating a first set of one or more active machine learning models and indicating a second set of one or more inactive machine learning models, wherein a first total of the first set of one or more active machine learning models is less than or equal to the first number of one or more active machine learning models, and wherein a second total of the second set of one or more inactive machine learning models is less than or equal to the second number of one or more inactive machine learning models.

Clause 58: The method of any one of Clauses 53-57, wherein the machine learning capability includes: a first capability to have at most a single active machine learning model and zero inactive machine learning models; a second capability to have at most a single active machine learning model, one or more inactive machine learning models, and a first duration to process an inactive machine learning model; a third capability to have at most a single active machine learning model, one or more inactive machine learning models, and a second duration to process the inactive machine learning model, wherein the first duration is longer than the second duration; a fourth capability to have one or more active machine learning models and zero inactive machine learning models; a fifth capability to have one or more active machine learning models, one or more inactive machine learning models, and a third duration to process the inactive machine learning model; or a sixth capability to have one or more active machine learning models, one or more inactive machine learning models, and a fourth duration to process the inactive machine learning model, wherein the third duration is longer than the fourth duration.

Clause 59: The method of any one of Clauses 53-58, further comprising: obtaining an indication of the machine learning capability.

Clause 60: The method of any one of Clauses 53-59, further comprising: outputting a configuration indicating a first set of one or more active machine learning models and indicating a second set of one or more inactive machine learning models and obtaining, in response to receiving the configuration, an acknowledgement that at least one of the first set of one or more active machine learning models is successfully loaded at the user equipment.

Clause 61: The method of Clause 60, wherein obtaining the acknowledgement comprises obtaining a plurality of acknowledgements, wherein each of the acknowledgements is for one of the first set of one or more active machine learning models.

Clause 62: The method of Clause 60 or 61, wherein obtaining the acknowledgement comprises obtaining the acknowledgement in a time window starting when the configuration is output.

Clause 63: The method of Clause 62, wherein the machine learning capability includes: a first number of one or more active machine learning models capable of being processed by the apparatus, and a second number of one or more inactive machine learning models capable of being processed by the apparatus; and a duration associated with the time window depends on the first number of one or more active machine learning models or the second number of one or more inactive machine learning models.

Clause 64: The method of any of Clauses 60-63, further comprising: obtaining, in response to outputting the configuration, an indication of a timing constraint associated with at least one of the first set of one or more active machine learning models.

Clause 65: The method of any one of Clauses 53-64, further comprising: outputting a configuration indicating a first set of one or more active machine learning models and indicating a second set of one or more inactive machine learning models, wherein the CSI report is based on a non-artificial intelligence codebook if an acknowledgement is not obtained in a time window starting when the configuration is output, wherein the acknowledgement indicates that at least one of the first set of one or more active machine learning models is successfully loaded at the user equipment.

Clause 66: A method of wireless communication by a network entity, comprising: outputting an indication to report CSI associated with a first machine learning model; determining a set of one or more active machine learning models in response to outputting the indication; outputting a reference signal associated with the CSI; and obtaining a CSI report based on the reference signal at least in response to a timing constraint being satisfied, wherein the timing constraint is based at least in part on the set of one or more active machine learning models.

Clause 67: The method of Clause 66, wherein: the timing constraint is satisfied if an event occurs before or starts no earlier than a timing reference; and a position in time of the timing reference is determined based at least in part on a machine learning capability associated with a user equipment.

Clause 68: The method of Clause 67, wherein: the indication further indicates to report the CSI in a reporting occasion; the event includes the reporting occasion; and the timing reference is positioned in time a first number of one or more symbols after a last symbol of the indication triggering the CSI report.

Clause 69: The method of Clause 67 or 68, wherein: the indication further indicates to report the CSI in a reporting occasion; the event includes the reporting occasion; and the timing reference is positioned in time a second number of one or more symbols after a last symbol of the reference signal.

Clause 70: The method of any of Clauses 67-69, wherein: the indication further indicates to report the CSI in a reporting occasion; the CSI report includes periodic CSI or semi-persistent CSI; the event includes a reception occasion associated with the reference signal; and the timing reference is positioned in time a third number of one or more symbols before the reporting occasion.

Clause 71: The method of Clause 70, further comprising: selecting a first value for the third number of one or more symbols if the first machine learning model is in the set of one or more active machine learning models and selecting a second value for the third number of one or more symbols if the first machine learning model is not in the set of one or more active machine learning models, wherein the second value is different than the first value.

Clause 72: The method of Clause 70, further comprising: selecting a first value for the third number of one or more symbols if the CSI report includes periodic CSI; selecting a second value for the third number of one or more symbols if the CSI report is an initial transmission associated with semi-persistent CSI; and selecting a third value for the third number of one or more symbols if the CSI report is a subsequent transmission associated with semi-persistent CSI, wherein the second value is different than the third value.

Clause 73: The method of any of Clauses 67-72, wherein the position in time of the timing reference depends in part on: an identifier associated with the first machine learning model, a rank indicator associated with one or more transmission layers, if a CSI feedback decoder is available, if another machine learning model is active, or any combination thereof.

Clause 74: The method of any of Clauses 67-73, further comprising: obtaining an indication of the position in time of the timing reference.

Clause 75: The method of any of Clauses 67-74, further comprising: determining the position in time of the timing reference based at least in part on the set of one or more active machine learning models.

Clause 76: The method of Clause 75, wherein: the timing reference is positioned in time: a first number of one or more symbols after a last symbol of the indication triggering the CSI report, a second number of one or more symbols after a last symbol of the reference signal, or a third number of one or more symbols before a reporting occasion associated with the CSI report; and determining the position in time of the timing reference comprises: selecting a first value for the first number of one or more symbols, a second value for the second number of one or more symbols, or a third value for the third number of one or more symbols if the first machine learning model is in the set of one or more active machine learning models; and selecting a fourth value for the first number of one or more symbols, a fifth value for the second number of one or more symbols, or a sixth value for the third number of one or more symbols if the first machine learning model is not in the set of one or more active machine learning models, wherein the second value is different than the first value.

Clause 77: The method of Clause 76, wherein: the first value is less than the fourth value; the second value is less than the fifth value; and the third value is less than the sixth value.

Clause 78: The method of any one of Clauses 66-77, wherein the set includes a series of one or more identifiers associated with the one or more active machine learning models.

Clause 79: The method of any one of Clauses 66-78, further comprising: obtaining an indication of a machine learning capability associated with a user equipment, wherein the machine learning capability includes a first number of one or more active machine learning models capable of being processed by the user equipment, and wherein a total number of machine learning models in the set is less than or equal to the first number.

Clause 80: The method of any one of Clauses 66-79, further comprising: obtaining an indication of a machine learning capability associated with a user equipment, wherein the machine learning capability includes a combination of machine learning models that are capable of being processed in an active state, and wherein the one or more active machine learning models in the set are in the combination of machine learning models.

Clause 81: The method of any one of Clauses 66-80, wherein determining the set comprises updating the set to include the first machine learning model in response to receiving the indication to report the CSI if the first machine learning model is not in the set.

Clause 82: The method of Clause 81, wherein updating the set comprises: removing a first identifier or a last identifier associated with a second machine learning model from the set; and adding an identifier associated with the first machine learning model to the set.

Clause 83: The method of Clause 81, wherein updating the set comprises: removing a second machine learning model from the set; obtaining an indication that the second machine learning model is removed from the set; and adding the first machine learning model to the set.

Clause 84: The method of any of Clauses 81-83, wherein: the indication further indicates to report CSI associated with the first machine learning model and a second machine learning model in a same UCI; inserting the first machine learning model in a first position of the set if the first machine learning model is associated with an identifier having a smaller value than the second machine learning model; and inserting the second machine learning model in the first position of the set if the second machine learning model is associated with a smaller identifier than the first machine learning model.

Clause 85: The method of any one of Clauses 66-84, further comprising: refraining from outputting, in a time window ending at a reporting occasion in which the CSI report is obtained, an indication to report CSI associated with a second machine learning model not in the set of one or more machine learning models.

Clause 86: The method of Clause 85, wherein: the time window starts when the indication to report the CSI associated with the first machine learning model is output for aperiodic CSI or an initial transmission of semi-persistent CSI; and the time window starts a third number of one or more symbols before the reference signal for periodic CSI or subsequent transmissions of the semi-persistent CSI.

Clause 87: The method of Clause 86, wherein the third number of one or more symbols depends on whether the first machine learning model is in a set of one or more active machine learning models.

Clause 88: The method of Clause 86 or 87, further comprising: obtaining an indication of the third number of one or more symbols.

Clause 89: A method of wireless communication by a network entity, comprising: outputting an indication to report information associated with a first machine learning model; and obtaining a report indicating the information based on a machine learning processing constraint being satisfied.

Clause 90: The method of Clause 89, wherein: the machine learning processing constraint allows for concurrent processing with the first machine learning model and a second machine learning model; and the information includes channel state information, beam management information, positioning information, channel estimation information, or any combination thereof.

Clause 91: The method of Clause 90, further comprising: obtaining an indication of a machine learning capability including: a combination of machine learning models that are capable of being processed in an active state or an inactive state; a first number of inference tasks that can be shared among models in a set of active machine learning models or the combination, a second number of one or more inference tasks for each model in the set of active machine learning models or the combination, a threshold associated with the machine learning processing constraint per one or more subcarriers, per one or more carriers, or per one or more bands; or a combination thereof.

Clause 92: The method of Clause 91, wherein the machine learning processing constraint is satisfied: if a first total number of inference tasks associated with the first machine learning model and the second machine learning model is less than or equal to the first number; if a second total number of inference tasks associated with the first machine learning model is less than or equal to the second number associated with the first machine learning model; and if a third total number of inference tasks associated with the second machine learning model is less than or equal to the second number associated with the second machine learning model.

Clause 93: The method of any of Clauses 90-92, wherein the machine learning processing constraint is satisfied if a total number of processing units associated with active machine learning models is less than or equal to a threshold.

Clause 94: The method of Clause 93, further comprising: obtaining an indication of a first number of one or more processing units associated with the first machine learning model and a second number of one or more processing units associated with the second machine learning model.

Clause 95: The method of Clause 93 or 94, wherein a number of one or more processing units associated with the first machine learning model is equal to zero if the first machine learning model is in an active state.

Clause 96: The method of any of Clauses 89-95, wherein: one or more processing units or one or more inference tasks associated with the first machine learning model are occupied from when the indication is output until the report is obtained if the report includes aperiodic CSI or an initial transmission associated with semi-persistent CSI; and the one or more processing units or the one or more inference tasks associated with the first machine learning model are occupied from when a last occasion associated with a reference signal is output prior to a timing reference until the report is obtained if the report includes periodic CSI or a subsequent transmission associated with semi-persistent CSI.

Clause 97: The method of any of Clauses 89-95, wherein: one or more processing units or one or more inference tasks associated with the first machine learning model are occupied from when the indication is output until the report is obtained if the report includes aperiodic CSI; and the one or more processing units or the one or more inference tasks associated with the first machine learning model are occupied from when activation or configuration of the report is output until deactivation or reconfiguration of the report is output if the report includes periodic CSI or semi-persistent CSI.

Clause 98: The method of any one of Clauses 89-97, further comprising: obtaining an indication of a process identifier for each of a plurality of machine learning models, wherein the process identifier indicates whether the corresponding machine learning model is capable of concurrent processing with another machine learning model.

Clause 99: The method of Clause 98, wherein concurrent processing is allowed for machine learning models with different process identifiers.

Clause 100: An apparatus, comprising: a memory; and a processor coupled to the memory, the processing being configured toto perform a method in accordance with any one of Clauses 1-99.

Clause 101: An apparatus, comprising means for performing a method in accordance with any one of Clauses 1-99.

Clause 102: A non-transitory computer-readable medium having instructions stored thereon to perform a method in accordance with any one of Clauses 1-99.

Clause 103: A computer program product embodied on a computer-readable storage medium comprising code for performing a method in accordance with any one of Clauses 1-99.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. An apparatus for wireless communication, comprising:
one or more memories; and
one or more processors coupled to the one or more memories and configured to cause the apparatus to:
receive an indication to report channel state information (CSI) associated with a first machine learning model,
receive a reference signal associated with the CSI, and
transmit a CSI report associated with the reference signal based at least in part on a machine learning capability associated with the apparatus.

2. The apparatus of claim 1, wherein to transmit the CSI report, the one or more processors are further configured to transmit the CSI report in response to a timing constraint being satisfied, wherein the timing constraint is based at least in part on the machine learning capability.

3. The apparatus of claim 2, wherein:
the timing constraint is satisfied if an event occurs before or starts no earlier than a timing reference; and
a position in time of the timing reference is determined based at least in part on the machine learning capability.

4. The apparatus of claim 1, wherein the machine learning capability includes:
a first number of one or more active machine learning models capable of being processed by the apparatus;
a second number of one or more inactive machine learning models capable of being processed by the apparatus;
a delay for switching between an active machine learning model and an inactive machine learning model;
a combination of machine learning models that are capable of being processed in an active state or an inactive state; or
any combination thereof.

5. The apparatus of claim 1, wherein the machine learning capability includes:
a first capability to have at most a single active machine learning model and zero inactive machine learning models;
a second capability to have at most a single active machine learning model, one or more inactive machine learning models, and a first duration to process an inactive machine learning model;
a third capability to have at most a single active machine learning model, one or more inactive machine learning models, and a second duration to process the inactive machine learning model, wherein the first duration is longer than the second duration;
a fourth capability to have one or more active machine learning models and zero inactive machine learning models;
a fifth capability to have one or more active machine learning models, one or more inactive machine learning models, and a third duration to process the inactive machine learning model; or
a sixth capability to have one or more active machine learning models, one or more inactive machine learning models, and a fourth duration to process the inactive machine learning model, wherein the third duration is longer than the fourth duration.

6. The apparatus of claim 1, where the one or more processors are further configured to transmit an indication of the machine learning capability.

7-13. (canceled)

14. An apparatus for wireless communication, comprising:
one or more memories; and
one or more processors coupled to the one or more memories and configured to cause the apparatus to:
receive an indication to report channel state information (CSI) associated with a first machine learning model,
determine a set of one or more active machine learning models in response to receiving the indication,
receive a reference signal associated with the CSI, and
transmit a CSI report based on the reference signal at least in response to a timing constraint being satisfied, wherein the timing constraint is based at least in part on the set of one or more active machine learning models.

15. The apparatus of claim 14, wherein:
the timing constraint is satisfied if an event occurs before or starts no earlier than a timing reference; and
a position in time of the timing reference is determined based at least in part on a machine learning capability associated with the apparatus.

16-18. (canceled)

19. The apparatus of claim 15, wherein the position in time of the timing reference depends in part on:
an identifier associated with the first machine learning model,
a rank indicator associated with one or more transmission layers,
if a CSI feedback decoder is available,
if another machine learning model is active, or
any combination thereof.

20. (canceled)

21. The apparatus of claim 15, wherein the one or more processors are further configured to determine the position in time of the timing reference based at least in part on the set of one or more active machine learning models.

22. The apparatus of claim 14, wherein the set includes a series of one or more identifiers associated with the one or more active machine learning models.

23. The apparatus of claim 14, wherein the one or more processors are further configured to:
transmit an indication of a machine learning capability associated with the apparatus, wherein the machine learning capability includes a first number of one or more active machine learning models capable of being processed by the apparatus; and
wherein a total number of machine learning models in the set is less than or equal to the first number.

24. The apparatus of claim 14, wherein the one or more processors are further configured to transmit an indication of a machine learning capability associated with the apparatus,
wherein the machine learning capability includes a combination of machine learning models that are capable of being processed in an active state; and
wherein the one or more active machine learning models in the set are in the combination of machine learning models.

25. The apparatus of claim 21, wherein:
the timing reference is positioned in time:
a first number of one or more symbols after a last symbol of the indication triggering the CSI report,
a second number of one or more symbols after a last symbol of the reference signal, or
a third number of one or more symbols before a reporting occasion associated with the CSI report; and
to determine the position in time of the timing reference, the one or more processors are further configured to:
select a first value for the first number of one or more symbols, a second value for the second number of one or more symbols, or a third value for the third number of one or more symbols if the first machine learning model is in the set of one or more active machine learning models, and
select a fourth value for the first number of one or more symbols, a fifth value for the second number of one or more symbols, or a sixth value for the third number of one or more symbols if the first machine learning model is not in the set of one or more active machine learning models, wherein the second value is different than the first value.

26. The apparatus of claim 25, wherein:
the first value is less than the fourth value;
the second value is less than the fifth value; and
the third value is less than the sixth value.

27. The apparatus of claim 14, wherein to determine the set, the one or more processors are further configured to update the set to include the first machine learning model in response to receiving the indication to report the CSI if the first machine learning model is not in the set.

28. The apparatus of claim 27, wherein to update the set the one or more processors are further configured to:
remove a second machine learning model from the set;
transmit an indication that the second machine learning model is removed from the set; and
add the first machine learning model to the set.

29-34. (canceled)

35. An apparatus for wireless communication, comprising:
one or more memories; and
one or more processors coupled to the one or more memories and configured to cause the apparatus to:
receive an indication to report information associated with a first machine learning model,
determine the information using the first machine learning model while concurrently determining other information using a second machine learning model in response to a machine learning processing constraint being satisfied, and
transmit a report indicating the information.

36. The apparatus of claim 35, wherein the information includes channel state information, beam management information, positioning information, channel estimation information, or any combination thereof.

37. The apparatus of claim 35, wherein the one or more processors are further configured to transmit an indication of a machine learning capability including:
a combination of machine learning models that are capable of being processed in an active state or an inactive state;
a first number of inference tasks that can be shared among models in a set of active machine learning models or the combination,
a second number of one or more inference tasks for each model in the set of active machine learning models or the combination,
a threshold associated with the machine learning processing constraint per one or more subcarriers, per one or more carriers, or per one or more bands; or
a combination thereof.

38. The apparatus of claim 37, wherein the machine learning processing constraint is satisfied:
if a first total number of inference tasks associated with the first machine learning model and the second machine learning model is less than or equal to the first number;
if a second total number of inference tasks associated with the first machine learning model is less than or equal to the second number associated with the first machine learning model; and
if a third total number of inference tasks associated with the second machine learning model is less than or equal to the second number associated with the second machine learning model.

39. The apparatus of claim 35, wherein the machine learning processing constraint is satisfied if a total number of processing units associated with active machine learning models is less than or equal to a threshold.

40. The apparatus of claim 39, wherein the one or more processors are further configured to transmit an indication of a first number of one or more processing units associated with the first machine learning model and a second number of one or more processing units associated with the second machine learning model.

41. (canceled)

42. The apparatus of claim 39, wherein the one or more processors are further configured to allocate unoccupied processing units to the first machine learning model based at least in part on priorities associated with the active machine learning models.

43. The apparatus of claim 42, wherein the priorities associated with the active machine learning models are based at least in part on:
a model identifier,
a carrier identifier,
a bandwidth part identifier,
a CSI report identifier, or
any combination thereof.

44. The apparatus of claim 35, wherein the one or more processors are further configured to transmit an indication of a process identifier for each of a plurality of machine learning models, wherein the process identifier indicates whether the corresponding machine learning model is capable of concurrent processing with another machine learning model.

45. The apparatus of claim 44, wherein concurrent processing is allowed for machine learning models with different process identifiers.

46. The apparatus of claim 35, wherein:
one or more processing units or one or more inference tasks associated with the first machine learning model are occupied from when the indication is received until the report is transmitted if the report includes aperiodic channel state information (CSI) or an initial transmission associated with semi-persistent CSI; and
the one or more processing units or the one or more inference tasks associated with the first machine learning model are occupied from when a last occasion associated with a reference signal is received prior to a timing reference until the report is transmitted if the report includes periodic CSI or a subsequent transmission associated with semi-persistent CSI.

47. The apparatus of claim 35, wherein:
one or more processing units or one or more inference tasks associated with the first machine learning model are occupied from when the indication is received until the report is transmitted if the report includes aperiodic channel state information (CSI); and
the one or more processing units or the one or more inference tasks associated with the first machine learning model are occupied from when activation or configuration of the report is received until deactivation or reconfiguration of the report is received if the report includes periodic CSI or semi-persistent CSI.

48. An apparatus for wireless communication, comprising:
one or more memories; and
one or more processors coupled to the one or more memories and configured to cause the apparatus to:
output an indication to report channel state information (CSI) associated with a first machine learning model, and
obtain a CSI report associated with a reference signal based at least in part on a machine learning capability associated with a user equipment.

49-50. (canceled)
